(19) United States
(12) Patent Application Publication
(10) Pub. No.: US 2020/0061953 A1
(43) Pub. Date: Feb. 27, 2020

(54) LIQUID IMPACT PROOF STRUCTURES

(71) Applicant: Atacama, Inc., Alameda, CA (US)

(72) Inventors: Siyuan XING, Davis, CA (US); Jesé AGUILAR, Woodland, CA (US)

(73) Assignees: Atacama, Inc., Alameda, CA (US); Atacama, Inc., Alameda, CA (US)

(21) Appl. No.: 16/065,593

(22) PCT Filed: Dec. 29, 2016
(86) PCT No.: PCT/US2016/069286

§ 371 Date: Jun. 22, 2018

Related U.S. Application Data
(60) Provisional application No. 62/274,006, filed on Dec. 31, 2015.
(60) Provisional application No. 62/354,065, filed on Jun. 23, 2016.

(51) Int. Cl. B32B 3/08; B32B 7/12; B32B 5/26; B32B 37/12; B32B 38/00

(52) U.S. Cl. CPC B32B 3/085; B32B 7/12; B32B 5/26; B32B 37/12; B32B 38/145; B32B 2307/7265; B32B 2307/728; B32B 2307/73; B32B 2555/02; B32B 2535/00; B32B 2437/00

(57) ABSTRACT

The present disclosure provides articles of manufacture with a structure that resists liquid impacts, such as from rain, as well as methods of making such articles. In some embodiments, the articles include two layers of porous material. The inner layer is made from a hydrophobic porous material or has a hydrophobic coating. A spacer layer is positioned in-between the two layers to provide physical separation between the layers, airflow between the layers, and other benefits. Importantly, the configuration of the spacer layer allows each of the other layers to be made from more breathable materials than existing waterproof materials, while allowing the article as a whole to withstand far greater water impact pressures than either layer individually.

### CROSS REFERENCE TO RELATED APPLICATIONS

This application claims the priority benefit of U.S. Provisional Application Ser. Nos. 62/274,006, filed Dec. 31, 2015, and 62/354,065, filed Jun. 23, 2016, each of which is incorporated herein by reference in its entirety.

### FIELD

The present disclosure relates to articles of manufacture with a structure that resists liquid impact (i.e., a liquid impact-proof structure), as well as methods related thereto.

### BACKGROUND

Breathable materials with strong liquid-impact proof capacity are very important in a broad range of applications, including rainproof apparel and other gear, leak-proof bed sheets, wound dressing, protection suites for chemical splash and biological fluid contamination, and the like. For example, breathable rainproof jackets are widely used in outdoor activities because the rain is kept away from the inside clothes while the sweat vapor can diffuse through to the outside. These combined results kept the wearer dry and warm. Breathable leak-proof bed sheets are widely used in beds for patients and babies as they can prevent the mattress from being contaminated by blood or urine while providing air flow needed to maintain a healthy microenvironment near the body.

Existing solutions for rain-proofing use a porous membrane-like material that can withstand high hydrostatic pressure, which is believed to be directly correlated with its waterproof/rainproof ability. Specifically, in order to block both a high level of rain impact (with pressure of roughly 20 kPa) and a large pressure of the body in contact with a wet surface (with pressure of roughly 137 kPa), good rainproof fabric is designed to possess a hydrostatic pressure of 200 kpa. For example, GORE-TEX® membrane is a hydrophobic porous polytetrafluoroethylene (PTFE) membrane that can resist water pressure as high as 280 kpa. However, such a dense structure possesses limited air permeability and severely blocks the convective flow of vapor through the apparel, resulting in a largely decreased dynamic breathability of the fabric. As a result, the wearer often ends up with the inside of the apparel saturated from their own perspiration, especially during high-intensity exertion. Other products like NIKWAX Analogy® utilizes a dense woven out layer and a fur-like hydrophobic fleece layer to generate a directional waterproof capacity. However, such a structure may fail under high pressure, e.g., during sitting or kneeling down. It may also be too warm to be comfortable in warm and high exertion situations due to its dense fleece-like structure.

Therefore, a need exists for improved articles that combine strong and robust liquid impact proofing with high air and vapor permeability, thus providing for a high dynamic breathability. Such articles are capable of resisting high impact pressures from rain and wet surface contact while allowing a higher degree of breathability, vapor permeability, and/or sweat convection than existing waterproof materials.

### BRIEF SUMMARY

To meet these and other demands, the present disclosure provides articles with a structure that resists liquid impact, as well as methods related thereto. The articles have a unique structure with a first or outer layer comprising a porous material, a second or inner layer comprising a hydrophobic porous material on at least a first surface, and a spacer layer between the first or outer and second or inner layers. This configuration allows for an article that displays a high degree of liquid impact resistance, and yet is made from highly permeable/breathable constituent layers.

In certain aspects, the present disclosure provides an article of manufacture that resists liquid impact, the article comprising: (a) a first layer comprising a first porous material, wherein the first layer is positioned to receive the liquid impact; (b) a second layer comprising a hydrophobic porous material on at least a portion of the second layer, wherein the second layer is positioned behind the first layer in the direction of the liquid impact; and (c) a spacer layer separating the first layer and the second layer. In some embodiments, the hydrophobic porous material comprises a second porous material with a hydrophobic coating on at least the portion of the second layer. In some embodiments, the hydrophobic coating comprises a fluoropolymer, silicone, hydrosilicone, fluoroacrylate, wax, or olefin. In some embodiments, the hydrophobic coating is a liquid-repellent coating. In some embodiments, the second porous material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the second porous material is a metal mesh or a polymer mesh. In some embodiments, the hydrophobic porous material comprises polypropylene, polydimethylsiloxane, or a fluoro-polymer. In some embodiments, the first porous material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the first porous material is a metal mesh or a polymer mesh. In some embodiments, the first porous material has a pore size of between about 15 μm and about 1 mm. In some embodiments, the first porous material has a pore size of between about 50 μm and about 1 mm. In some embodiments, the hydrophobic porous material has a pore size of between about 15 μm and about 1 mm. In some embodiments, the hydrophobic porous material has a pore size of between about 50 μm and about 1 mm. In some embodiments, the spacer layer separates the first layer and the second layer from physical contact. In some embodiments, the spacer layer separates the first layer and the second layer from being connected by liquid accumulation from the liquid impact. In some embodiments, the spacer layer separates the first layer and the second layer by between about 100 μm and about 2 cm. In some embodiments, the spacer layer comprises a plurality of discrete spacers, wherein at least a first discrete spacer of the plurality has a first end and a second end, and wherein the first end penetrates into the first layer and the second end penetrates into the second layer. In some embodiments, the first end and the second end of the first spacer are connected to each other. In some embodiments, the first porous material of the first layer is a textile comprising a plurality of fibers, the second porous material of the second layer is a textile comprising a plurality of fibers, and the spacer layer comprises at least a first yarn threaded through at least a first space between the plurality of fibers of the first layer and through at least a first space from the plurality of fibers of the second layer. In some embodiments, the first yarn is a monofilament yarn. In some embodiments, the first layer, the second layer, and the first yarn comprise a 3D knitted or woven fabric. In some embodiments, the spacer layer comprises a plurality of discrete spacers, wherein each discrete spacer of the plurality has a first end and a second end, and wherein the first end is attached to the first layer and the second end is attached to the second layer. In some embodiments, the discrete spacers of the plurality are spaced apart from each other by between about 10 μm and about 1 cm. In some embodiments, the discrete spacers of the plurality are spaced apart from each other by about 2 mm. In some embodiments, each discrete spacer of the plurality comprises a moisture impermeable material in at least the second end attached to the second layer. In some embodiments, the moisture impermeable material is selected from the group consisting of adhesive, polyurethane, thermoplastic polyurethane (TPU), silicone, metal, polytetrafluoroethylene (PTFE), plastic and a dense hydrophobic fabric. In some embodiments, the first layer comprises: (a) a first surface comprising the first porous material, wherein the first surface is positioned to receive the liquid impact; and (b) a second surface comprising a hydrophilic material, wherein the second surface is adjacent to the spacer layer. In some embodiments, the first porous material is a hydrophobic porous material. In some embodiments, the second layer comprises: (a) a first surface, wherein the first surface is attached to the plurality of discrete spacers, and wherein the first surface further comprises: (i) a first portion, wherein the first portion of the first surface is located at the attachments between the second layer and the plurality of discrete spacers, and wherein the first portion comprises the hydrophobic porous material; and (ii) a second portion, wherein the second portion of the first surface is located around the attachments between the second layer and the plurality of discrete spacers, and wherein the second portion comprises a hydrophilic material; and (b) a second surface comprising the hydrophobic porous material, wherein the second surface is behind the first surface in the direction of the liquid impact. In some embodiments, the spacer layer further comprises a hydrophilic layer, wherein the hydrophilic layer is positioned between the first end and the second end of the plurality of discrete spacers, wherein the hydrophilic layer connects the discrete spacers of the plurality, and wherein the hydrophilic layer comprises a hydrophilic material. In some embodiments, the hydrophilic material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the first layer and the spacer layer each comprise a hydrophobic porous material. In some embodiments, the first layer and the spacer layer each comprise a hydrophobic porous material, and wherein the second layer comprises: (a) a first surface comprising a hydrophobic porous material, wherein the first surface is adjacent to the spacer layer; and (b) a second surface comprising a hydrophilic material, wherein the second surface is behind the first surface in the direction of the liquid impact. In some embodiments, the first surface comprises between about 10% and about 95% of the thickness of the second layer. In some embodiments, the second layer and the spacer layer each comprise a hydrophobic porous material, and wherein the first layer comprises a hydrophilic material. In some embodiments, the first layer comprises a first portion comprising a hydrophobic porous material and a second portion comprising the hydrophilic material. In some embodiments, the second portion of the first layer forms a pattern on a surface of the first layer positioned to receive the liquid impact. In some embodiments, the second portion forms a pattern on the surface of the first layer between about 1 mm and about 1 cm in width. In some embodiments, the second portion covers between about 5% and about 50% of the surface area of the first layer. In some embodiments, the second portion of the first layer comprises a first sub-portion abutting a second sub-portion in a cross-section of the first layer, wherein only the first sub-portion is present on a surface of the first layer positioned to receive the liquid impact, wherein the first sub-portion comprises a hydrophobic porous material, and wherein the second sub-portion comprises the hydrophilic material. In some embodiments, the second sub-portion occupies between about 5% and about 95% of the cross-sectional thickness of the first layer. In some embodiments, the first layer and the spacer layer each comprise a hydrophilic material, and wherein the second layer comprises: (a) a first surface comprising a hydrophilic material, wherein the first surface is adjacent to the spacer layer; and (b) a second surface comprising a hydrophobic porous material, wherein the second surface is behind the first surface in the direction of the liquid impact. In some embodiments, the first surface comprises between about 10% and about 95% of the thickness of the second layer. In some embodiments, the spacer layer comprises a space separating the first layer and the second layer, and wherein at least one of the first layer and the second layer is affixed to a support structure that maintains separation between the first layer and the second layer. In some embodiments, the article resists a liquid impact having an impact pressure of up to about 250 kPa. In some embodiments, the first layer resists a liquid impact having an impact pressure of up to about 6 kPa. In some embodiments, the second layer resists a liquid impact having an impact pressure of up to about 6 kPa. In some embodiments, the spacer layer is open to airflow in at least a first end. In some embodiments, the first end of the spacer layer is configured to allow reversible sealing of the first end. In some embodiments, the article is a waterproof fabric. In some embodiments, the waterproof fabric is a component of a garment. In some embodiments, the garment comprises: (a) a first portion comprising the waterproof fabric; and (b) a second portion comprising a second fabric. In some embodiments, the second fabric is a second waterproof fabric different from the waterproof fabric of the first portion. In some embodiments, the waterproof fabric is a component of an outerwear, footwear, outdoor gear, pack, umbrella, rain gear, outerwear accessory, diaper, pad, wound dressing, or bed sheet.

In further aspects, the present disclosure provides an article of manufacture comprising: (a) an outer layer comprising a first porous material having a pore size of between about 15 μm and about 1 mm; (b) a spacer layer; and (c) an inner layer comprising a hydrophobic porous material having a pore size of between about 15 μm and about 1 mm, wherein the inner layer has a first and a second surface, and wherein the first surface of the inner layer faces the spacer layer; wherein the spacer layer separates the outer layer and the inner layer from physical contact and allows airflow between the outer layer and the first surface of the inner layer. In some embodiments, the inner layer comprises the hydrophobic porous material on one or both of the first and the second surfaces. In some embodiments, the hydrophobic porous material comprises a second porous material with a hydrophobic coating on one or both of the first and the second surfaces of the inner layer. In some embodiments, the hydrophobic coating comprises a fluoropolymer, silicone, hydrosilicone, fluoroacrylate, wax, or olefin. In some embodiments, the hydrophobic coating is a liquid-repellent coating. In some embodiments, the second porous material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the second porous material is a metal mesh or a polymer mesh. In some embodiments, the hydrophobic porous material comprises polypropylene, polydimethylsiloxane, or a fluoro-polymer. In some embodiments, the first porous material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the first porous material is a metal mesh or a polymer mesh. In some embodiments, the first porous material has a pore size of between about 50 μm and about 1 mm. In some embodiments, the hydrophobic porous material has a pore size of between about 50 μm and about 1 mm. In some embodiments, the spacer layer separates the outer layer and the inner layer from being connected by liquid accumulation from a liquid impact to the outer layer. In some embodiments, the spacer layer separates the outer layer and the inner layer by between about 100 μm and about 2 cm. In some embodiments, the spacer layer comprises a plurality of discrete spacers, wherein at least a first discrete spacer of the plurality has a first end and a second end, and wherein the first end penetrates into the outer layer and the second end penetrates into the inner layer. In some embodiments, the first end and the second end of the first spacer are connected to each other. In some embodiments, the first porous material of the outer layer is a textile comprising a plurality of fibers, the second porous material of the inner layer is a textile comprising a plurality of fibers, and the spacer layer comprises at least a first yarn threaded through at least a first space between the plurality of fibers of the outer layer and through at least a first space from the plurality of fibers of the inner layer. In some embodiments, the first yarn is a monofilament yarn. In some embodiments, the outer layer, the inner layer, and the first yarn comprise a 3D knitted or woven fabric. In some embodiments, the spacer layer comprises a plurality of discrete spacers, wherein each discrete spacer of the plurality has a first end and a second end, and wherein the first end is attached to the outer layer and the second end is attached to the first surface of the inner layer. In some embodiments, the discrete spacers of the plurality are spaced apart from each other by between about 10 μm and about 1 cm. In some embodiments, the discrete spacers of the plurality are spaced apart from each other by about 2 mm. In some embodiments, each discrete spacer of the plurality comprises a moisture impermeable material in at least the second end attached to the first surface of the inner layer. In some embodiments, the moisture impermeable material is selected from the group consisting of adhesive, polyurethane, thermoplastic polyurethane (TPU), silicone, metal, polytetrafluoroethylene (PTFE), plastic and a dense hydrophobic fabric. In some embodiments, the outer layer comprises: (a) an outer surface comprising the first porous material; and (b) an inner surface comprising a hydrophilic material, wherein the inner surface of the outer layer is adjacent to the spacer layer. In some embodiments, the first porous material is a hydrophobic porous material. In some embodiments, the inner layer comprises: (a) the first surface, wherein the first surface is attached to the plurality of discrete spacers, and wherein the first surface further comprises: (i) a first portion, wherein the first portion of the first surface is located at the attachments between the inner layer and the plurality of discrete spacers, and wherein the first portion comprises the hydrophobic porous material; and (ii) a second portion, wherein the second portion of the first surface is located around the attachments between the inner layer and the plurality of discrete spacers, and wherein the second portion comprises a hydrophilic material; and (b) the second surface, wherein the second surface comprises the hydrophobic porous material and faces in a direction opposite the first surface. In some embodiments, the spacer layer further comprises a hydrophilic layer, wherein the hydrophilic layer is positioned between the first end and the second end of the plurality of discrete spacers, wherein the hydrophilic layer connects the discrete spacers of the plurality, and wherein the hydrophilic layer comprises a hydrophilic material. In some embodiments, the hydrophilic material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the outer layer and the spacer layer each comprise a hydrophobic porous material. In some embodiments, the outer layer and the spacer layer each comprise a hydrophobic porous material, wherein the first surface of the inner layer comprises a hydrophobic porous material, and wherein the second surface of the inner layer comprises a hydrophilic material. In some embodiments, the first surface comprises between about 10% and about 95% of the thickness of the inner layer. In some embodiments, the inner layer and the spacer layer each comprise a hydrophobic porous material, and wherein the outer layer comprises a hydrophilic material. In some embodiments, the outer layer comprises a first portion comprising a hydrophobic porous material and a second portion comprising the hydrophilic material. In some embodiments, the second portion of the outer layer forms a pattern on an outer surface of the outer layer. In some embodiments, the second portion forms a pattern on the outer surface of the outer layer between about 1 mm and about 1 cm in width. In some embodiments, the second portion covers between about 5% and about 50% of the surface area of the outer layer. In some embodiments, the second portion of the outer layer comprises a first sub-portion abutting a second sub-portion in a cross-section of the outer layer, wherein only the first sub-portion is present on the outer surface of the outer layer, wherein the first sub-portion comprises a hydrophobic porous material, and wherein the second sub-portion comprises the hydrophilic material. In some embodiments, the second sub-portion occupies between about 5% and about 95% of the cross-sectional thickness of the first layer. In some embodiments, the outer layer and the spacer layer each comprise a hydrophilic material, wherein the first surface of the inner layer comprises a hydrophilic material, and wherein the second surface of the inner layer comprises a hydrophobic porous material. In some embodiments, the first surface comprises between about 10% and about 95% of the thickness of the inner layer. In some embodiments, the spacer layer comprises a space separating the outer layer and the inner layer, and wherein at least one of the outer layer and the inner layer is affixed to a support structure that maintains separation between the outer layer and the inner layer. In some embodiments, the article resists a liquid impact having an impact pressure of up to about 250 kPa. In some embodiments, the outer layer resists a liquid impact having an impact pressure of up to about 6 kPa. In some embodiments, the inner layer resists a liquid impact having an impact pressure of up to about 6 kPa. In some embodiments, the spacer layer is open to airflow in at least a first end. In some embodiments, the first end of the spacer layer is configured to allow reversible sealing of the first end. In some embodiments, the article is a waterproof fabric. In some embodiments, the waterproof fabric is a component of a garment. In some embodiments, the garment comprises: (a) a first portion comprising the waterproof fabric; and (b) a second portion comprising a second fabric. In some embodiments, the second fabric is a second waterproof fabric different from the waterproof fabric of the first portion. In some embodiments, the waterproof fabric is a component of an outerwear, footwear, outdoor gear, pack, umbrella, rain gear, outerwear accessory, diaper, pad, wound dressing, or bed sheet.

In further aspects, the present disclosure provides an article of manufacture comprising: an outer layer comprising a first porous material, the outer layer having an outer surface and an inner surface, wherein the first porous material has a pore size of between 10 μm and about 5 mm; a spacer layer; an inner layer comprising a hydrophobic porous material having a pore size of between about 10 μm and about 1.5 mm; and a protection layer, wherein the protection layer is affixed to the outer surface of the outer layer, and wherein the protection layer has a pore size of between about 10 μm and about 400 μm; wherein the spacer layer separates the outer layer and the inner layer from physical contact and allows airflow between the outer layer and the first surface of the inner layer. In some embodiments, the protection layer is a woven fabric protection layer (e.g., a hydrophilic or hydrophobic woven fabric protection layer). In some embodiments, the inner layer has a first and a second surface, wherein the first surface of the inner layer faces the spacer layer, and the inner layer comprises the hydrophobic porous material on one or both of the first and the second surfaces. In some embodiments, the hydrophobic porous material comprises a second porous material with a hydrophobic coating on one or both of the first and the second surfaces of the inner layer. In some embodiments, the hydrophobic coating comprises a fluoropolymer, silicone, hydrosilicone, fluoroacrylate, wax, or olefin. In some embodiments, the hydrophobic coating is a liquid-repellent coating. In some embodiments, the second porous material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the second porous material is a metal mesh or a polymer mesh. In some embodiments, the hydrophobic porous material comprises polypropylene, polydimethylsiloxane, or a fluoro-polymer. In some embodiments, the first porous material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the first porous material is a metal mesh or a polymer mesh. In some embodiments, the first porous material has a pore size of between about 10 μm and about 400 μm. In some embodiments, the hydrophobic porous material has a pore size of between about 50 μm and less than 0.5 mm. In some embodiments, the spacer layer separates the outer layer and the inner layer by between about 100 μm and about 2 cm. In some embodiments, the spacer layer comprises a plurality of discrete spacers, at least a first discrete spacer of the plurality has a first end and a second end, and the first end penetrates into the inner surface of the outer layer and the second end penetrates into the inner layer. In some embodiments, the first end and the second end of the first spacer are connected to each other. In some embodiments, the first porous material of the outer layer is a textile comprising a plurality of fibers, the hydrophobic porous material of the inner layer is a textile comprising a plurality of fibers, and the spacer layer comprises at least a first yarn threaded through at least a first space between the plurality of fibers of the outer layer and through at least a first space from the plurality of fibers of the inner layer. In some embodiments, the first yarn is a monofilament yarn. In some embodiments, the first layer, the second layer, and the first yarn comprise a 3D knitted or woven fabric. In some embodiments, the spacer layer comprises a plurality of discrete spacers, wherein each discrete spacer of the plurality has a first end and a second end, and wherein the first end is attached to the outer layer and the second end is attached to the first surface of the inner layer. In some embodiments, the discrete spacers of the plurality are spaced apart from each other by between about 10 μm and about 1 cm. In some embodiments, the discrete spacers of the plurality are spaced apart from each other by about 2 mm. In some embodiments, each discrete spacer of the plurality comprises a moisture impermeable material in at least the second end attached to the first surface of the inner layer. In some embodiments, the moisture impermeable material is selected from the group consisting of adhesive, polyurethane, thermoplastic polyurethane (TPU), silicone, metal, polytetrafluoroethylene (PTFE), plastic and a dense hydrophobic fabric. In some embodiments, the outer surface of the outer layer comprises the first porous material, and the inner surface of the outer layer comprises a hydrophilic material, wherein the inner surface of the outer layer is adjacent to the spacer layer. In some embodiments, the first porous material is a hydrophobic porous material. In some embodiments, the inner layer comprises: (a) the first surface, wherein the first surface is attached to the plurality of discrete spacers, and wherein the first surface further comprises: (i) a first portion, wherein the first portion of the first surface is located at the attachments between the inner layer and the plurality of discrete spacers, and wherein the first portion comprises the hydrophobic porous material; and (ii) a second portion, wherein the second portion of the first surface is located around the attachments between the inner layer and the plurality of discrete spacers, and wherein the second portion comprises a hydrophilic material; and (b) the second surface, wherein the second surface comprises the hydrophobic porous material and faces in a direction opposite the first surface. In some embodiments, the spacer layer further comprises a hydrophilic layer, wherein the hydrophilic layer is positioned between the first end and the second end of the plurality of discrete spacers, wherein the hydrophilic layer connects the discrete spacers of the plurality, and wherein the hydrophilic layer comprises a hydrophilic material. In some embodiments, the hydrophilic material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the outer layer and the spacer layer each comprise a hydrophobic porous material. In some embodiments, the outer layer and the spacer layer each comprise a hydrophobic porous material, wherein the first surface of the inner layer comprises a hydrophobic porous material, and wherein the second surface of the inner layer comprises a hydrophilic material. In some embodiments, the first surface comprises between about 10% and about 95% of the thickness of the inner layer. In some embodiments, the inner layer and the spacer layer each comprise a hydrophobic porous material, and wherein the outer layer comprises a hydrophilic material. In some embodiments, the outer layer comprises a first portion comprising a hydrophobic porous material and a second portion comprising the hydrophilic material. In some embodiments, the second portion of the outer layer forms a pattern on an outer surface of the outer layer. In some embodiments, the second portion forms a pattern on the outer surface of the outer layer between about 1 mm and about 1 cm in width. In some embodiments, the second portion covers between about 5% and about 50% of the surface area of the outer layer. In some embodiments, the second portion of the outer layer comprises a first sub-portion abutting a second sub-portion in a cross-section of the outer layer, wherein only the first sub-portion is present on the outer surface of the outer layer, wherein the first sub-portion comprises a hydrophobic porous material, and wherein the second sub-portion comprises the hydrophilic material. In some embodiments, the second sub-portion occupies between about 5% and about 95% of the cross-sectional thickness of the first layer. In some embodiments, the outer layer and the spacer layer each comprise a hydrophilic material, wherein the first surface of the inner layer comprises a hydrophilic material, and wherein the second surface of the inner layer comprises a hydrophobic porous material. In some embodiments, the first surface comprises between about 10% and about 95% of the thickness of the inner layer. In some embodiments, the spacer layer comprises a space separating the outer layer and the inner layer, and wherein at least one of the outer layer and the inner layer is affixed to a support structure that maintains separation between the outer layer and the inner layer. In some embodiments, the article resists a liquid impact having an impact pressure of up to about 41 kPa. In some embodiments, the protection layer resists a liquid impact having an impact pressure of less than about 0.1 kPa. In some embodiments, the protection layer resists a liquid impact having an impact pressure of greater than about 0.1 kPa. In some embodiments, an article comprising the outer layer, the spacer layer, and the inner layer but lacking the protection layer resists a liquid impact having an impact pressure of up to about 21 kPa. In some embodiments, the spacer layer is open to airflow in at least a first end. In some embodiments, the first end of the spacer layer is configured to allow reversible sealing of the first end. In some embodiments, the protection layer is reversibly affixed to the outer surface of the outer layer. In some embodiments, the article is a waterproof fabric. In some embodiments, the waterproof fabric is a component of a garment. In some embodiments, the garment comprises: (a) a first portion comprising the outer layer, the spacer layer, and the inner layer; and (b) a second portion comprising the protection layer, wherein the first portion and the second portion are reversibly affixed. In some embodiments, the waterproof fabric is a component of an outerwear, footwear, outdoor gear, pack, umbrella, rain gear, outerwear accessory, diaper, pad, wound dressing, or bed sheet.

In further aspects, the present disclosure provides a method of making an article that resists liquid impact, wherein the article comprises a first layer positioned to receive the liquid impact, a second layer positioned behind the first layer in the direction of the liquid impact, and a spacer layer separating the first layer and the second layer, the method comprising: (a) providing the second layer, wherein the second layer comprises a hydrophobic porous material on at least a first portion of the second layer, and wherein the second layer further comprises a first surface that faces the direction of the liquid impact; (b) screen printing a spacer material onto the first surface of the second layer to generate the spacer layer, wherein the spacer layer comprises a plurality of discrete spacers attached to the second layer; and (c) adhering the first layer onto the spacer layer generated in step (b), wherein the first layer comprises a first porous material. In some embodiments, screen printing the spacer material onto the second layer comprises: (i) printing a first portion of a spacer material onto the first surface of the second layer through a screen; (ii) curing the first portion of the spacer material; and (iii) printing a second portion of the spacer material onto the cured first portion. In some embodiments, the method further comprises repeating steps (i) and (ii) before performing step (iii). In some embodiments, the method further comprises curing the first layer, the second layer, and the spacer layer after step (c). In further aspects, the present disclosure provides a method of making an article of manufacture, wherein the article comprises an outer layer comprising a first porous material having a pore size of between about 15 μm and about 1 mm, an inner layer comprising a hydrophobic porous material having a pore size of between about 15 μm and about 1 mm, and a spacer layer separating the first layer and the second layer, the method comprising: (a) providing the inner layer, wherein the inner layer has a first and a second surface, and wherein the first surface of the inner layer faces the spacer layer, and wherein the inner layer comprises the hydrophobic porous material on at least a portion of the inner layer; (b) screen printing a spacer material onto the first surface of the inner layer to generate the spacer layer, wherein the spacer layer comprises a plurality of discrete spacers attached to the inner layer; and (c) adhering the outer layer onto the spacer layer generated in step (b). In some embodiments, screen printing the spacer material onto the inner layer comprises: (i) printing a first portion of a spacer material onto the first surface of the inner layer through a screen; (ii) curing the first portion of the spacer material; and (iii) printing a second portion of the spacer material onto the cured first portion. In some embodiments, the method further comprises repeating steps (i) and (ii) before performing step (iii). In some embodiments, the method further comprises curing the outer layer, the inner layer, and the spacer layer after step (c). In some embodiments, step (c) further comprises heating the spacer layer, and wherein the spacer layer comprises a puff ink. In further aspects, the present disclosure provides a method of making an article that resists liquid impact, wherein the article comprises a first layer positioned to receive the liquid impact, a second layer positioned behind the first layer in the direction of the liquid impact, and a spacer layer separating the first layer and the second layer, the method comprising: (a) providing the first layer and the second layer, wherein the first layer comprises a first porous material, wherein the second layer comprises a hydrophobic porous material on at least a first portion of the second layer, and wherein the second layer comprises a first surface that faces the direction of the liquid impact; and (b) bonding the spacer layer to the first layer and the first surface of the second layer by lamination, wherein the spacer layer is bonded between the first layer and the first surface of the second layer, and wherein the spacer layer comprises a plurality of discrete spacers, each spacer of the plurality comprising a solid glue particle. In further aspects, the present disclosure provides a method of making an article of manufacture, wherein the article comprises an outer layer comprising a first porous material having a pore size of between about 15 μm and about 1 mm, an inner layer comprising a hydrophobic porous material having a pore size of between about 15 μm and about 1 mm, and a spacer layer separating the first layer and the second layer, the method comprising: (a) providing the outer layer and the inner layer, wherein the outer layer comprises a first porous material, wherein the inner layer has a first and a second surface, wherein the first surface of the inner layer faces the spacer layer, and wherein the inner layer comprises the hydrophobic porous material on at least a first portion of the inner layer; and (b) bonding the spacer layer to the outer layer and the first surface of the inner layer by lamination, wherein the spacer layer is bonded between the outer layer and the first surface of the inner layer, and wherein the spacer layer comprises a plurality of discrete spacers, each spacer of the plurality comprising a solid glue particle. In further aspects, the present disclosure provides a method of making an article that resists liquid impact, wherein the article comprises a first layer positioned to receive the liquid impact, a second layer positioned behind the first layer in the direction of the liquid impact, and a spacer layer separating the first layer and the second layer, the method comprising: (a) providing a spacer material; (b) applying an adhesive film onto the spacer material; (c) laminating the applied adhesive film and the spacer material together; (d) cutting the laminated adhesive film and spacer material into a plurality of discrete spacers to generate the spacer layer, wherein the spacer layer has a first surface comprising the adhesive film and a second surface comprising the spacer material; and (e) bonding the spacer layer to the first layer and the second layer by lamination, wherein the spacer layer is bonded between the first layer and the second layer, wherein the first layer comprises a first porous material, wherein the second layer comprises a hydrophobic porous material on at least a first portion of the second layer, wherein the first surface of the second layer faces the direction of the liquid impact, and wherein the first surface of the spacer layer is bonded to the first surface of the second layer. In further aspects, the present disclosure provides a method of making an article of manufacture, wherein the article comprises an outer layer comprising a first porous material having a pore size of between about 15 μm and about 1 mm, an inner layer comprising a hydrophobic porous material having a pore size of between about 15 μm and about 1 mm, and a spacer layer separating the first layer and the second layer, the method comprising: (a) providing a spacer material; (b) applying an adhesive film onto the spacer material; (c) laminating the applied adhesive film and the spacer material together; (d) cutting the laminated adhesive film and spacer material into a plurality of discrete spacers to generate the spacer layer, wherein the spacer layer has a first surface comprising the adhesive film and a second surface comprising the spacer material; and (e) bonding the spacer layer to the outer layer and the inner layer by lamination, wherein the spacer layer is bonded between the outer layer and the inner layer, wherein the outer layer comprises a first porous material, wherein the inner layer has a first and a second surface, wherein the first surface of the inner layer faces the spacer layer, wherein the inner layer comprises the hydrophobic porous material on at least a first portion of the inner layer, and wherein the first surface of the spacer layer is bonded to the first surface of the inner layer. In further aspects, the present disclosure provides a method of making an article that resists liquid impact, wherein the article comprises an outer layer comprising a first porous material, the outer layer having an outer surface and an inner surface, wherein the first porous material has a pore size of between 15 μm and about 5 mm, a spacer layer, and an inner layer comprising a hydrophobic porous material having a pore size of between about 15 μm and less than about 1.5 mm, the method comprising: (a) knitting the outer layer and the inner layer; (b) knitting the spacer layer between the outer layer and the inner layer with a yarn. In some embodiments, the inner layer is knitted using a hydrophobic yarn to produce the hydrophobic porous material. In some embodiments, the yarn is a hydrophobic monofilament yarn. In some embodiments, the method further comprises, after step (b): (c) soaking the article in a hydrophobic coating solution to produce the hydrophobic porous material; and (d) squeezing the article between rollers to remove excess coating solution. In some embodiments, the method further comprises after step (b): treating the inner layer with a hydrophobic coating solution using textile printing to produce the hydrophobic porous material. In some embodiments, the method further comprises affixing a protection layer to the outer surface of the outer layer, wherein the protection layer has a pore size of between about 10 μm and about 400 μm. In some embodiments, the protection layer is reversibly affixed to the outer surface of the outer layer. In some embodiments, the protection layer is bonded to the outer surface of the outer layer by lamination. In some embodiments, the protection layer is a woven fabric protection layer (e.g., a hydrophilic or hydrophobic woven fabric protection layer). In further aspects, the present disclosure provides a method of making an article of manufacture, wherein the article comprises an outer layer comprising a first hydrophilic porous material having a pore size of between about 15 μm and about 1 mm, an inner layer comprising a hydrophobic porous material having a pore size of between about 15 μm and about 1 mm, and a hydrophobic spacer layer separating the first layer and the second layer, the method comprising: (a) providing an article comprising an outer layer comprising a first porous material having a pore size of between about 15 μm and about 1 mm, an inner layer comprising the first porous material having a pore size of between about 15 μm and about 1 mm, and a spacer layer separating the first layer and the second layer; and (b) applying a print paste comprising a hydrophobic material onto the inner layer such that the inner layer and spacer layer are coated with the hydrophobic material; thereby producing the article comprising an outer layer comprising the first hydrophilic porous material having a pore size of between about 15 μm and about 1 mm, an inner layer comprising the hydrophobic porous material having a pore size of between about 15 μm and about 1 mm, and a hydrophobic spacer layer that separates the first layer and the second layer. In some embodiments, the method further comprises after step (b): (c) applying a print paste comprising a hydrophobic material onto the outer layer through a screen roller such that, after applying the print paste, the outer layer comprises a first portion comprising the hydrophilic porous material and a second portion comprising a hydrophobic material. In some embodiments, the method further comprises, after step (c): (d) applying a print paste comprising a hydrophobic material onto the outer layer such that the print paste penetrates through part but not all of the outer layer, wherein after applying the print paste, the outer layer comprises a first portion comprising the hydrophilic porous material and a second portion comprising a hydrophobic material, and wherein the first portion is not present on the outer surface of the outer layer. In some embodiments, the second or inner layer comprises the hydrophobic porous material on one or both of the first and the second surfaces. In some embodiments, the hydrophobic porous material comprises a second porous material with a hydrophobic coating on at least the first portion of the second or inner layer. In some embodiments, the hydrophobic coating comprises a fluoropolymer, silicone, hydrosilicone, fluoroacrylate, wax, or olefin. In some embodiments, the hydrophobic coating is a liquid-repellent coating. In some embodiments, the second porous material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the second porous material is a metal mesh or a polymer mesh. In some embodiments, the hydrophobic porous material comprises polypropylene, polydimethylsiloxane, or a fluoro-polymer. In some embodiments, the first porous material is a textile. In some embodiments, the textile is a natural fiber, a synthetic fiber, or a blend thereof. In some embodiments, the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof. In some embodiments, the first porous material is a metal mesh or a polymer mesh. In some embodiments, the first porous material has a pore size of between about 15 μm and about 1 mm. In some embodiments, the first porous material has a pore size of between about 50 μm and about 1 mm. In some embodiments, the hydrophobic porous material has a pore size of between about 15 μm and about 1 mm. In some embodiments, the hydrophobic porous material has a pore size of between about 50 μm and about 1 mm. In some embodiments, the spacer layer separates the first layer and the second layer from physical contact. In some embodiments, the spacer layer separates the outer layer and the inner layer from physical contact. In some embodiments, the spacer layer separates the first layer and the second layer from being connected by liquid accumulation. In some embodiments, the spacer layer separates the outer layer and the inner layer from being connected by liquid accumulation. In some embodiments, the spacer layer separates the first layer and the second layer by between about 100 μm and about 2 cm. In some embodiments, the spacer layer separates the outer layer and the inner layer by between about 100 μm and about 2 cm. In some embodiments, the discrete spacers of the plurality are spaced apart from each other by between about 10 μm and about 1 cm. In some embodiments, the discrete spacers of the plurality are spaced apart from each other by about 2 mm. In some embodiments, each discrete spacer of the plurality comprises a moisture impermeable material in at least an end attached to the second layer. In some embodiments, each discrete spacer of the plurality comprises a moisture impermeable material in at least an end attached to the inner layer. In some embodiments, the moisture impermeable material is selected from the group consisting of adhesive, polyurethane, thermoplastic polyurethane (TPU), silicone, metal, polytetrafluoroethylene (PTFE), plastic and a dense hydrophobic fabric. In some embodiments, the article resists a liquid impact having an impact pressure of up to about 250 kPa. In some embodiments, the article resists a liquid impact having an impact pressure of up to about 250 kPa. In some embodiments, the first layer resists a liquid impact having an impact pressure of up to about 6 kPa. In some embodiments, the outer layer resists a liquid impact having an impact pressure of up to about 6 kPa. In some embodiments, the second layer resists a liquid impact having an impact pressure of up to about 6 kPa. In some embodiments, the inner layer resists a liquid impact having an impact pressure of up to about 6 kPa. In some embodiments, the article resists a liquid impact having an impact pressure of up to about 41 kPa. In some embodiments, the protection layer resists a liquid impact having an impact pressure of less than about 0.1 kPa. In some embodiments, the protection layer resists a liquid impact having an impact pressure of greater than about 0.1 kPa. In some embodiments, an article comprising the outer layer, the spacer layer, and the inner layer but lacking the protection layer resists a liquid impact having an impact pressure of up to about 21 kPa. In some embodiments, the spacer layer is open to airflow in at least a first end. In some embodiments, the first end of the spacer layer is configured to allow reversible sealing of the first end. In some embodiments, the article is a waterproof fabric. In some embodiments, the waterproof fabric is a component of a garment. In some embodiments, the garment comprises: (a) a first portion comprising the waterproof fabric; and (b) a second portion comprising a second fabric. In some embodiments, the second fabric is a second waterproof fabric different from the waterproof fabric of the first portion. In some embodiments, the waterproof fabric is a component of an outerwear, footwear, outdoor gear, pack, umbrella, rain gear, outerwear accessory, diaper, pad, wound dressing, or bed sheet.

It is to be understood that one, some, or all of the properties of the various embodiments described above and herein may be combined to form other embodiments of the present invention. These and other aspects of the present disclosure will become apparent to one of skill in the art. These and other embodiments of the present disclosure are further described by the detailed description that follows.

### BRIEF DESCRIPTION OF THE DRAWINGS

FIGS. 1A & 1B show cross-sectional (FIG. 1A) and top (FIG. 1B) views of a liquid impact-proof structure in accordance with some embodiments.

FIGS. 2A & 2B show cross-sectional (FIG. 2A) and top (FIG. 2B) views of a liquid impact-proof structure in accordance with some embodiments.

FIGS. 2C & 2D show cross-sectional (FIG. 2C) and top (FIG. 2D) views of a liquid impact-proof structure in accordance with some embodiments.

FIG. 3 illustrates an article resisting liquid impact in accordance with some embodiments.

FIGS. 4A-4C show exemplary liquid impact-proof structures in accordance with some embodiments.

FIGS. 5A & 5B show cross-sectional views of liquid impact-proof structures in accordance with some embodiments.

FIGS. 5C-5F show views of an exemplary liquid impact-proof structure made by 3D knitting in accordance with some embodiments.

FIGS. 5G & 5H show a schematic (FIG. 5G) and actual view (FIG. 5H) of a liquid impact-proof structure having a protection layer in accordance with some embodiments.

FIGS. 5I-5S show views of liquid impact-proof structures in accordance with some embodiments. FIGS. 5I-5L, FIG. 5N, & FIG. 5S show cross-sectional views of the liquid impact-proof structures. FIG. 5M, FIGS. 5O-5Q, & FIG. 5R show top views of the liquid impact-proof structures.

FIGS. 6A & 6B show cross-sectional views of liquid impact-proof structures in accordance with some embodiments.

FIGS. 7A & 7B show two views of a liquid impact-proof structure in accordance with some embodiments.

FIG. 8 shows a cross-sectional view of a liquid impact-proof structure in accordance with some embodiments.

FIG. 9A shows a cross-sectional view of a liquid impact-proof structure in accordance with some embodiments.

FIG. 9B shows a cross-sectional view of a liquid impact-proof structure in accordance with some embodiments.

FIGS. 10A & 10B show liquid impact-proof structures used in a garment in accordance with some embodiments.

FIGS. 11A & 11B show cross-sectional views of liquid impact-proof structures in accordance with some embodiments.

FIG. 12A is a schematic flow diagram illustrating a method for manufacturing an article with a liquid impact-proof structure in accordance with some embodiments.

FIG. 12B illustrates method for manufacturing an article with a liquid impact-proof structure in accordance with some embodiments.

FIGS. 12C-12E illustrate methods for manufacturing an article with a liquid impact-proof structure in accordance with some embodiments.

FIG. 13 illustrates a rain droplet simulator configured to test liquid impact-proof structures using water sprayed at different speeds corresponding to different impact pressures.

FIGS. 14A & 14B show the results of testing liquid impact-proof structures in accordance with some embodiments using the simulator shown in FIG. 13.

FIGS. 15A-15C show liquid impact-proof structures in accordance with some embodiments. Scale bar in FIG. 15C: 200 μm.

### DETAILED DESCRIPTION

I. Articles with a Liquid Impact-Proof Structure

Certain aspects of the present disclosure relate to articles of manufacture with a liquid impact-proof structure (e.g., a structure that resists a high-impact pressure liquid, including without limitation raindrops). As used herein and commonly known in the art, an impact pressure may refer to the pressure generated by a high-energy liquid (e.g., high velocity liquid droplets, compression on a wet surface) when it hits the surface of a material. As used herein and commonly known in the art, a hydrostatic pressure of a material may refer to a measurement metric used to characterize the maximum constant hydrostatic pressure a porous material can withstand before it leaks. In existing materials, the hydrostatic pressure equals the maximum impact pressure the fabric can withstand. Thus, the terms are interchangeable when describing each layer of a fabric. However, in the liquid impact-proof structures and articles of the present disclosure, these two terms are independent. As described herein, the articles of the present disclosure have a unique, multi-layer structure that allows them to resist much higher impact pressures without leaking than each individual constituent layer. Thus, the articles may possess high liquid impact resistance while being made of more breathable/air permeable constituent layers than existing waterproof materials.

Although waterproof/rainproof fabric is used as an example herein to illustrate the function and structure of the material, it should be noted that the structure can be applied to a broad range of liquid proof applications for blocking/protection purposes. The liquid can be any aqueous solution, bio-fluid (sweat, urine, blood, mucus, etc.), corrosive liquid, oil, organic solvent, and many others.

In some embodiments, the articles comprise (a) a first layer comprising a first porous material, wherein the first layer is positioned to receive the liquid impact; (b) a second layer comprising a hydrophobic porous material on at least a portion of the second layer, wherein the second layer is positioned behind the first layer in the direction of the liquid impact; and (c) a spacer layer separating the first layer and the second layer. In some embodiments, the articles comprise (a) an outer layer comprising a first porous material having a pore size of between about 15 μm and about 1 mm; (b) a spacer layer; and (c) an inner layer comprising a hydrophobic porous material having a pore size of between about 15 μm and about 1 mm, where the inner layer has a first and a second surface, where the first surface of the inner layer faces the spacer layer; and where the spacer layer separates the outer layer and the inner layer from physical contact and allows airflow between the outer layer and the first surface of the inner layer. The terms “outer” and “inner” as used herein refer to an outer surface facing an external environment (e.g., with moisture) and an inner surface facing an element or area to be shielded by the article from water, such as a wearer, interior space, or dry material. For example, if the article is part of a garment, while the garment is worn the outer direction faces the external environment and the inner direction faces the skin of the wearer. If the article is part of a piece of outdoor gear, the outer direction faces the external environment and the inner direction faces the user while the gear is in use. If the article is a leak-proof layer (e.g., part of a diaper, pad, bed sheet, or the like), the outer direction faces the moisture (e.g., wet skin, saturated polymer) and the inner direction is the external dry environment (e.g., mattress, clothes).

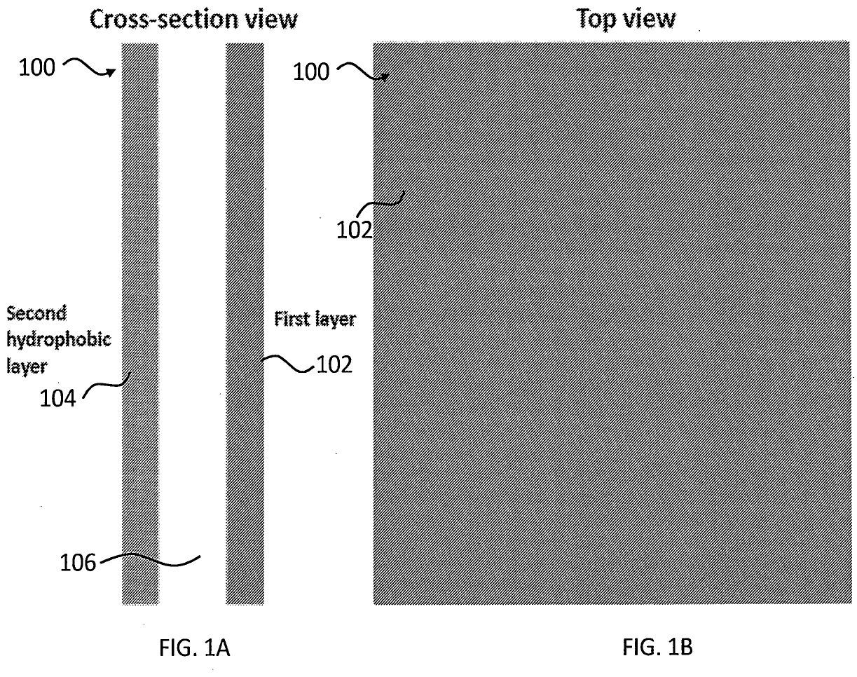

The liquid impact-proof articles of the present disclosure utilize the combined action of multiple porous layers to reduce and eliminate the penetration of high impact liquids. Unlike materials designed following conventional principles, each layer of the structure alone may be insufficient to resist the penetration of the liquid (possessing low hydrostatic pressure, e.g., the first layer can be completely hydrophilic, the second layer is 2 kPa), yet the combined actions of these layers synergistically enable the complete blockage of the penetration of high impact pressure liquid or droplets (e.g., 137 kpa or more). As shown in FIG. 1A, exemplary structure 100 utilizes a first or outer layer 102 of the porous structure to reduce the impact pressure of the fluid (e.g., contacting layer 102 from the outside, such as from the perspective of the top view shown in FIG. 1B) while a second or inner layer 104 of the porous hydrophobic structure serves as a barrier to eliminate any liquid leaking through layer 102.

In some embodiments, layers 102 and 104 are separated from direct contact during a liquid impact pressure by spacer layer 106. In some embodiments, layers 102 and 104 are separated from being connected by confined liquid (e.g., liquid accumulation from a liquid impact to layer 102, such as a liquid bridge between layers 102 and 104) during a liquid impact pressure by spacer layer 106. In some embodiments, layers 102 and 104 are separated from direct contact and from being connected by confined liquid (e.g., liquid accumulation from a liquid impact to layer 102, such as a liquid bridge between layers 102 and 104) during a liquid impact pressure by spacer layer 106. However, in some embodiments, and without wishing to be bound to theory, it is thought that connecting layers 102 and 104 by liquid accumulation does not ruin the waterproof or liquid impact-proof nature of the structure. Article 100 also prevents the penetration of liquid due to the high compressed pressure during sitting or kneeling down, as the empty space between the layers (e.g., spacer layer 106) releases the accumulated fluidic pressure during these actions, and the liquid under compression does not contact the inside dry layers, e.g., due to the separation provided by the spacer layer.

In some embodiments, an additional layer of structure can be used to enable the complete separation of the two layers during impact, deformation and bending. The additional layer of structure should block the pressure transmission directly from the first or outer layer to the second or inner layer by touching each other. As described below and illustrated herein, additional fluidic structures can be incorporated to facilitate the drainage of the liquid leaked through the first or outer layer, further preventing the liquid from continuously accumulating between the two layers.

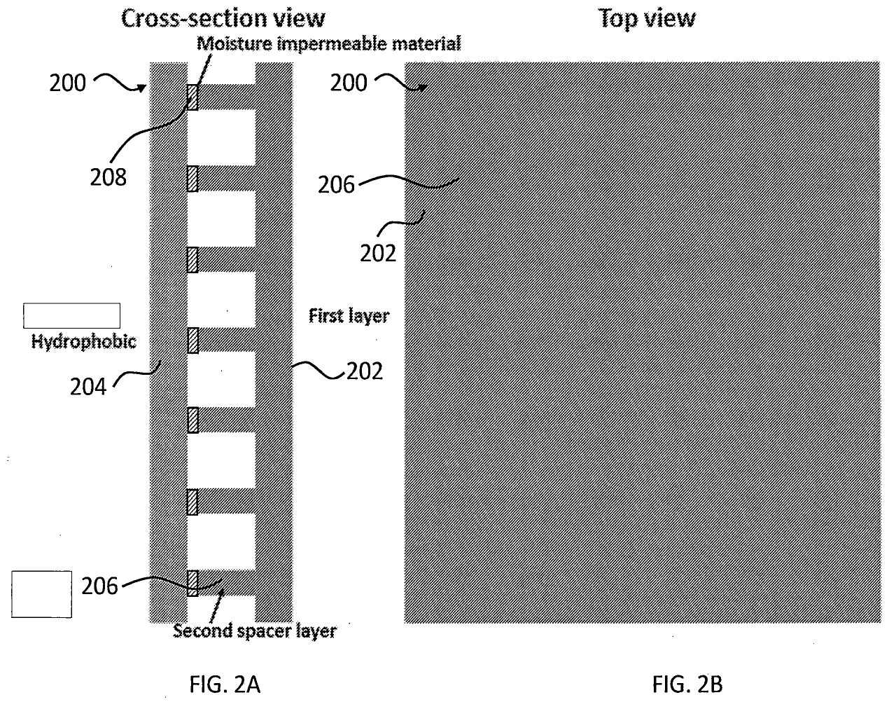

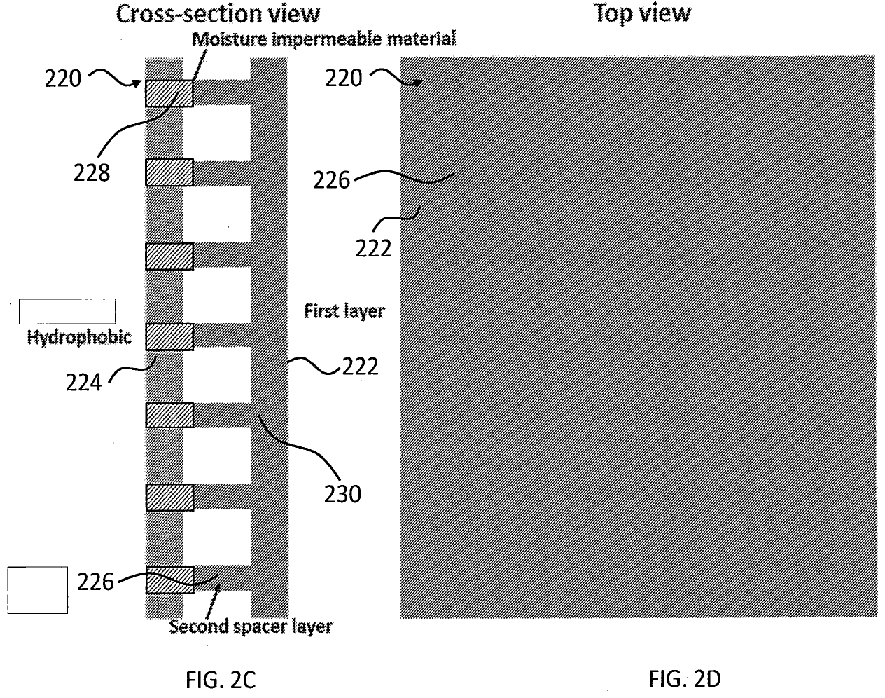

In some embodiments, an article of the present disclosure utilizes two separated layers connected by a physical spacer layer (e.g., a spacer layer comprising a plurality of discrete spacers) to reduce and eliminate the penetration of high-impact pressure liquid. Exemplary article 200 is illustrated in FIGS. 2A & 2B. The first or outer layer 202 is a continuous porous structure, as shown in FIG. 2B. In some embodiments, second or inner layer 204 comprises a hydrophobic porous material. For example, the entire layer 204 may be made of the hydrophobic porous material, or a portion of layer 204 may be made of the hydrophobic porous material (e.g., the surface facing spacer layer 206, and/or the opposite surface). As shown in FIG. 2A, spacer layer 206 supports layer 202 so that it stays separated from second or inner layer 204 under pressure or bending. The attachments of spacer layer 206 to layer 202 are shown in FIG. 2B, although in some embodiments, from the top or outside view, spacer layer 206 would not be visible.

Moreover, in some embodiments, joint 208 where spacer layer 206 and second or inner layer 204 connect is moisture impermeable under high pressure. That is to say, in some embodiments, each discrete spacer of the plurality of spacers comprising spacer layer 206 includes a moisture impermeable material in at least the end attached to the second or inner layer (e.g., layer 204). As used herein, any material that can resist the penetration of moisture under the maximum impact pressure applied onto the spacer layer is considered a “moisture-impermeable” material of the present disclosure. Exemplary moisture impermeable materials of the present disclosure include without limitation adhesive (e.g., an adhesive film), polyurethane, thermoplastic polyurethane (TPU), silicone, metal, PTFE, solid polymer, plastic, and dense hydrophobic porous material (e.g., a hydrophobic fabric that can resist a hydrostatic pressure of more than about 20 kPa).

An additional embodiment is illustrated as exemplary article 220 in FIGS. 2C & 2D. Similar to layers 202 and 204 of article 200, article 220 contains first or outer layer 222 (a continuous porous structure) and second or inner layer 224 comprising a hydrophobic porous material (e.g., the entire layer 224 may be made of the hydrophobic porous material, or a portion of layer 224 may be made of the hydrophobic porous material, such as the surface facing spacer layer 226, and/or the opposite surface). Spacer layer 226 comprises a plurality of discrete spacers. In some embodiments, as shown at joint 228, some or all of these spacers where spacer layer 226 and second or inner layer 224 connect is moisture impermeable under high pressure. That is to say, in some embodiments, each discrete spacer of the plurality of spacers comprising spacer layer 226 includes a moisture impermeable material in at least the end attached to the second or inner layer (e.g., layer 224). Moreover, in some embodiments, some or all of the spacers of spacer layer 226 have ends that penetrate into layers 222 and/or 224. For example, a spacer may have a first end that penetrates into layer 222 (as illustrated at joint 230) and/or a second end that penetrates into layer 224 (as illustrated at joint 228; however, the use of a hydrophobic porous material in these embodiments is optional in some embodiments). For example, article 220 may contain a 3D knitted structure (e.g., as described infra) in which the spacers of spacer layer 226 may penetrate into and through layers 222 and 224 while still providing a liquid impact-proof or waterproof structure. In some embodiments, the first and second ends (e.g., 228 and 230) may be connected with each other (e.g., as in a 3D knitted structure).

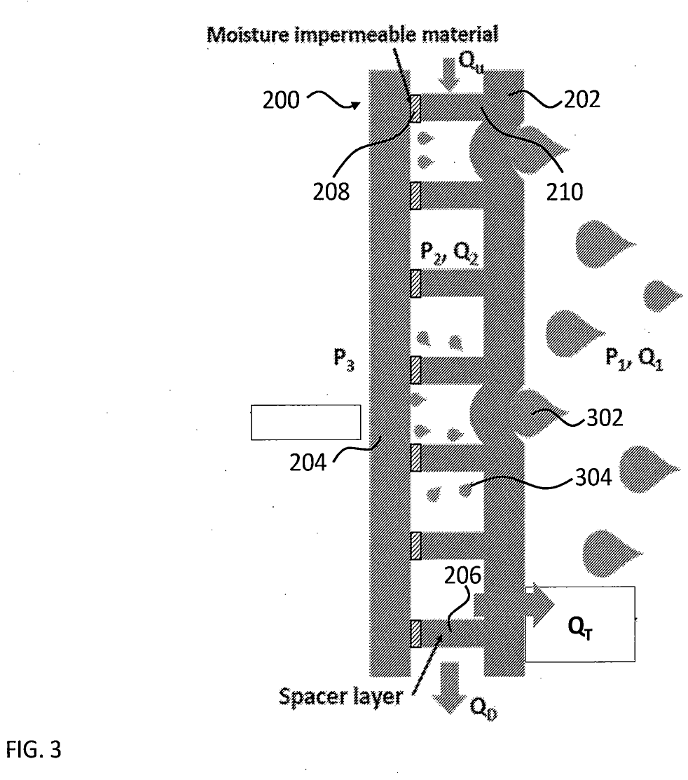

FIG. 3 further illustrates how article 200 is able to resist liquid impacts. When a water stream or droplet 302 with flow rate Q₁ and high impact pressure P₁ hits layer 202, part of the liquid is directly splashed away from the external surface of the fabric due to the fibrous or porous structure of the material. The flow rate Q₂ and impact pressure P₂ of the fluid that was able to penetrate through the first layer of the fabric (e.g., water droplet 304) are reduced by layer 202, such that water 304 can be completely repelled away by hydrophobic layer 204. The first layer 202 of the fabric, experiencing high impact pressure, is supported by spacer layer 206. The discrete spacers of spacer layer 206 (in this example, arranged as in a pillar structure) redistribute the high impact pressure onto the joint areas 208 of the third layer, which are impermeable to moisture and therefore stay dry. Moreover, spacer structure 206 ensures that layers 202 and 204 do not touch each other during use, including under high pressure, bending, etc. As a result, layer 204 is only required to possess a relatively low level of hydrophobicity (e.g., able to withstand only a small hydrostatic pressure, such as up to 6 kPa). Therefore, relatively permeable materials may be used for layer 204, and the overall article 200 maintains good breathability. In certain embodiments, and strictly optionally, spacer layer 206 allows the penetrated fluid (e.g., 304) to flow away easily without accumulation between layers 202 and 204.

In one embodiment, the thickness of the spacer layer is tall enough prevent the two layers from physical contact. For example, in some embodiments, the spacer layer separates the first or outer layer and the second or inner layer by between about 100 μm and about 2 cm. In some embodiments, the spacer layer separates the first or outer layer and the second or inner layer by a distance less than about any of the following distances (in mm): 20, 15, 10, 5, 1, or 0.5. In some embodiments, the spacer layer separates the first or outer layer and the second or inner layer by a distance greater than about any of the following distances (in mm): 0.1, 0.5, 1, 5, 10, or 15. That is, the spacer layer may separate the first or outer layer and the second or inner layer by any of a range of distances having an upper limit of 20, 15, 10, 5, 1, or 0.5 and an independently selected lower limit of 0.1, 0.5, 1, 5, 10, or 15, wherein the lower limit is less than the upper limit.

In one embodiment, a spacer layer of the present disclosure includes a plurality of discrete spacers that are deformable. The spacer layer can be shortened or collapsed when the rainproof function is not needed. Such a structure may also reduce the thickness of the fabric for easy packaging. Alternatively, in another embodiment, the height of the spacer layer can be adjustable to provide different levels of rain-proofing according to different applications.

Theoretically, the pressure and flow rate relationships of the fabric shown in FIG. 3 meet the following relationships:

P₂<P₃

Q_{D}+Q_{T}>Q₂+Qᵤ

where P₂ is the impact pressure of the fluid that was able to penetrate through layer 202; P₃ is the maximum impact pressure that layer 204 is able to resist; Q_{D} is the maximum drainage rate between the fabric layers; Q_{T} is the drainage rate through layer 202; Qᵤ is the flow rate of moisture coming from upper spaces between the two layers; and Q₂ is the flow rate of the fluid that was able to penetrate through layer 202. In some embodiments, drainage through the front layer 202 is the main path and Q_{T} is larger than Q_{D}.

In some embodiments, a spacer layer of the present disclosure allows airflow between an outer layer and a first surface of the inner layer. As used herein, airflow between the outer layer and the first surface of the inner layer may refer to one or more of the flow of air in the outward to inward direction (e.g., through layers 202, 206, and/or 204 in the direction of raindrops 302 as shown in FIG. 3), the flow of air in the inward to outward direction (e.g., through layers 202, 206, and/or 204 in a direction opposite raindrops 302 as shown in FIG. 3), and the flow of air through the spacer layer parallel to the outer layer and/or first surface of the inner layer (e.g., in the direction of the arrows labeled Qᵤ and Q_{D} in FIG. 3, or a direction opposite to these arrows along the same plane).

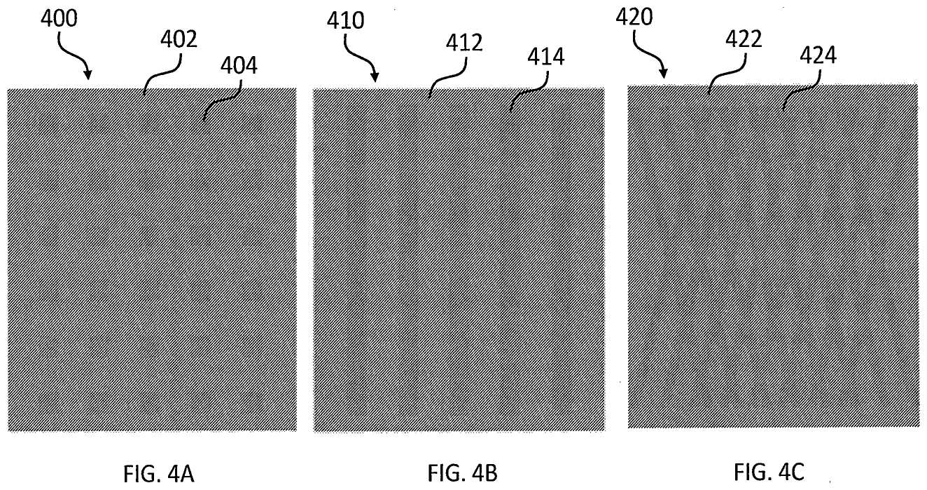

In some embodiments, as described above, a spacer layer of the present disclosure comprises a plurality of discrete spacers. In some embodiments, each discrete spacer of the plurality has a first end attached to the first or outer layer (e.g., joint 210 in FIG. 3) and a second end attached to the second or inner layer (e.g., at joint 208 in FIGS. 2A & 3). In some embodiments, the spacer layer has empty spaces and is not a continuous membrane or structure. One of skill in the art will appreciate that the specific geometry of the spacer layer is not limited by the present disclosure and may include but is not limited to an array of cylinders (e.g., as shown in FIG. 2B), cubes, spheres, pyramid, cones, etc. FIGS. 4A-4C show several exemplary geometries of the spacer layer. For example, FIG. 4A shows an array of cubic spacers 404 attached to first or outer layer 402 in article 400; FIG. 4B shows an array of parallel linear spacers 414 attached to first or outer layer 412 in article 410; and FIG. 4C shows an array of hatched linear spacers 424 attached to first or outer layer 422 in article 420.

In some embodiments, the discrete spacers of the plurality are spaced apart from each other by between about 10 μm and about 1 cm. In some embodiments, the discrete spacers of the plurality are spaced apart from each other by a distance less than about any of the following distances (in mm): 10, 5, 1, 0.5, 0.25, 0.1, 0.09, 0.075, 0.05, or 0.025. In some embodiments, the discrete spacers of the plurality are spaced apart from each other by a distance greater than about any of the following distances (in mm): 0.01, 0.025, 0.05, 0.075, 0.09, 0.1, 0.25, 0.5, 1, or 5. That is, the discrete spacers of the plurality are spaced apart from each other by any of a range of distances having an upper limit of 10, 5, 1, 0.5, 0.25, 0.1, 0.09, 0.075, 0.05, or 0.025 and an independently selected lower limit of 0.01, 0.025, 0.05, 0.075, 0.09, 0.1, 0.25, 0.5, 1, or 5, wherein the lower limit is less than the upper limit. In certain embodiments, the discrete spacers of the plurality are spaced apart from each other by about 2 mm.

In some embodiments, the discrete spacers of the plurality are spaced apart from each other by between about 100 μm and about 1 cm. In some embodiments, the discrete spacers of the plurality are spaced apart from each other by a distance less than about any of the following distances (in mm): 10, 5, 1, or 0.5. In some embodiments, the discrete spacers of the plurality are spaced apart from each other by a distance greater than about any of the following distances (in mm): 0.1, 0.5, 1, or 5. That is, the discrete spacers of the plurality are spaced apart from each other by any of a range of distances having an upper limit of 10, 5, 1, or 0.5 and an independently selected lower limit of 0.1, 0.5, 1, or 5, wherein the lower limit is less than the upper limit. In certain embodiments, the discrete spacers of the plurality are spaced apart from each other by about 2 mm.

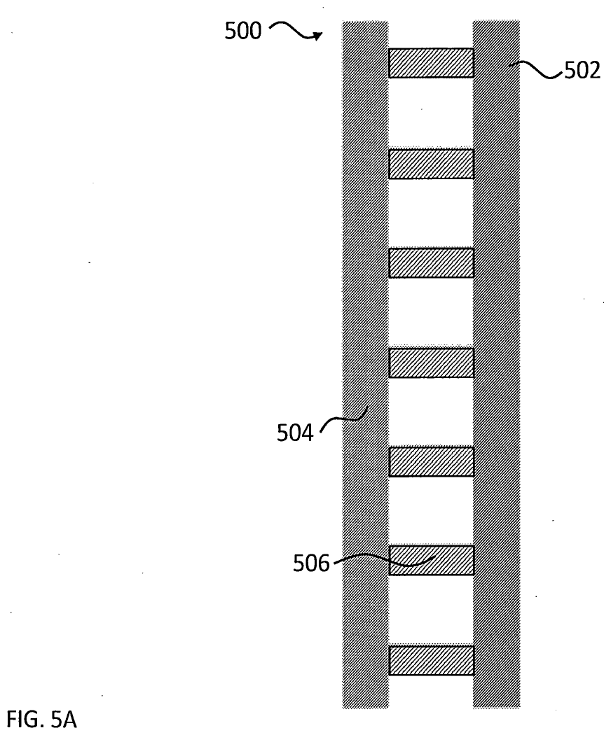

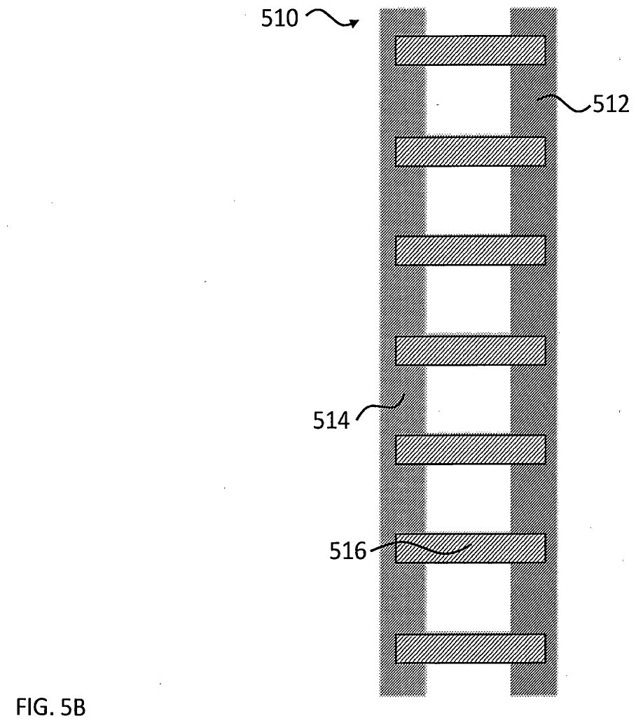

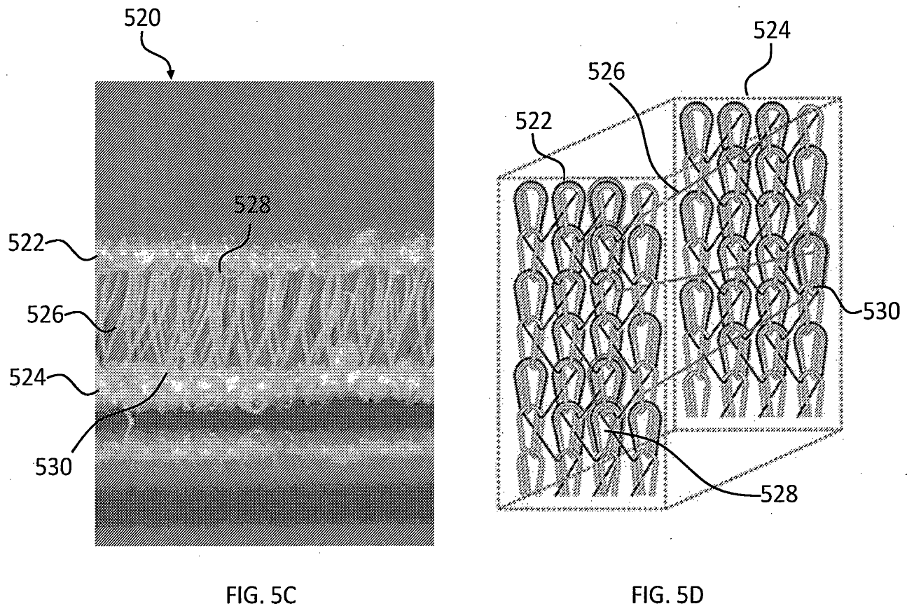

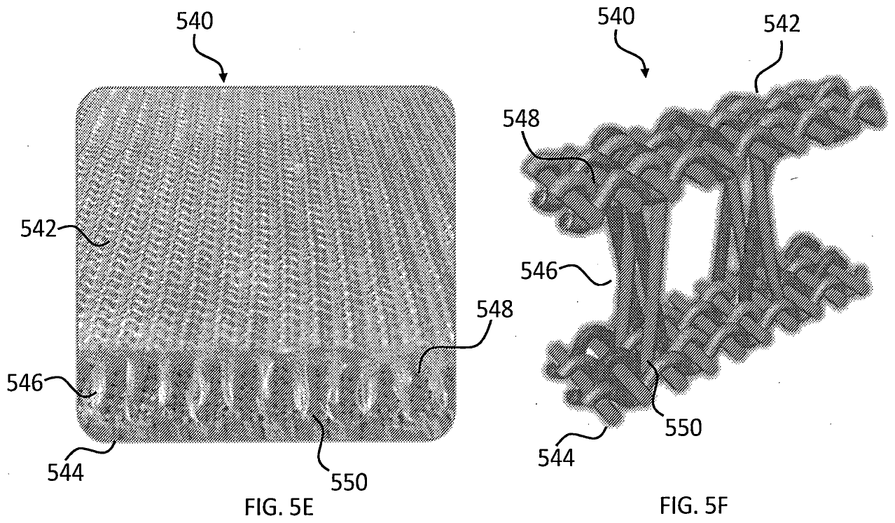

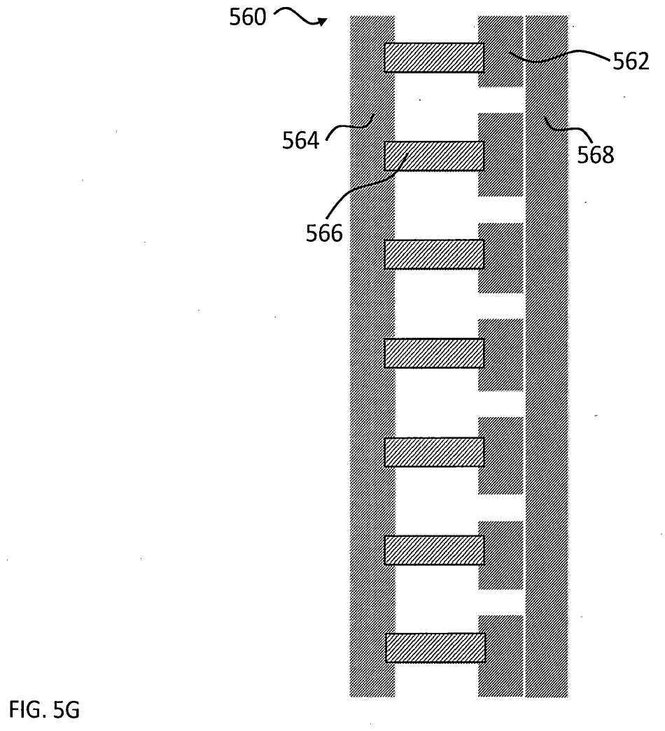

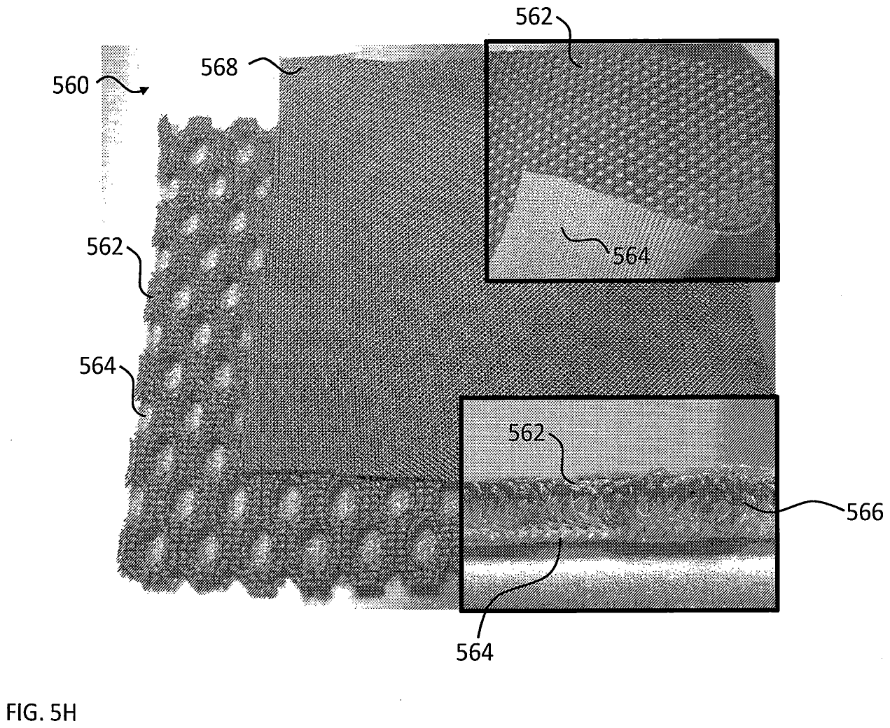

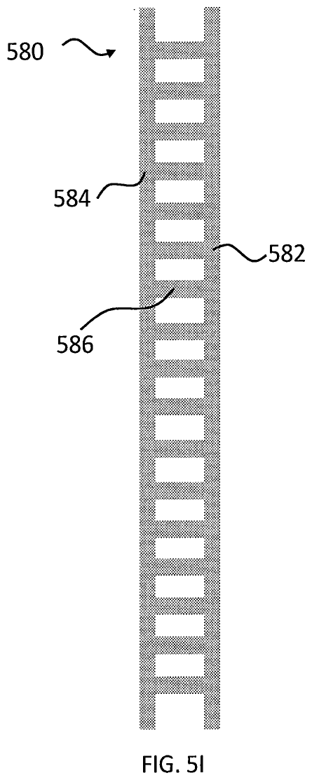

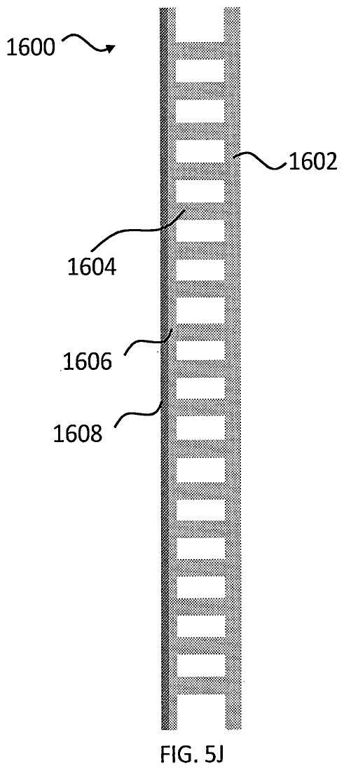

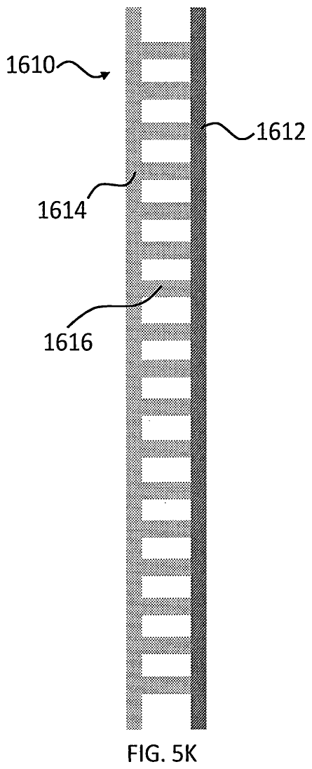

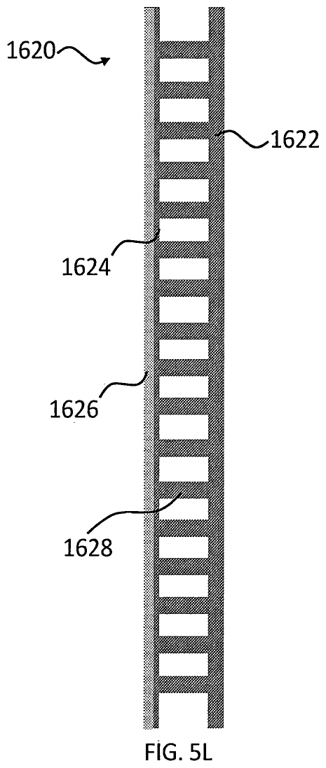

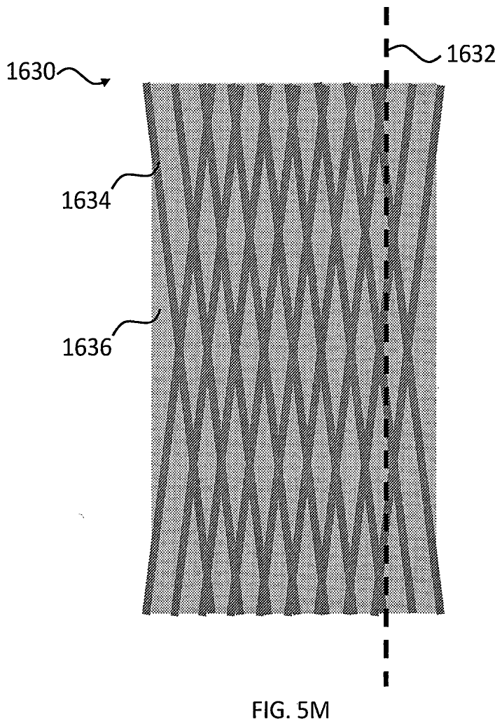

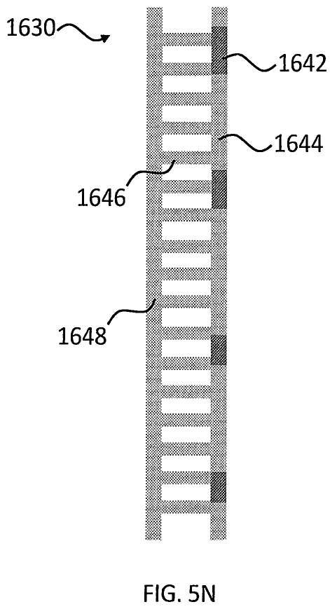

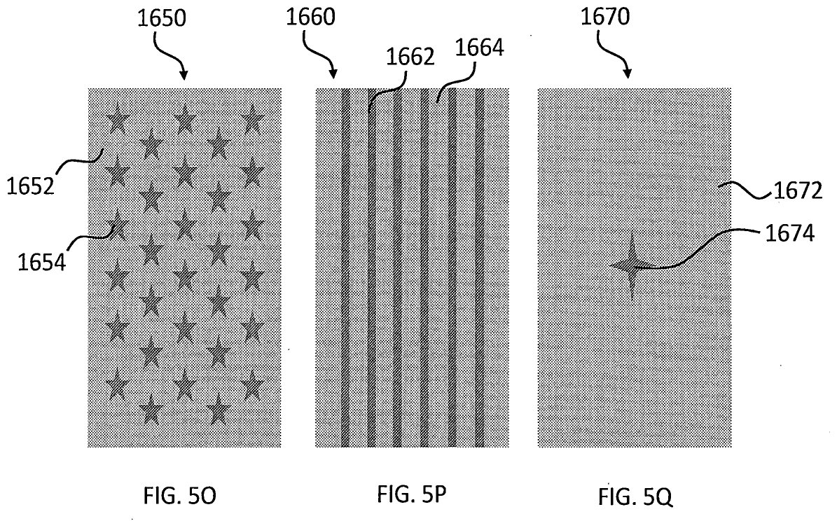

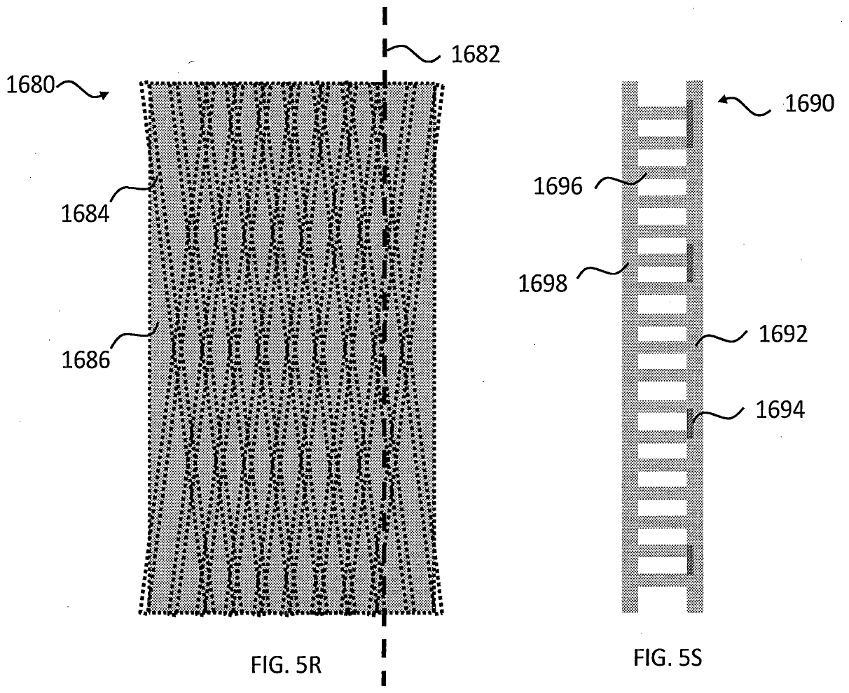

FIGS. 5-9 illustrate optional features and aspects of exemplary articles of the present disclosure. It is to be understood by one of skill in the art that the optional features and aspects illustrated herein (e.g., features including but not limited to particular spacer layer configurations, elements using moisture-impermeable materials, elements using hydrophilic materials, elements using hydrophobic materials, and so forth) may be combined in any combination or configuration. As such, the articles of the present disclosure are not limited to those explicitly illustrated or described herein; those of skill in the art may readily contemplate other combinations and/or embodiments of these features and/or aspects without departing from the scope of the present disclosure.

In some embodiments, a spacer layer of the present disclosure is made of a moisture impermeable material, similar to joint 208. That is to say, most or all of each spacer of the plurality is made from the moisture impermeable material, not just the attachment to the second or inner layer (e.g., joint 208). An exemplary embodiment is shown in FIG. 5A. Article 500 includes first or outer layer 502, second or inner layer 504, and spacer layer 506. In FIG. 5A, spacer layer 506 includes a plurality of discrete spacers. Each discrete spacer of the plurality in spacer layer 506 is made from a moisture-impermeable material of the present disclosure.

Another exemplary embodiment is shown in FIG. 5B. Article 510 includes first or outer layer 512, second or inner layer 514, and spacer layer 516. Spacer layer 516 includes a plurality of discrete spacers having a first end affixed with layer 512 and a second layer affixed with layer 514. In some embodiments, the first and/or second end(s) penetrate into the corresponding layers, e.g., the first end penetrates into the first layer and/or the second end penetrates into the second layer. In some embodiments, one or more of the spacers in spacer layer 516 is made from a moisture-impermeable material of the present disclosure.

In some embodiments, a spacer layer of the present disclosure comprises one or more yarns. In some embodiments, the one or more yarns may be threaded through a first or outer layer of the present disclosure and a second or inner hydrophobic layer of the present disclosure. For example, the first or outer layer and the second or inner layer may be made from textiles (e.g., any of the textiles described herein and/or known in the art) having a plurality of fibers. In some embodiments, the spacer layer includes at least a first yarn threaded through at least one space between the plurality of fibers of the first or outer layer and also threaded through at least one space between the plurality of fibers of the second or inner hydrophobic layer. In some embodiments, the entire spacer layer may be made from a single yarn.

In some embodiments, the size of the space between fibers (e.g., space(s) between the plurality of fibers of the first or outer layer, and/or space(s) between the plurality of fibers of the second or inner layer) can be from 1 μm to 1 mm. In some embodiments, the size of the space between fibers is greater than about any of the following sizes (in μm): 1, 5, 10, 50, 100, 150, 200, 250, 300, 350, 400, 450, 500, 550, 600, 650, 700, 750, 800, 850, 900, or 950. In some embodiments, the size of the space between fibers is less than about any of the following sizes (in μm): 1000, 950, 900, 850, 800, 750, 700, 650, 600, 550, 500, 450, 400, 350, 300, 250, 200, 150, 100, 50, 10, or 5. That is, the size of the space between fibers may be any of a range of sizes (in μm) having an upper limit of 1000, 950, 900, 850, 800, 750, 700, 650, 600, 550, 500, 450, 400, 350, 300, 250, 200, 150, 100, 50, 10, or 5 and an independently selected lower limit of 1, 5, 10, 50, 100, 150, 200, 250, 300, 350, 400, 450, 500, 550, 600, 650, 700, 750, 800, 850, 900, or 950, wherein the lower limit is less than the upper limit.

In some embodiments, the pore size of the first or outer layer is between about 10 μm and 400 μm. In some embodiments, the pore size of the first or outer layer is greater than about any of the following sizes (in μm): 10, 25, 50, 100, 150, 200, 250, 300, or 350. In some embodiments, the pore size of the first or outer layer is less than about any of the following sizes (in μm): 400, 350, 300, 250, 200, 150, 100, 50, or 25. That is, the pore size of the first or outer layer may be any of a range of sizes (in μm) having an upper limit of 400, 350, 300, 250, 200, 150, 100, 50, or 25 and an independently selected lower limit of 10, 25, 50, 100, 150, 200, 250, 300, or 350, wherein the lower limit is less than the upper limit.

In some embodiments, the pore size of the second or inner layer is between about 10 μm and 1.5 mm. In some embodiments, the pore size of the second or inner layer is greater than about any of the following sizes (in μm): 10, 25, 50, 100, 150, 200, 250, 300, 350, 400, 450, 500, 550, 600, 650, 700, 750, 800, 850, 900, 950, 1000, 1100, 1200, 1300, or 1400. In some embodiments, the pore size of the second or inner layer is less than about any of the following sizes (in μm): 1500, 1400, 1300, 1200, 1100, 1000, 950, 900, 850, 800, 750, 700, 650, 600, 550, 500, 450, 400, 350, 300, 250, 200, 150, 100, 50, or 25. That is, the pore size of the second or inner layer may be any of a range of sizes (in μm) having an upper limit of 1500, 1400, 1300, 1200, 1100, 1000, 950, 900, 850, 800, 750, 700, 650, 600, 550, 500, 450, 400, 350, 300, 250, 200, 150, 100, 50, or 25 and an independently selected lower limit of 10, 25, 50, 100, 150, 200, 250, 300, 350, 400, 450, 500, 550, 600, 650, 700, 750, 800, 850, 900, 950, 1000, 1100, 1200, 1300, or 1400, wherein the lower limit is less than the upper limit.

These concepts are illustrated in FIGS. 5C-5F. FIG. 5C provides a cross-section of article 520. In some embodiments, article 520 is a 3D knitted fabric. FIG. 5D illustrates an exemplary structure at yarn scale that can be used to knit article 520 (see www.knittingindustry.com/uploads/1174/3d-fabric-diagram.jpg). If using the design shown in FIG. 5D, article 520 includes first or outer layer 522 and second or inner hydrophobic layer 524. Article 520 also includes spacer layer 526, which is made of one or more monofilament-based yarn(s). The yarn(s) of spacer layer 526 connect layers 522 and 524 by virtue of being threaded through fiber loops of each layer, e.g., through one or more fiber loops from the layer 522 (e.g., loop 528) and through one or more fiber loops from the layer 524 (e.g., loop 530). Spacer layer 526 may be made from a plurality of monofilament-based yarns, or it may be a single monofilament-based yarn continuously threaded through layers 522 and 524. FIG. 5E provides a cross-section of an article with a structure similar to that of article 540 (see www.lbie.com/3dfabric.png). FIG. 5F illustrates an exemplary structure at yarn scale that can be used to knit article 540 (see www.lbie.com/3dWeave.png). In some embodiments, article 540 is a 3D woven fabric. If using the design shown in FIG. 5F, the yarns of spacer layer 546 connect woven layer 542 and 544 by virtue of being threaded through the gaps between fibers of each layer (e.g., gaps 548 and 550).

In some embodiments, the yarn(s) of a spacer layer of the present disclosure (e.g., spacer layer 526 and/or 546) may be made from any suitable material(s) known in the art, including cotton, hemp, rayon, coconut fiber, cellulose, wool, silk, bamboo, polyurethane, polypropylene, polyethylene, glass, acetate, polyester, nylon, elastin fiber, and/or any blend thereof. In some embodiments, the yarn(s) may be monofilament. In some embodiments, the yarn is treated to be hydrophobic. In some embodiments, the yarn(s) of a spacer layer is a multifilament yarn made of a bundle of hydrophobic monofilaments. In some embodiments, a first or outer and/or a second or inner layer of the present disclosure may be a regular knitted or woven fabric, e.g., knitted or woven from any suitable material(s) known in the art and/or described herein.

In some embodiments, a monofilament yarn has diameter from about 10 μm to about 2 mm. In some embodiments, the diameter of the monofilament yarn is greater than about any of the following diameters (in μm): 10, 25, 50, 75, 100, 150, 200, 300, 400, 500, 600, 700, 800, 900, 1000, 1100, 1200, 1300, 1400, 1500, 1600, 1700, 1800, or 1900. In some embodiments, the diameter of the monofilament yarn is less than about any of the following sizes (in μm): 2000, 1900, 1800, 1700, 1600, 1500, 1400, 1300, 1200, 1100, 1000, 900, 800, 700, 600, 500, 400, 300, 200, 150, 100, 75, 50, or 25. That is, the diameter of the monofilament yarn may be any of a range of diameters (in μm) having an upper limit of 2000, 1900, 1800, 1700, 1600, 1500, 1400, 1300, 1200, 1100, 1000, 900, 800, 700, 600, 500, 400, 300, 200, 150, 100, 75, 50, or 25 and an independently selected lower limit of 10, 25, 50, 75, 100, 150, 200, 300, 400, 500, 600, 700, 800, 900, 1000, 1100, 1200, 1300, 1400, 1500, 1600, 1700, 1800, or 1900, wherein the lower limit is less than the upper limit.

Without wishing to be bound to theory, it is thought that a protection layer of the present disclosure provides the structure with improved liquid impact proof capacity while not significantly diminishing its overall air permeability. In some embodiments, the outer layer of the structure has larger openings than the inner layer. In some embodiments, the inner layer of the structure has larger openings than the outer layer. In some embodiments, the outer layer and the inner layer of the structure have openings of approximately equivalent size. In some embodiments, a protection layer (e.g., a woven or knitted fabric) is attached to the structure at the surface of the outer layer (FIG. 5G). In FIG. 5G, article 560 includes outer layer 562, inner layer 564, spacer layer 566, and protection layer 568 affixed to the outer surface of outer layer 562. In some embodiments, protection layer 568 is a woven fabric protection layer, such as a hydrophobic or hydrophilic woven protection layer. In some embodiments, layers 562, 564, and 566 are part of a 3D knitted fabric. In some embodiments, layer 568 is reversibly affixed to layer 562.

In some embodiments, outer layer 562 is made of a porous material with a pore size of between about 10 μm and about 5 mm. For example, in some embodiments, the outer layer has a pore size less than about any of the following sizes (in mm): 5, 4.5, 4, 3.5, 3, 2.5, 2, 1.5, 1, 0.8, 0.6, 0.4, 0.2, 0.08, 0.06, or 0.04. In some embodiments, the outer layer has a pore size greater than about any of the following sizes (in mm): 0.01, 0.04, 0.06, 0.08, 0.2, 0.4, 0.5, 1.0, 1.5, 2, 2.5, 3, 3.5, 4, or 4.5. That is, in some embodiments, an outer layer of the present disclosure may have a pore size of any of a range of pore sizes (in mm) having an upper limit of about 5, 4.5, 4, 3.5, 3, 2.5, 2, 1.5, 1, 0.8, 0.6, 0.4, 0.2, 0.08, 0.06, or 0.04 and an independently selected lower limit of about 0.01, 0.04, 0.06, 0.08, 0.2, 0.4, 0.5, 1.0, 1.5, 2, 2.5, 3, 3.5, 4, or 4.5, wherein the lower limit is less than the upper limit. In some embodiments, the outer layer has a pore size of between about 10 μm and about 400 μm.

In some embodiments, inner layer 564 has a smaller pore size than outer layer 562. In some embodiments, inner layer 564 includes a hydrophobic porous material having a pore size of between about 15 μm and about 1.5 mm. For example, in some embodiments, the inner layer has a pore size less than any of the following sizes (in μm): 500, about 400, about 300, about 200, about 100, about 90, about 80, about 70, about 60, about 50, about 40, about 30, or about 20. In some embodiments, the inner layer has a pore size greater than about any of the following sizes (in μm): 15, 20, 30, 40, 50, 60, 70, 80, 90, 100, 200, 300, or 400. That is, in some embodiments, an inner layer of the present disclosure may have a pore size of any of a range of pore sizes (in μm) having an upper limit of 500, about 400, about 300, about 200, about 100, about 90, about 80, about 70, about 60, about 50, about 40, about 30, or about 20 and an independently selected lower limit of about 15, 20, 30, 40, 50, 60, 70, 80, 90, 100, 200, 300, or 400, wherein the lower limit is less than the upper limit.

In some embodiments, protection layer 568 has a pore size of between about 10 μm and about 400 μm. For example, in some embodiments, the protection layer has a pore size less than about any of the following sizes (in μm): 400, 350, 300, 250, 200, 150, 100, 90, 80, 70, 60, 50, 40, 30, or 20. In some embodiments, the protection layer has a pore size greater than about any of the following sizes (in μm): 10, 20, 30, 40, 50, 60, 70, 80, 90, 100, 150, 200, 250, 300, or 350. That is, in some embodiments, a protection layer of the present disclosure may have a pore size of about any of a range of pore sizes (in μm) having an upper limit of 400, 350, 300, 250, 200, 150, 100, 90, 80, 70, 60, 50, 40, 30, or 20 and an independently selected lower limit of about 10, 20, 30, 40, 50, 60, 70, 80, 90, 100, 150, 200, 250, 300, or 350, wherein the lower limit is less than the upper limit.

Article 560 is further illustrated in FIG. 5H. Article 560 is a combination of 3D knitted/woven fabric and a single layer of dense woven fabric. The 3D knitted/woven fabric is composed of outer layer 562, spacer layer 566, and inner hydrophobic layer 564. Layer 562 has large openings in its structure. Protection layer 568 is a woven layer attached to the layer 562 of the 3D fabric. In some embodiments, the large opening size of the first layer is from 0.5 mm to 5 mm. In some embodiments, the pore size of protection layer is from 10 μm to 400 μm. In some embodiments, the protection layer and the 3D spacer structure are affixed to form one piece of material. In some embodiments, the protection layer and the 3D spacer structure are reversibly affixed. In other embodiments, the protection layer and the 3D spacer structure are bonded together, e.g., by lamination. In some embodiments, the protection layer can be hydrophobic (e.g., able to resist a hydrostatic pressure larger than 0.1 kpa). In some embodiments, the protection layer can be hydrophilic (e.g., resists a hydrostatic pressure less than 0.1 kpa). The unexpectedly high resistance to liquid impact pressure coupled with superior air permeability demonstrated by the articles of the present disclosure make them highly advantageous for use as waterproof fabrics, e.g., as part of a garment, outerwear, footwear (e.g., a shoe or boot), outdoor gear (e.g., a tent or sleeping bag), a pack, an umbrella, rain gear, an outerwear accessory, and/or a leak-proof layer for use in a diaper, pad, wound dressing, or bed sheet.

In some embodiments, the first, second and spacer layers of the fabric possess various combinations of wettability (i.e. hydrophilicity, hydrophobicity). The first layer is the outside layer and the second layer is the inside layer. Each combination shown in FIGS. 5I-5L, described below, is believed to possess benefits in certain applications.

In some embodiments, the first or outer layer, the spacer layer, and the second or inner layer each comprise a hydrophobic porous material. Article 580 is illustrated in FIG. 5I. Article 580 includes first or outer layer 582, second or inner layer 584, and spacer layer 586. In FIG. 5I, each of the first, second, and spacer layers comprises a hydrophobic material.

In some embodiments, the first or outer layer and the spacer layer each comprise a hydrophobic porous material, and the second or inner layer comprises a first surface, adjacent to the spacer layer, comprising a hydrophobic porous material and a second surface, comprising a hydrophilic material, behind the first surface. Article 1600 is illustrated in FIG. 5J. In article 1600, only inside surface 1608 of the second layer comprises a hydrophilic material. The remaining portion of second layer 1606, spacer layer 1604, and first or outer layer 1602 comprise hydrophobic materials. In some embodiments, the first surface comprises between about 10% and about 95% of the thickness of the second layer, e.g., about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the thickness of the second layer. In certain embodiments, the thickness of the hydrophobic portion of layer 1606 can be between 10% and 95% of the total thickness of the second layer. For example, in some embodiments, the first surface comprises less than about any of the following percentages of the thickness of the second layer: 95, 90, 85, 80, 75, 70, 65, 60, 55, 50, 45, 40, 35, 30, 25, 20, or 15. In some embodiments, the first surface comprises greater than about any of the following percentages of the thickness of the second layer: 10, 15, 20, 25, 30, 35, 40, 45, 50, 55, 60, 65, 70, 75, 80, 85, or 90. That is, in some embodiments, the first surface comprises a percentage of the thickness of the second layer of any of a range of percentages having an upper limit of about 95, 90, 85, 80, 75, 70, 65, 60, 55, 50, 45, 40, 35, 30, 25, 20, or 15 and an independently selected lower limit of about 10, 15, 20, 25, 30, 35, 40, 45, 50, 55, 60, 65, 70, 75, 80, 85, or 90, wherein the lower limit is less than the upper limit. Without wishing to be bound to theory, this structure is believed to provide wicking properties to the layer that is in closer contact with the inside clothes (e.g., surface 1608) and to help moisture distribution.

In some embodiments, the second or inner layer and the spacer layer each comprise a hydrophobic porous material, and the first or outer layer comprises a hydrophilic material. Article 1610 is illustrated in FIG. 5K. In article 1610, first layer 1612 comprises a hydrophilic material. Second layer 1614 and spacer layer 1616 comprise a hydrophobic material. Without wishing to be bound to theory, this configuration is believed to provide an absorptive/wicking property to first layer 1612 of the fabric. This can be useful in leak-proof applications, for example as bedsheet or car seat covers. This configuration is beneficial because it is believed that there is much less accumulation of liquid in between the layers due to the spreading of liquid in the first layer 1612. This allows for fabrics to stay waterproof in the presence of strong/instant mechanical impacts.

In some embodiments, the first or outer layer and the spacer layer each comprise a hydrophilic material, and the second or inner layer comprises a first surface, adjacent to the spacer layer, comprising a hydrophilic material, and a second surface, behind the first surface, comprising a hydrophobic porous material. Article 1620 is illustrated in FIG. 5L. In article 1620, only inside surface 1626 of the second layer comprises a hydrophobic material. The remaining portion of second layer 1624, spacer layer 1628, and first or outer layer 1622 comprise a hydrophilic material. Without wishing to be bound to theory, this configuration is thought to be very absorptive and improve the absorption capacity of the structure while being leak-proof.

In some embodiments, the first layer comprises a first portion comprising a hydrophobic porous material and a second portion comprising a hydrophilic material. In some embodiments, the second layer, spacer layer and a portion of the first layer comprise a hydrophobic material while the remaining portion of the first layer comprises a hydrophilic material. In some embodiments, the hydrophilic and hydrophobic portions of the first layer form a pattern, e.g., on the outer surface of the first layer. Some exemplary configurations are shown in FIG. 5M & FIGS. 5O-5Q. FIG. 5M depicts article 1630. In article 1630, hydrophilic portions 1634 are interconnected to form a network pattern, and hydrophobic portions 1636 make up the remainder of the first layer. FIG. 5N illustrates a cross-section of article 1630 taken along plane 1632. As shown in FIG. 5N, both hydrophilic portions 1642 and hydrophobic portions 1644 extend through the first layer of the fabric. Second layer 1648 and spacer layer 1646 both comprise a hydrophobic material. The pattern formed on the first layer can be any pattern, including without limitation, repeated, curved, linear, or geometric patterns; straight lines or interconnected networks; or a single pattern or design (e.g., a logo). Exemplary embodiments include articles 1650, 1660, and 1670 (shown in FIGS. 5O-5Q) that have various hydrophilic patterns (i.e., 1654, 1662, and 1674) and portions that are hydrophobic (i.e., 1652, 1664, 1672). In one embodiment, the pattern can be a logo, e.g., of the apparel manufacturer. In another embodiment, the pattern is a customized slogan. In some embodiments, the widths of the patterns are between about 1 mm and about 1 cm, e.g., about 1 mm, about 2 mm, about 3 mm, about 4 mm, about 5 mm, about 6 mm, about 7 mm, about 8 mm, about 9 mm, or about 1 cm. In some embodiments, the pattern can cover between about 5% and about 50% of the total area of the first layer. For example, in some embodiments, the pattern covers less than about any of the following percentages of the total area of the first or outer layer: 50, 45, 40, 35, 30, 25, 20, 15, or 10. In some embodiments, the pattern covers greater than about any of the following percentages of the total area of the first or outer layer: 5, 10, 15, 20, 25, 30, 35, 40, or 45. That is, in some embodiments, the pattern covers a percentage of the first or outer layer of any of a range of percentages having an upper limit of about 50, 45, 40, 35, 30, 25, 20, 15, or 10 and an independently selected lower limit of about 5, 10, 15, 20, 25, 30, 35, 40, or 45, wherein the lower limit is less than the upper limit. In one embodiment, the patterns are only visible when the hydrophilic portion of the first layer is wet. Without wishing to be bound to theory, it is believed that a connected hydrophilic portion is helpful for drainage of moisture through the first layer of the fabric. It can also help to dry moisture that sticks to the first layer of the liquid impact-proof fabric.

In some embodiments, the second portion of the first or outer layer comprises a first sub-portion abutting a second sub-portion in a cross-section of the first layer, wherein only the first sub-portion is present on the outer surface of the first or outer layer, wherein the first sub-portion comprises a hydrophobic porous material, and wherein the second sub-portion comprises the hydrophilic material. For example, in some embodiments, the hydrophilic portion of the first layer is on the inside surface of the first layer such that the hydrophilic layer does not completely penetrate the first layer. An example of this configuration is shown in FIGS. 5R and 5S. FIG. 5S (article 1690) shows a cross-section of article 1680 along plane 1682. In article 1690, hydrophobic portion 1692 of the first layer is on the outside surface of the first layer and hydrophilic portion 1694 is on the inner surface of the first layer (in FIG. 5R, this configuration is depicted as dotted line 1684). In some embodiments, the hydrophilic sub-portion comprises between about 5% and about 95% of the thickness of the first or outer layer, e.g., about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the thickness of the second layer. For example, in some embodiments, the hydrophilic sub-portion comprises less than about any of the following percentages of the thickness of the first or outer layer: 95, 90, 85, 80, 75, 70, 65, 60, 55, 50, 45, 40, 35, 30, 25, 20, or 15. In some embodiments, the hydrophilic sub-portion comprises greater than about any of the following percentages of the thickness of the first or outer layer: 10, 15, 20, 25, 30, 35, 40, 45, 50, 55, 60, 65, 70, 75, 80, 85, or 90. That is, in some embodiments, the hydrophilic sub-portion comprises a percentage of the thickness of the first or outer layer of any of a range of percentages having an upper limit of about 95, 90, 85, 80, 75, 70, 65, 60, 55, 50, 45, 40, 35, 30, 25, 20, or 15 and an independently selected lower limit of about 10, 15, 20, 25, 30, 35, 40, 45, 50, 55, 60, 65, 70, 75, 80, 85, or 90, wherein the lower limit is less than the upper limit. For example, in some embodiments, the penetration of hydrophilic portion 1694 can be between 5% and 95% of the total thickness of the first layer. Spacer layer 1696 and second layer 1698 are both hydrophobic. As shown in FIG. 5R, the remaining portion of the first layer (e.g., 1686) can be hydrophobic. In some embodiments, the hydrophilic pattern is not visible from the outside of the fabric, and the outside of the fabric is completely water repellent. Without wishing to be bound to theory, it is believed that this configuration helps the drainage of liquid between the layers of structures while keeping the outside of the fabric completely water repellent, without wetness and/or visibility of the hydrophilic patterns.

In some embodiments of any of the structures described above in reference to FIGS. 5I-5S, one or both ends of the spacer layer can penetrate into the first or outer and/or second or inner layer. In some embodiments of any of the structures described above in reference to FIGS. 5I-5S, the spacer layer can comprise one or more yarns threaded through the first or outer and/or second or inner layer (e.g., produced by 3D knitting or weaving as described herein).

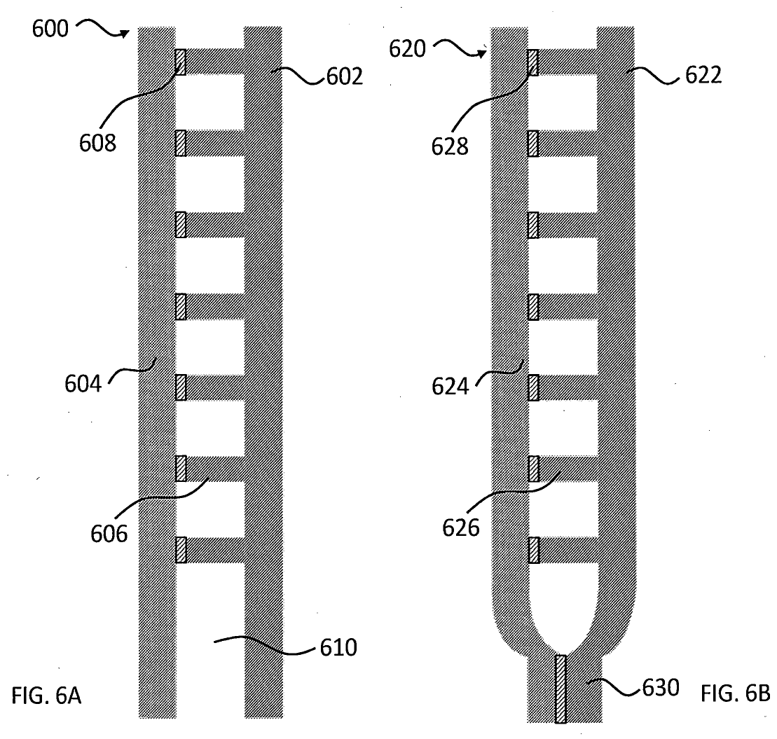

Turning now to FIGS. 6A & 6B, in some embodiments, a spacer layer of the present disclosure is open to airflow in at least a first end. In FIG. 6A, article 600 includes first or outer layer 602, second or inner layer 604, and spacer layer 606 with a moisture-impermeable material of the present disclosure in at least joint 608. One end of article 600 is open to airflow, as shown at end 610. End 610 is permeable to liquid, so that the accumulated moisture can be drained away.

In FIG. 6B, article 620 includes first or outer layer 622, second or inner layer 624, and spacer layer 626 with a moisture-impermeable material of the present disclosure in at least joint 628. One end of article 620 is open to airflow but is also configured to allow reversible sealing, as shown at end 630 (illustrated in the sealed position). When end 630 is left open, an additional passage for airflow and moisture flow is provided directly through spacer layer 626. In some embodiments, a fastening means can be integrated at end 630 to open, close, and seal. Any fastening means known in the art may be used, including without limitation one or more zippers, buttons, ties, clasps, pins, snaps, and the like.

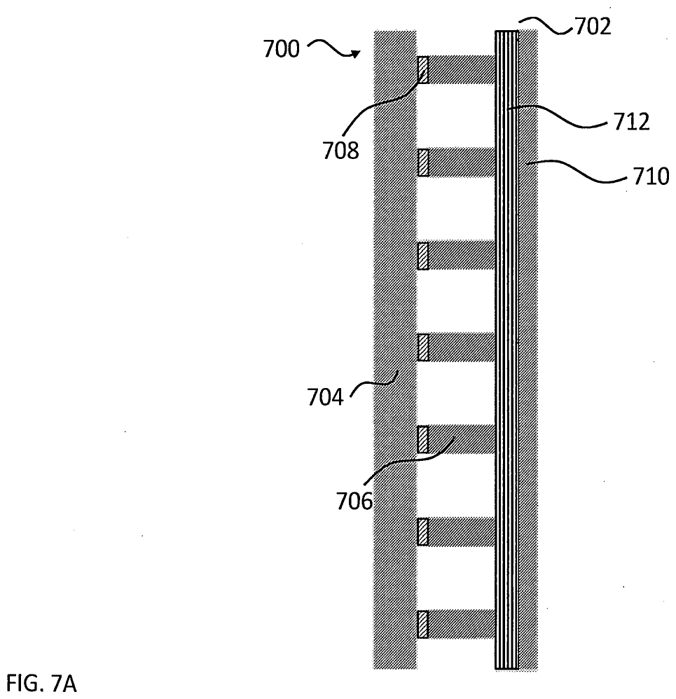

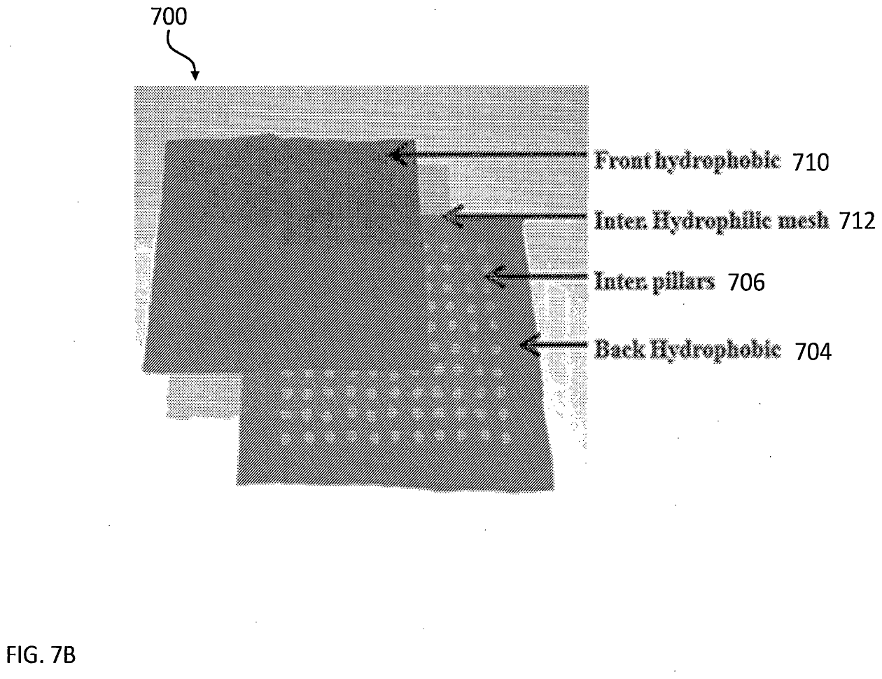

In some embodiments, an article of the present disclosure includes a hydrophilic material. In some embodiments, a first or outer layer of the present disclosure includes a hydrophilic material of the present disclosure. One exemplary configuration is shown in FIGS. 7A & 7B. As shown in the cross-sectional view illustrated in FIG. 7A, article 700 includes first or outer layer 702, second or inner layer 704, and spacer layer 706 with a moisture-impermeable material of the present disclosure in at least joint 708. Layer 702 includes a first surface 710 comprising a porous material of the present disclosure. Surface 710 is positioned facing outward, e.g., to receive a liquid impact. In some embodiments, the porous material of surface 710 is a hydrophobic porous material of the present disclosure. Layer 702 further includes a second surface 712 comprising a hydrophilic material of the present disclosure. Surface 712 is attached to spacer layer 706. Without wishing to be bound to theory, it is thought that the addition of a hydrophilic material to layer 702 (e.g., at surface 712) provides the capacity of quickly removing the moisture penetrated through surface 710. In some embodiments, surfaces 710 and 712 of layer 702 can be a single layer of fabric, with one side of the fabric treated with hydrophobic coating while the other side being hydrophilic. In other embodiments, the hydrophilic fabric can be patterned to separate regions for drainage. In some embodiments, one or both ends of spacer layer 706 penetrates into layer 704 and/or layer 702 (e.g., at surface 712). In some embodiments, spacer layer 706 comprises one or more yarns threaded through layer 704 and/or layer 702 (e.g., produced by 3D knitting or weaving as described herein).

A top view showing each layer of article 700 is provided in FIG. 7B. Both surfaces of first or outer layer 702 are shown. In this example, each surface is made from a different material. Moving from outward in, surface 710 is made from a hydrophobic material of the present disclosure (in this example, a fabric). Next, surface 712 is made from a hydrophilic material of the present disclosure (in this example, a hydrophilic mesh). Attached to surface 712 is spacer layer 706, which comprises an array of cylindrical pillars. Attached to spacer layer 706 is second or inner layer 704, which is made from a hydrophobic material of the present disclosure (in this example, a hydrophobic fabric of the present disclosure).

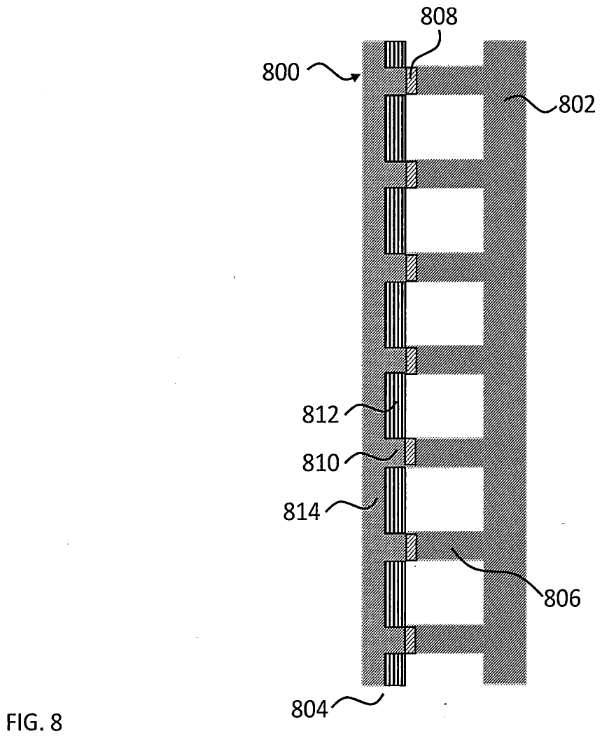

Turning now to FIG. 8, in some embodiments, a second or inner layer of the present disclosure includes a hydrophilic material of the present disclosure. Article 800 includes first or outer layer 802, second or inner layer 804, and spacer layer 806 with a moisture-impermeable material of the present disclosure in at least joint 808. Spacer layer 806 includes a plurality of discrete spacers of the present disclosure. Layer 804 includes a first surface attached to spacer layer 806. The first surface includes first portion 810 located at the attachments between layer 804 and spacer layer 806 and second portion 812 located around the attachments between layer 804 and spacer layer 806. Portion 810 comprises a hydrophobic porous material of the present disclosure, while portion 812 comprises a hydrophilic material of the present disclosure. Layer 804 also includes second surface 814, which is behind the first surface in the direction of the liquid impact or faces inward. Surface 814, like portion 810, comprises a hydrophobic porous material of the present disclosure. Portion 812 is thought to facilitate drainage of liquid from spacer layer 806. In some embodiments, the first and second surfaces layers of layer 804 can be combined into one layer of fabric, with one side of the fabric treated with patterned hydrophilic pattern and the other side being completely hydrophobic.

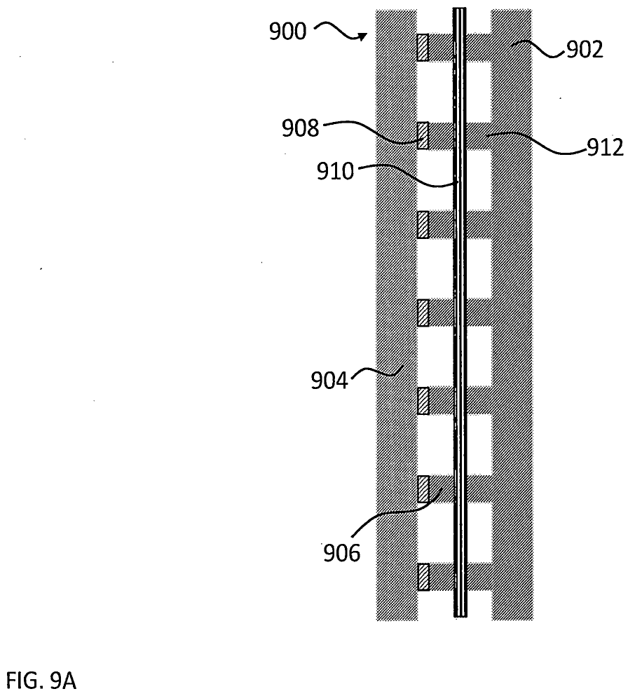

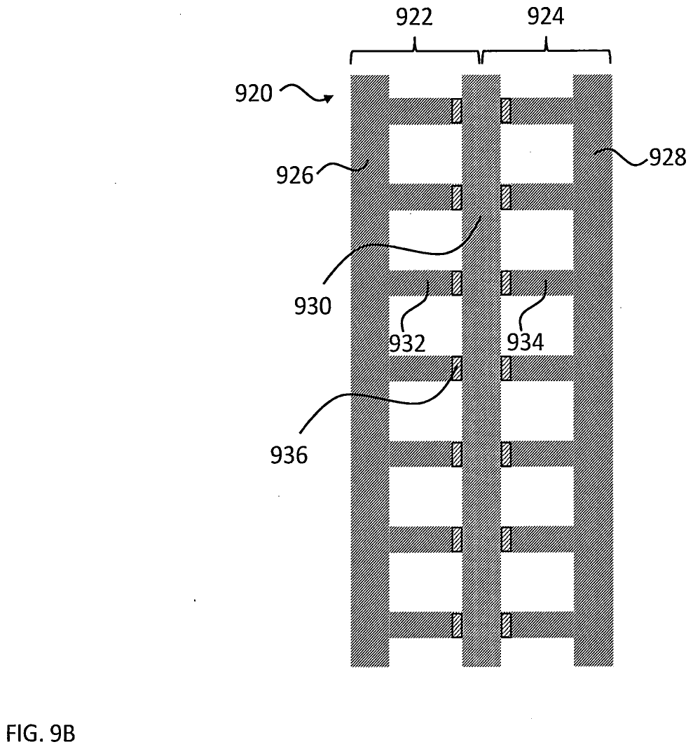

Turning now to FIG. 9A, in some embodiments, a spacer layer of the present disclosure includes a hydrophilic material of the present disclosure. This is illustrated with exemplary article 900. Article 900 includes first or outer layer 902, second or inner layer 904, and spacer layer 906 with a moisture-impermeable material of the present disclosure in at least joint 908. Spacer layer 906 also includes hydrophilic layer 910, which is made from a hydrophilic material of the present disclosure. Hydrophilic layer 910 is positioned between the first end (e.g., at joint 908) and the second end (e.g., at joint 912) of spacer layer 906, which includes a plurality of discrete spacers. Hydrophilic layer 910 connects multiple discrete spacers of the plurality. Without wishing to be bound to theory, it is thought that this design helps facilitate airflow between the layers of the structure.

In some embodiments, two liquid impact proof structures of the present disclosure can be placed with the two inner layers of the structure bonded together. In some embodiments, one layer of material is in the middle instead of two layers of materials. An exemplary embodiment of this concept is illustrated in FIG. 9B. Article 920 is shown with liquid impact proof structures 922 and 924 bonded together. Each has a first or outer layer of the present disclosure (e.g., 926 and 928, respectively). Each has a second or inner layer of the present disclosure, and both second or inner layers are bonded together to form layer 930. In some embodiments, layer 930 is a single layer rather than two individual layers bonded together. 922 and 924 each have a spacer layer of the present disclosure (e.g., 932 and 934, respectively). In some embodiments, one or more of the spacer layers includes a moisture impermeable material in at least one of the joints connecting layer 932 and/or 934 to layer 930, such as joint 936. Without wishing to be bound to theory, it is thought that this design helps maintain the capacity of liquid impact proof layer when the inside surface contacting the fabric is also wet.

A variety of hydrophilic materials may suitably be used as described above. In some embodiments, a hydrophilic material of the present disclosure is a textile. In some embodiments, the textile includes without limitation a natural fiber, a synthetic fiber, or a blend thereof. For example, in some embodiments, a textile of the present disclosure may include without limitation cotton, hemp, rayon, coconut fiber, cellulose, wool, silk, bamboo, polyurethane, polypropylene, polyethylene, glass, acetate, polyester, nylon, elastin fiber, and/or any blend thereof.

A variety of materials may suitably be used in a first or outer layer of the present disclosure, e.g., in a porous material as described above. In some embodiments, a first or outer layer of the present disclosure may include a metal mesh or a polymer mesh. In some embodiments, a first or outer layer of the present disclosure may include a textile. In some embodiments, the textile includes without limitation a natural fiber, a synthetic fiber, or a blend thereof. For example, in some embodiments, a textile of the present disclosure may include without limitation cotton, hemp, rayon, coconut fiber, cellulose, wool, silk, bamboo, polyurethane, polypropylene, polyethylene, glass, acetate, polyester, nylon, elastin fiber, and/or any blend thereof.

A variety of materials may suitably be used as a hydrophobic material of the present disclosure. In some embodiments, a hydrophobic material of the present disclosure comprises polypropylene, polydimethylsiloxane (PDMS), or a fluoro-polymer (including without limitation a polymer made from tetrafluoroethylene-, vinyl fluoride-, perfluoroether-, vinylidene fluoride-, or chlorotrifluoroethylene-based monomers). In some embodiments, hydrophobicity of the hydrophobic material can be achieved through a hydrophobic and/or liquid-repellent coating (e.g., a fluoropolymer, silicone, hydrosilicone, fluoroacrylate, wax, or olefin) or using inherent hydrophobic fibers, including polypropylene, PDMS, etc. For example, a hydrophobic material of the present disclosure may comprise a porous material of the present disclosure with a hydrophobic coating on at least a first surface, e.g., as described above. Such porous materials may include, without limitation, a metal mesh, a polymer mesh, or a textile of the present disclosure. In some embodiments, the textile includes without limitation a natural fiber, a synthetic fiber, or a blend thereof. For example, in some embodiments, a textile of the present disclosure may include without limitation cotton, hemp, rayon, coconut fiber, cellulose, wool, silk, bamboo, polyurethane, polypropylene, polyethylene, glass, acetate, polyester, nylon, elastin fiber, and/or any blend thereof.

As described herein, the articles of the present disclosure advantageously allow for a high degree of liquid impact resistance provided synergistically by spaced constituent layers. Due to the nature of the structure, each constituent layer may display relatively high permeability and breathability while still providing a high degree of liquid impact resistance. This contrasts with existing waterproof materials such as GORE-TEX® membrane (see, e.g., U.S. Pat. No. 4,868,928), which has a pore size ˜0.2 μm in scale and thus possesses limited air permeability.

As used herein, pore size may refer to a maximum or largest pore diameter of a porous material. In some embodiments, a porous material of the present disclosure has a pore size less than about any of the following sizes (in μm): 1000, 750, 500, 250, 100, 50, 25, or 15. In some embodiments, a porous material of the present disclosure has a pore size greater than about any of the following sizes (in μm): 10, 15, 25, 50, 100, 250, 500, or 750. That is, a porous material of the present disclosure may have a pore size of any of a range of pore sizes having an upper limit of 1000, 750, 500, 250, 100, 50, 25, or 15 and an independently selected lower limit of 10, 15, 25, 50, 100, 250, 500, or 750, wherein the lower limit is less than the upper limit. In some embodiments, a porous material of the present disclosure (e.g., of a first or outer layer of the present disclosure) has a pore size of between about 10 μm and about 1 mm. In some embodiments, a porous material of the present disclosure (e.g., of a first or outer layer of the present disclosure) has a pore size of between about 15 μm and about 1 mm. In certain embodiments, a porous material of the present disclosure (e.g., of a first or outer layer of the present disclosure) has a pore size of between about 50 μm and about 1 mm. In some embodiments, a hydrophobic porous material of the present disclosure has a pore size less than about any of the following sizes (in μm): 1000, 750, 500, 250, 100, 50, 25, or 15. In some embodiments, a hydrophobic porous material of the present disclosure has a pore size greater than about any of the following sizes (in μm): 10, 15, 25, 50, 100, 250, 500, or 750. That is, a hydrophobic porous material of the present disclosure may have a pore size of any of a range of pore sizes having an upper limit of 1000, 750, 500, 250, 100, 50, 25, or 15 and an independently selected lower limit of 10, 15, 25, 50, 100, 250, 500, or 750, wherein the lower limit is less than the upper limit. In some embodiments, a hydrophobic porous material of the present disclosure has a pore size of between about 10 μm and about 1 mm. In some embodiments, a hydrophobic porous material of the present disclosure has a pore size of between about 15 μm and about 1 mm. In certain embodiments, a hydrophobic porous material of the present disclosure (e.g., of a first or outer layer of the present disclosure) has a pore size of between about 50 μm and about 1 mm.

As used herein, resistance to a liquid impact may refer to the ability of a material (e.g., an article of the present disclosure) to prevent liquid from penetrating through the material (e.g., through a second or inner layer of the present disclosure). In some embodiments, an article of the present disclosure resists a liquid impact having an impact pressure of up to about 250 kPa. This high degree of resistance is provided by the synergistic effect of two material layers separated by a spacer layer of the present disclosure. In some embodiments, a first or outer layer of the present disclosure resists a liquid impact having an impact pressure of up to about 6 kPa. In some embodiments, a second or inner layer of the present disclosure resists a liquid impact having an impact pressure of up to about 6 kPa.

The articles of the present disclosure may find use in a variety of waterproof materials. In some embodiments, an article of the present disclosure comprises or is part of a waterproof fabric. In some embodiments, a waterproof fabric of the present disclosure may be a component of a garment, outerwear, footwear (e.g., a shoe or boot), outdoor gear (e.g., a tent or sleeping bag), a pack, an umbrella, rain gear, an outerwear accessory, and/or a leak-proof layer for use in a diaper, pad, wound dressing, or bed sheet.

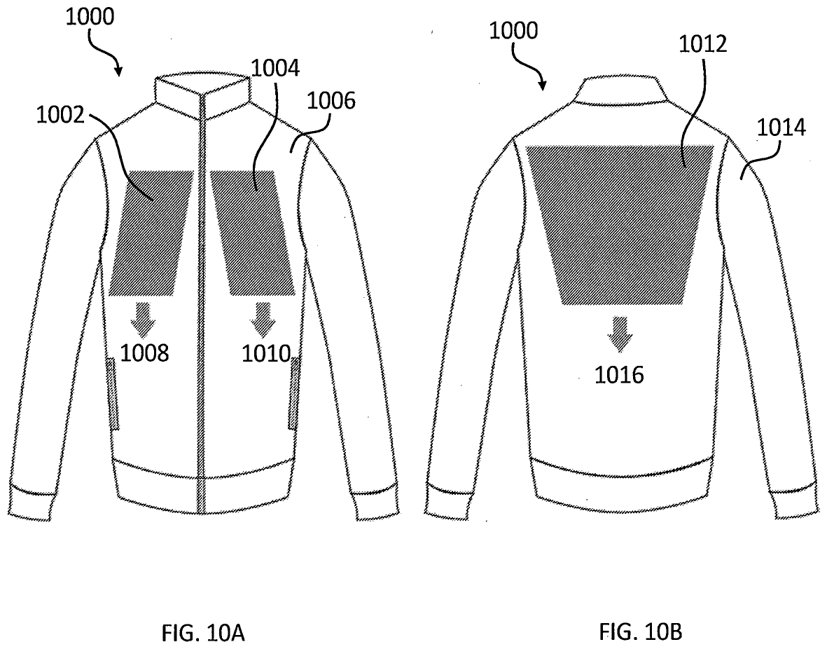

Garments can be made with the aforementioned structures. In one embodiment, the whole garment is constructed with the aforementioned impact proof material (e.g., an article of the present disclosure). Alternatively, as shown in FIGS. 10A & 10B, only certain sections of the garment are replaced with this material, such as chest, middle back, etc., whereas other regions are still covered by conventional rainproof fabrics. In some embodiments, sections of the garment where a wearer's sweat accumulates (e.g., the chest, back, etc.) are replaced with an article of the present disclosure. For example, FIG. 10A shows a front view of an exemplary jacket 1000. Jacket 1000 has sections 1002 and 1004 made of an article of the present disclosure, as well as material 1006, which may be another material or even a different waterproof material (e.g., GORE-TEX®). Sections 1002 and 1004 have water drainage down and away from the wearer at the bottom of sections 1002 and 1004 when worn on the body, as depicted by arrows 1008 and 1010, respectively. FIG. 10B shows a back view of an exemplary jacket 1000. Jacket 1000 has back section 1012 made of an article of the present disclosure, as well as material 1014, which may be another material or even a different waterproof material (e.g., GORE-TEX®). Like sections 1002 and 1004, section 1012 has water drainage down and away from the wearer at the bottom of section 1012 when worn on the body, as depicted by arrow 1016.

In some embodiments, a garment can be formed using several layers of articles together, where one piece and the other piece can be separable. In one embodiment, one piece of the garment can be a hydrophobic inner layer of the present disclosure made with knitted material, while the other piece is a jacket integrated with a hydrophobic layer and spacer layer of the present disclosure. When it is not raining, one only needs to wear the knitted layer for maximum comfort and flexibility. When it is raining, the other layer may be worn on the outside and provide greater protection against heavy rain. In one embodiment, one piece of the garment can be a 3D spacer fabric (e.g., containing an outer layer with a porous material having a pore size of between 0.5 mm and about 5 mm, a spacer layer, and an inner layer with a hydrophobic porous material having a pore size of between about 15 μm and less than 0.5 mm), while the other piece is a garment made of a protection layer (e.g., reversibly affixed to the outer layer). In some embodiments, the protection layer has a pore size of between about 10 μm and about 400 μm.

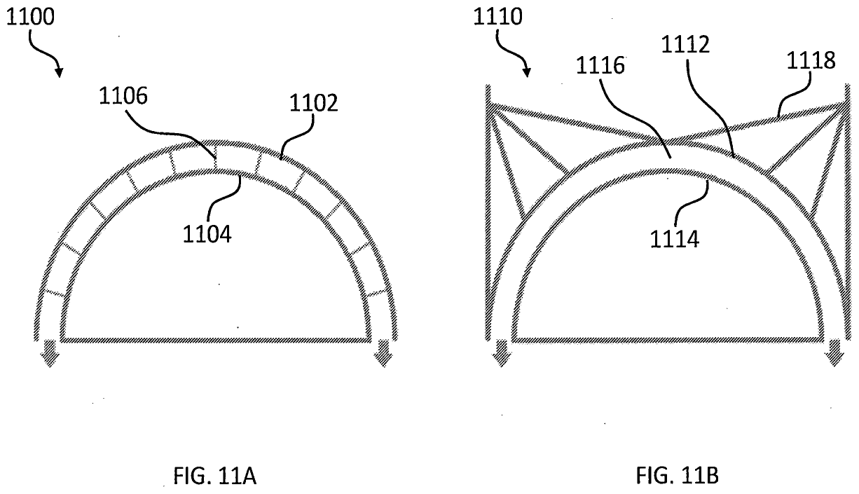

FIGS. 11A & 11B show a similar structure applied to a tent. Tent 1100 in FIG. 11A is composed of at least two layers of porous structures: outer layer 1102 and inner layer 1104. The two layers of fabrics are separated by spacer layer 1106, e.g., a spacer layer of the present disclosure comprising multiple discrete spacers. Fluid is drained on the outside of layer 1104, flowing to the sides of the tent and keeping the interior dry, as depicted by arrows. Tent 1110 in FIG. 11B is composed of at least two layers of porous structures: outer layer 1112 and inner layer 1114. A spacer layer 1116, e.g., a spacer layer of the present disclosure, separates layers 1112 and 1114. In some embodiments, layer 1112 is suspended by support structure 1118 (e.g., by external cables) that maintains spacer layer 1116 by separating layers 1112 and 1114. As such, rather than utilizing a physical spacer layer (e.g., a plurality of discrete spacers), in some embodiments (e.g., FIGS. 1A and 11B), a spacer layer of the present disclosure comprises a space separating a first or outer layer and a second or inner layer of the present disclosure. In some embodiments, the first or outer layer and/or the second or inner layer is affixed to a support structure (e.g., 1118) that maintains separation between the first or outer layer and the second or inner layer.

II. Methods of Making Articles with a Liquid Impact-Proof Structure

Certain aspects of the present disclosure relate to methods of making an article that resists liquid impact of the present disclosure. Exemplary methods of making these articles are set forth below, but the skilled artisan will appreciate that various fabrication methods and materials known in the art may be used to manufacture the articles of the present disclosure, depending upon the specific configuration of the article, without departing from the scope of the present disclosure.

In some embodiments, an article of the present disclosure is manufactured using a lamination process. In some embodiments, the article of the present disclosure includes a first layer or outer layer (e.g., positioned to receive a liquid impact), a second or inner layer (e.g., positioned behind the first layer in the direction of the liquid impact), and a spacer layer separating the first or outer layer and the second or inner layer.

In one embodiment, in the first step, one layer of the spacer material and one layer of adhesion film are laminated together. Then, the spacer structure can be cut from the combined layers, which are laminated with the other two fabric layers together. For example, in some embodiments, a method of making the article may include providing a spacer material; applying an adhesive film onto the spacer material; laminating the applied adhesive film and the spacer material together; and cutting the laminated adhesive film and spacer material into a plurality of discrete spacers to generate the spacer layer. As such, the spacer layer contains a first surface comprising the adhesive film and a second surface comprising the spacer material. Next, the method includes bonding the spacer layer to the first or outer layer and the second or inner layer by lamination. In some embodiments, the spacer layer is bonded between the first or outer layer and the second or inner layer, the second or inner layer comprises a hydrophobic porous material of the present disclosure on at least a first surface of the second or inner layer, and the first surface of the spacer layer is bonded to the first surface of the second or inner layer. In some embodiments, the spacer layer is first bonded to the first or outer layer, then to the second or inner layer. In other embodiments, the spacer layer is first bonded to the second or inner layer, then to the first or outer layer. In some embodiments, the adhesive film is a moisture impermeable material of the present disclosure.

In another embodiment of a lamination process, the spacer layer is composed of solid glue particles with the selected thickness/diameter. These adhesive particles serve as the spacer layer, which can be directly bonded with the two layers of porous substrates through lamination. For example, in some embodiments, a method of making the article may include providing the first or outer layer and the second or inner layer; and bonding the spacer layer to the first or outer layer and the first surface of the second or inner layer by lamination. In some embodiments, the second or inner layer comprises a hydrophobic porous material on at least a first surface facing the direction of a liquid impact, or facing the spacer layer. In some embodiments, the spacer layer is bonded between the first or outer layer and the first surface of the second or inner layer. In some embodiments, the spacer layer comprises a plurality of discrete spacers, each spacer of the plurality comprising one or more solid glue particles.

In some embodiments of a lamination process of the present disclosure (e.g., the exemplary lamination process(es) described above), the first or outer layer comprises a porous material of the present disclosure. In some embodiments, the second or inner layer may comprise a porous material of the present disclosure with a hydrophobic coating on at least the first surface, or the second or inner layer may be made from a hydrophobic porous material of the present disclosure, including without limitation a material comprising a fluoropolymer, silicone, hydrosilicone, fluoroacrylate, wax, or olefin.

In the art of printing, there are various ways for creating 3D/high profile structures on fabric layers. There are currently several different methods of textile printing available, including flatbed printing, rotary printing, inkjet printing, etc. In some embodiments, an article of the present disclosure is manufactured using screen printing. In some embodiments, the article of the present disclosure includes a first layer or outer layer (e.g., positioned to receive a liquid impact or facing outward), a second or inner layer (e.g., positioned behind the first layer in the direction of the liquid impact or facing inward), and a spacer layer separating the first or outer layer and the second or inner layer.

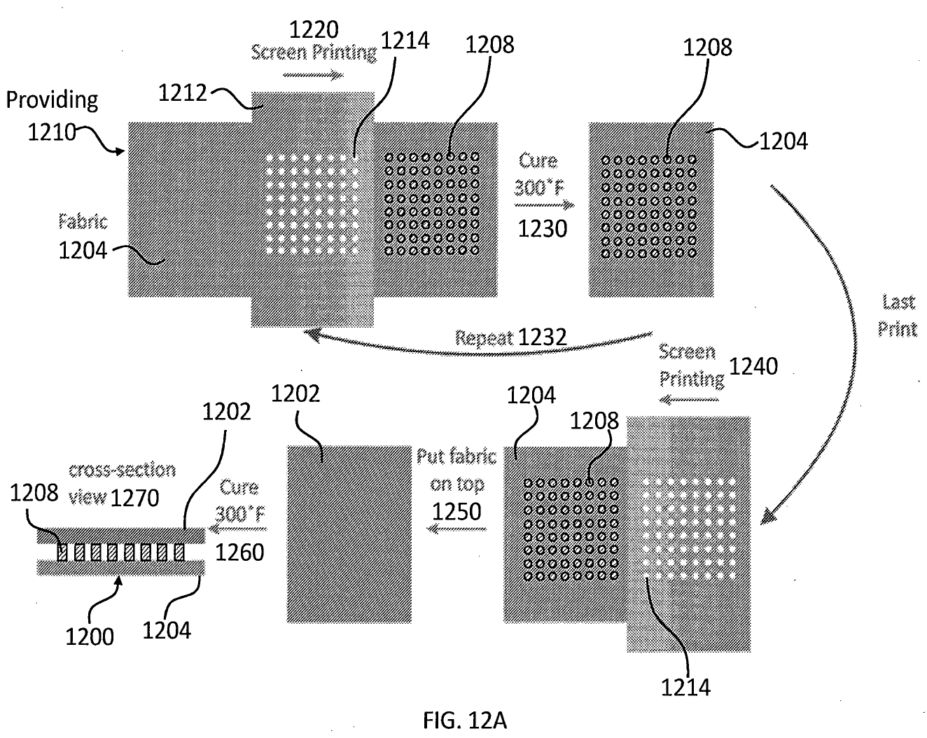

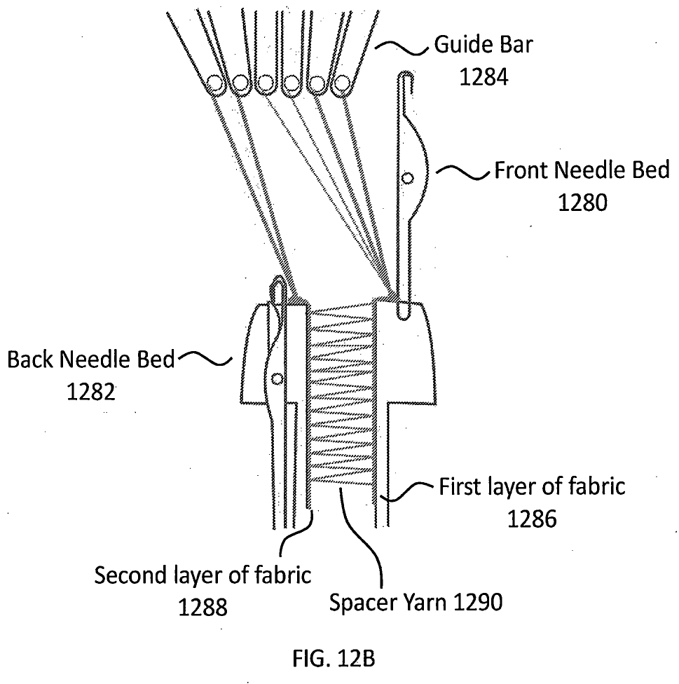

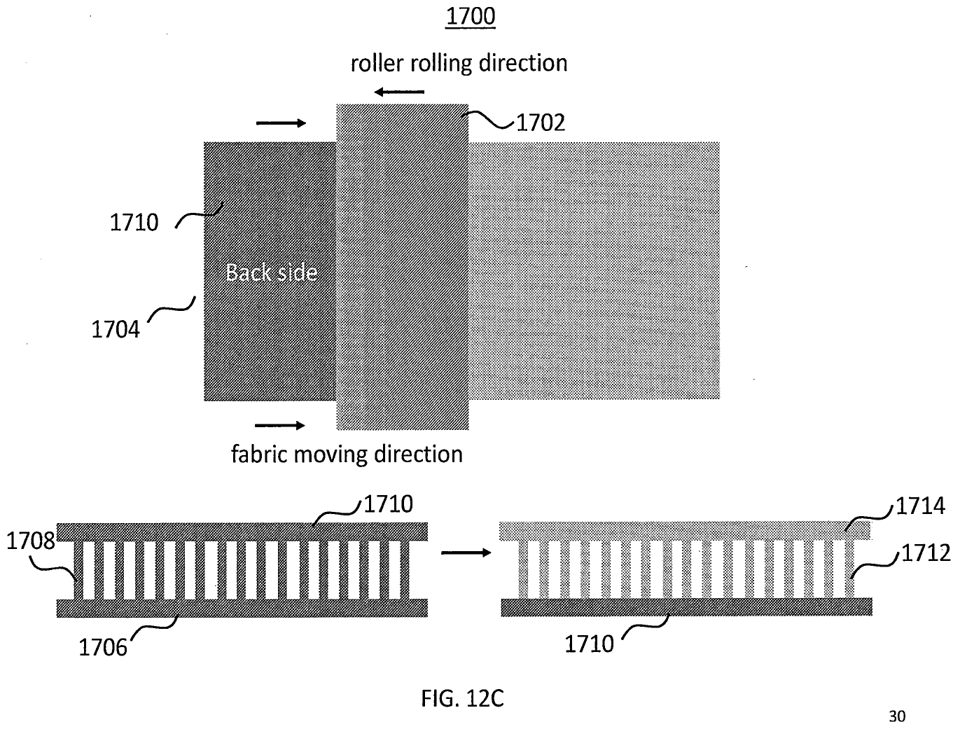

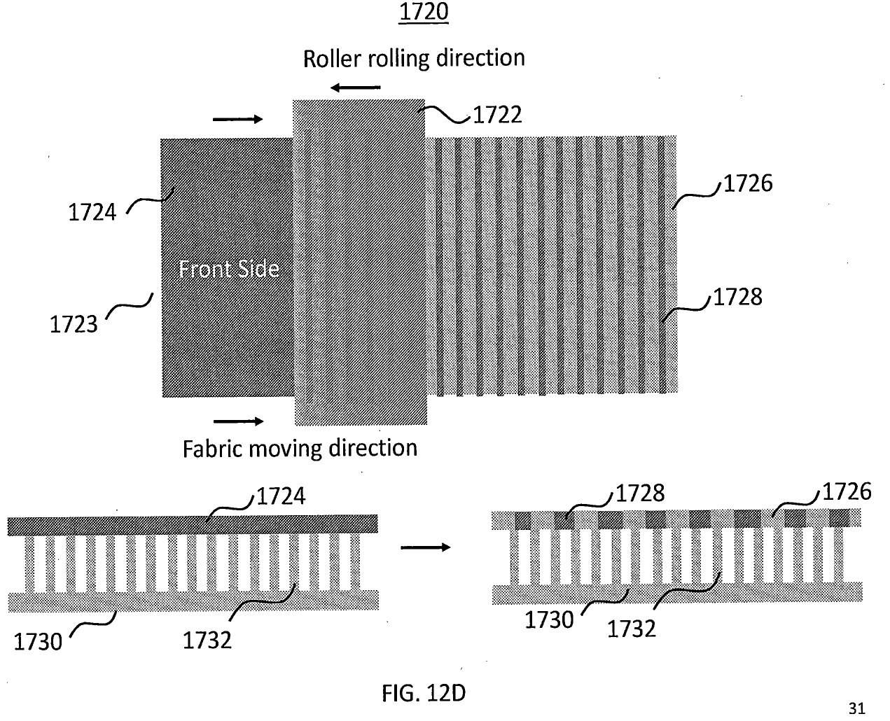

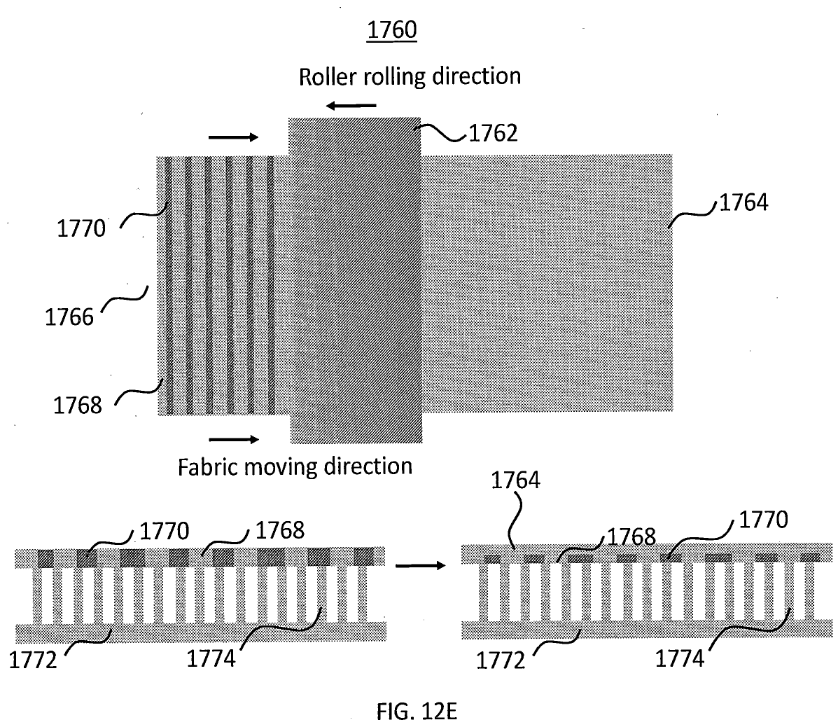

An exemplary embodiment of a screen printing-based method is illustrated in FIG. 12A. This method is similar to high-density ink printing. At step 1210, layer 1204 (e.g., a fabric layer) comprising a hydrophobic porous material of the present disclosure is provided. In some embodiments, layer 1204 comprises a hydrophobic porous material of the present disclosure on at least a first surface facing the direction of the liquid impact or the spacer layer.

At step 1220, a spacer material of the present disclosure is screen printed onto the first surface of layer 1204 using screen 1212 with a plurality of holes (e.g., hole 1214) to generate a spacer layer of the present disclosure (e.g., including spacers such as spacer 1208). In some embodiments, the spacer layer comprises a plurality of discrete spacers attached to layer 1204. As shown in FIG. 12A, the plurality of discrete spacers (e.g., spacers such as 1208) may be formed using holes (e.g., holes such as 1214) in screen 1212.

At step 1230, the material comprising layer 1204 and a spacer layer (e.g., 1208) is cured. In some embodiments, the curing involves exposing the spacer layer to heat (e.g., 300° F., as shown in FIG. 12A). Various other curing methods are known in the art, and one of skill in the art may suitably pick a curing method based upon, inter alia, the composition used to generate the spacer layer (e.g., ink). In some embodiments, the curing involves exposure to UV or infrared light. In some embodiments, the curing involves exposing the spacer layer to heat between about 300° F. and about 400° F.

In some embodiments, as shown in FIG. 12A, the manufacturing process includes a repeated cycle of printing and curing to gradually build up the spacer structure (e.g., spacers such as 1208) on top of one layer of the porous substrate (e.g., layer 1204). For example, in some embodiments, a screen printing-based method of the present disclosure includes (i) printing a first portion of a spacer material (e.g., 1208) onto the first surface of layer 1204 through screen 1212; (ii) curing the first portion of the spacer material (e.g., 1208); and (iii) printing a second portion of the spacer material onto the cured first portion, e.g., without curing the second portion of the spacer material. In some embodiments, the methods include repeating steps (i) and (ii) before performing step (iii), as illustrated by the repeat arrow at optional step 1232 in FIG. 12A.

In some embodiments, the process starts with repeated cycle of printing and curing (e.g., steps 1220, 1230, and 1232) to gradually build up the spacer structure on top of one layer of the porous substrate. After achieving the right thickness of the spacer, a final print is done without curing, which is used to adhere another layer (e.g., 1202) of the porous structure to the spacer structure. At step 1240, after achieving the right thickness of the spacer (e.g., any thickness of a spacer layer described herein), a final print is done, e.g., without curing. At step 1250, layer 1202 (e.g., a first layer of the present disclosure, such as a fabric layer) is adhered onto the spacer layer (e.g., including 1208).

In some embodiments, at step 1260, the material now including layers 1202 and 1204 and the spacer layer (e.g., spacers such as 1208) is cured, e.g., as described above. This curing step may be used, e.g., to promote adhesion of layer 1202 onto the spacer layer (e.g., spacers such as 1208). Cross-sectional view 1270 of article 1200 is provided to illustrate the configurations of layers 1202, 1204, and spacer layer 1208.

As will be appreciated by one of skill in the art, a screen printing process similar to that illustrated and described in reference to FIG. 12A may also be used to introduce optional features described herein. For example, various hydrophobic or hydrophilic layers of the present disclosure may be screen printed by changing the ink used in the roller during screen printing.

In some embodiments of a screen printing-based method of the present disclosure, heat-activated ink such puff ink can be used to create the spacer structure on one layer of the fabric while bonding the other layer. In some embodiments, if the spacer layer comprises puff ink, repetitive screen printing and curing steps may not be necessary. The puff ink may expand when applying heat, and the final thickness of the ink layer can be controlled by the amount of ink and the expansion ratio of the ink. Examples of puff ink known in the art include, without limitation, plastisol puff ink and puff additives that can be mixed with ink, such as JACQUARD® Puff Additive.

In some embodiments, an article of the present disclosure is manufactured using 3D knitting/weaving (see, e.g., FIG. 5D for an exemplary article created using 3D knitted fabrics in accordance with some embodiments). Techniques and machines suitable for 3D knitting/weaving are known in the art (e.g., high-speed double-needle bar Raschel machine, flatbed knitting machine, the fabrication device described at openknit.org). In some embodiments, the fabric can be constructed using warp or weft knitting machine with two needle-beds as shown in FIG. 12B. Regular knitting yarns are fed into both front needle bed 1280 and back needle bed 1282 of the knitting machine while monofilament yarns are fed in between guided by guide bars (e.g., guide bar 1284). During the knitting process, the guide bar moves back and forth to connect the two front and back layers of fabric structures (e.g., layers 1286 and 1288) together by spacer yarn 1290. After the knitting, the 3D fabric structure goes through a padding process to be treated into being hydrophobic, e.g., the 3D fabric is soaked into a hydrophobic coating solution, then goes through two rollers that squeeze excessive liquid out of the fabric. In some embodiments, hydrophobic yarns are directly fed into the guide bars of the knitting machine, and an impact proof structure fabric is generated without a padding process. In some embodiments, yarns with different wettability or hydrophobicity/hydrophilicity (e.g. yarns with hydrophobic/water repellent finishing and wicking finishing) can be fed into the front and back needle bed separately to create fabric with different wettability property at the front and back layer. For instance, if water repellent yarns are fed into the back needle bed and middle guide bars while wicking yarn is fed into the front needle bed, the resulting knitted spacer fabric will be similar to the structure shown in FIG. 5K. Similarly, one of skill in the art can use 3D knitting or weaving to generate any of the exemplary embodiments described in FIGS. 5I-5S. In some embodiments, a textile printing process can be utilized to treat only the second or inner layer of the fabric to be hydrophobic while the first or outside layer can maintain its original wettability. There are several different methods of textile printing available, including flatbed printing, rotary printing, inkjet printing, etc. For example, in some embodiment, a spacer fabric is laid on a flat surface with the second or inner layer facing up, and can be treated by a liquid-repellent using a screen printing. Some methods use various thickeners to keep the ink from migrating and to control the penetration in the fabric thickness direction. In printing in general, there are a number of variables which can be controlled. Some variables such as print paste viscosity, amount of print paste applied, roller/wiper pressure, speeds, mesh size of the screen, etc., can be used to control the depth of penetration of the print paste. One way to control depth of ink penetration is to adjust the printing parameters so that the print paste can completely cover and penetrate the second or inner layer of the fabric without contact the first or outside layer of the fabric. One of skill in the art is capable of determining suitable parameters for these printing variables for a variety of articles based on the guidance provided herein. Following any of these processes, the fabric can be dried and cured on a tender frame to fix the coating and dimensions. In some embodiments, the 3D spacer fabric is further bonded with another layer of protection fabric structure on the outside of the first layer (e.g., see FIGS. 5G & 5H) using a lamination and bonding process described herein.

In some embodiments, a textile printing process can be utilized to create different wettability or degrees of hydrophilicity/hydrophobicity on the front and back layers of the fabrics. There are several different methods of textile printing processes, including, for example, flatbed printing, rotary printing, inkjet printing, etc. For example, in some embodiments, a spacer fabric is laid on a flat surface with the second or inner layer facing up, and can be treated by a liquid-repellent using a screen printing. Some methods use various thickeners to keep the ink from migrating and to control the penetration in the fabric thickness direction. In printing in general, there are a number of variables which can be controlled. Some variables, such as print paste viscosity, amount of print paste applied, roller/wiper pressure, speeds, mesh size of the screen, etc., can be used to control the depth of penetration of the print paste.

In some embodiments, the depth of ink penetration is adjusted by the printing parameters so that the print paste can completely cover and penetrate the second or inner layer of the fabric without contacting the first or outside layer of the fabric. In some embodiments, after this step, the fabric is flipped, and hydrophobic patterns are printed and penetrated through the first layer of the fabric. In some embodiments, after this step, the first layer of the fabric is covered by a hydrophobic layer of ink that partially penetrates the first layer. One of skill in the art is capable of determining suitable parameters for these printing variables for a variety of articles based on the guidance provided herein.

Certain aspects of the present disclosure relate to methods of making an article having an outer layer comprising a first hydrophilic porous material having a pore size of between about 15 μm and about 1 mm, an inner layer comprising a hydrophobic porous material having a pore size of between about 15 μm and about 1 mm, and a hydrophobic spacer layer separating the first layer and the second layer. In some embodiments, the methods start with providing an article comprising an outer layer comprising a first porous material having a pore size of between about 15 μm and about 1 mm, an inner layer comprising the first porous material having a pore size of between about 15 μm and about 1 mm, and a spacer layer separating the first layer and the second layer, e.g., as described herein, and then applying a print paste comprising a hydrophobic material onto the inner layer such that the inner layer and spacer layer are coated with the hydrophobic material. This yields an article comprising an outer layer comprising the first hydrophilic porous material having a pore size of between about 15 μm and about 1 mm, an inner layer comprising the hydrophobic porous material having a pore size of between about 15 μm and about 1 mm, and a hydrophobic spacer layer that separates the first layer and the second layer.

Exemplary process steps are depicted in FIGS. 12C-12E. A person of skill in the art would recognize that the each of the processes depicted in FIGS. 12C-12E can be performed in separately or combined in any suitable order. Any textile printing process known in the art can be used to apply the print paste.

FIG. 12C depicts process 1700. In process 1700, fabric 1704 and roller 1702 are moved towards each other, and roller 1702 applies a hydrophobic print paste that penetrates through the inner or second layer and the spacer layer of fabric 1704. In process 1700, prior to application of the print paste, fabric 1704 has a hydrophilic outer or first layer 1710, hydrophilic inner or second layer 1706, and hydrophilic spacer layer 1708. After application of the print paste, fabric 1704 has hydrophobic inside or second layer 1714, hydrophilic outer or first layer 1710, and hydrophobic spacer layer 1712.

In some embodiments, this article can be further modified, e.g., by applying a print paste comprising a hydrophobic material onto the outer layer through a screen roller such that, after applying the print paste, the outer layer comprises a first portion comprising the hydrophilic porous material and a second portion comprising a hydrophobic material. For example, in some embodiments, the fabric produced in process 1700 can then be flipped, and patterns can be printed on the front side of the fabric. An example of this is shown in FIG. 12D, which depicts process 1720. In process 1720, fabric 1723 and roller 1722 are moved towards each other, and roller 1722 applies a hydrophobic print paste that penetrates through the first layer of the fabric at various intervals. In some embodiments, fabric 1723 is a fabric generated by process 1700 and flipped over. In process 1720, prior to application of the print paste, fabric 1723 has a hydrophilic first layer 1724, hydrophobic second layer 1730, and hydrophobic spacer layer 1732. After application of the hydrophobic print paste, fabric 1723 has a hydrophobic second layer 1730, a hydrophobic spacer layer 1732, a patterned first layer with hydrophobic portions (e.g., 1726) and hydrophilic portions (e.g., 1728) that both penetrate the entire width of the first layer.

In some embodiments, this article can be further modified, e.g., by applying a print paste comprising a hydrophobic material onto the outer layer such that the print paste penetrates through part but not all of the outer layer, wherein after applying the print paste, the outer layer comprises a first portion comprising the hydrophilic porous material and a second portion comprising a hydrophobic material, and wherein the first portion is not present on the outer surface of the outer layer. For example, in some embodiments, the fabric produced in process 1720 can be used in process 1760 (FIG. 12E). In process 1760, fabric 1766 and roller 1762 are moved towards each other, and roller 1762 applies a hydrophobic print paste that partially penetrates through the first layer of the fabric. In some embodiments, fabric 1766 is a fabric generated by process 1720. In process 1760, prior to application of the print paste, fabric 1766 has a patterned first layer with hydrophobic portions 1768 and hydrophilic portions 1770 that both penetrate the entire width of the first layer, a hydrophobic second layer 1772, and a hydrophobic spacer layer 1774. After application of the print paste, fabric 1766 has a first layer with an outer hydrophobic layer 1764 and an inner layer with hydrophobic portions (e.g., 1768) and hydrophilic portions (e.g., 1770). Spacer layer 1774 and second layer 1772 are hydrophobic.

In some embodiments, an article of the present disclosure is manufactured using 3D printing. Techniques and machines suitable for 3D printing (e.g., 3D printing of fabrics) are known in the art (see, e.g., www.disneyresearch.com/wp-content/uploads/A-Layered-Fabric-3D-Printer-for-Soft-Interactive-Objects-Paper.pdf and www.tamicare.com).

### EXAMPLES

The present disclosure will be more fully understood by reference to the following example. It should not, however, be construed as limiting the scope of the present disclosure. It is understood that the examples and embodiments described herein are for illustrative purposes only and that various modifications or changes in light thereof will be suggested to persons skilled in the art and are to be included within the spirit and purview of this application and scope of the appended claims.

### Example 1

### Testing Liquid Impact-Proof Structures with a Rain Droplet Simulator

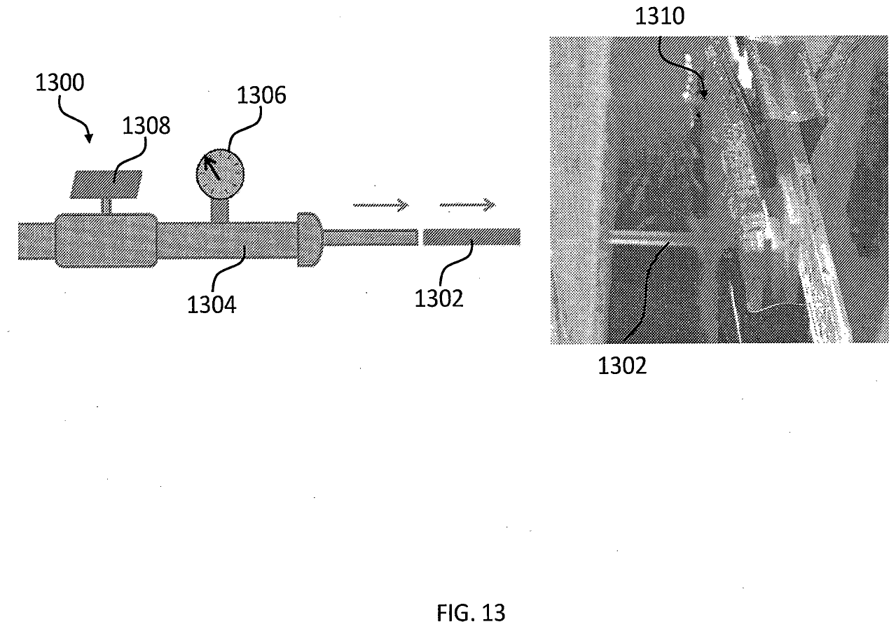

In order to test the liquid impact resistance of the materials described above, rain droplet simulator 1300 (FIG. 13) was built to shoot out water stream/droplets 1302 at different speeds, which correspond to different impact pressures. A thin plastic tube 1304 with a small outlet (e.g., ˜2.5 mm) is connected with a pressurized water pump. Water pressure gauge 1306 was installed to monitor the pressure of water before shooting out from the tube 1304. Manual valve 1308 was built to control the pressure to inject the water. After calibrating, this pressure could then be directly translated into a fluid stream/droplets to simulate rain.

Rain droplet generator 1300 was set to shoot continuous stream of water 1302 at 10 m/s, which corresponds to an impact pressure of about 81.9 kPa. Test materials (e.g., test material 1310) may be placed in front of water 1302 in order to examine the ability of test materials (e.g., 1310, or an article of the present disclosure) to resist liquid impacts having various impact pressures. For example, a knitted polyester fabric (175 g/m², interlock) was treated with commercial fluoropolymer and used as a hydrophobic porous material of the present disclosure. The maximum hydrostatic pressure of the fabric can withstand is around 2 kpa.

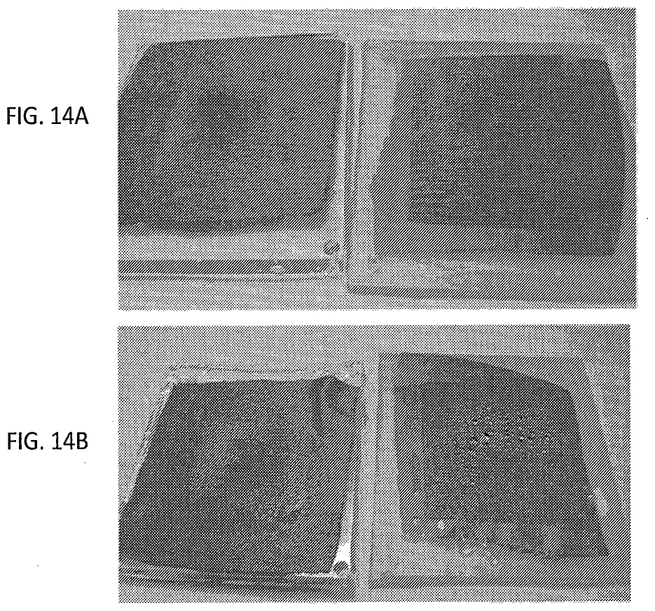

Rain droplet generator 1300 was next used to test the liquid impact resistance of exemplary materials. FIG. 14A shows that a material including two layers of the knitted polyester fabric described above, placed in contact together, was instantly penetrated by the strong water stream described above and became wet. On the contrary, FIG. 14B demonstrates that when the same two layers of fabric were separated without any physical contact by a spacer structure (about 8 mm in thickness), the combined structure was able to block the penetration of the stream of water, and the second or inner layer of the fabric stayed dry on the inside.

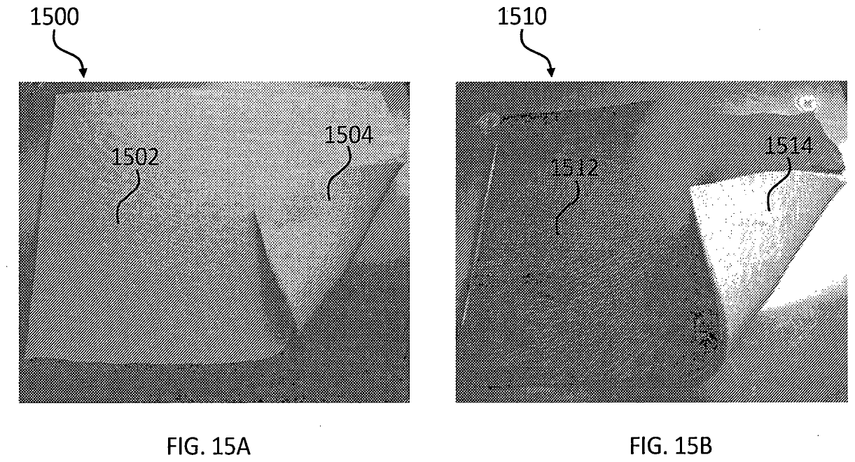

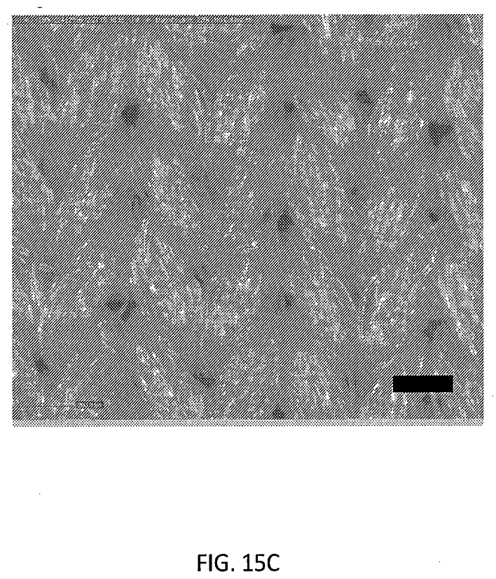

FIG. 15A shows the front (e.g., outside layer 1502) and back (e.g., inside layer 1504) of a liquid impact proof fabric 1500 fabricated using the 3D knitting approach. FIG. 15B shows the protection layer (e.g., protection layer 1512) and back (e.g., inner layer 1514) of a liquid impact proof fabric 1510 fabricated using the 3D knitting and bonding with woven fabric approach (e.g., as described in reference to FIGS. 5G & 5H).

Table 1 compares some key parameters that characterize the performance of the novel liquid impact proof fabrics as compared to a conventional hydrophobic woven fabric (often called “softshell”) and GORE-TEX®. The 3D spacer fabric described in Table 1 included an outer layer of a porous material having a pore size of between 10 μm and about 400 μm, a spacer layer, and an inner hydrophobic layer of a hydrophobic porous material having a pore size of between about 10 μm and about 1.5 mm. This material is shown in FIG. 15A, and similar materials are described in reference to FIGS. 5C-5F. The “3D spacer fabric+hydrophilic woven protection layer” in Table 1 include the 3D spacer fabric described above affixed to a hydrophilic woven protection layer on the outer surface of the 3D spacer fabric. This material is shown in FIG. 15B, and similar materials are described in reference to FIGS. 5G & 5H. The hydrophilic woven protection layer in Table 1 is this layer alone, i.e., without the 3D spacer fabric.

The fabric swatch had the following specifications: a weft-knitted 3D spacer fabric using circular knitting machine, identical knitting structure at front and back layers with a composition of 95% polyester and 5% spandex, a thickness of about 2 mm, an average pore size of about 83 μm (see FIG. 15C, scale bar is 200 μm) and a weight of 354 g/m². The fabric was treated to be hydrophobic using a padding process after knitting as described supra. Specifically, the maximum hydrostatic pressure of a fabric sample was measured by a hydrostatic tester. The device applies an increasing value of water pressure on a fabric sample and the maximum hydrostatic pressure is recorded when water penetrates through the sample and leakage happens. The maximum liquid impact pressure was measured using the rain droplet simulator aforementioned. Additionally, the liquid impact-proof structures were also tested by a third party using standard test protocols, including the air permeability tester (ASTM D737), the Rain Test (AATCC 35) and the Bundesmann Test (ISO 9865). The results are summarized in Table 1.

TABLE 1
Performance of liquid impact proof structures
as compared to existing materials.

| | | | 3 D spacer | | |
|---|---|---|---|---|---|
| | | | fabric + | | |
| | | Hydro- | hydrophilic | | |
| | | philic | woven | | |
| | 3 D | woven | protection | Soft- | |
| | Spacer | protection | layer | shell | GORE- |
| | Fabric | layer | combination | Fabric | TEX ® |
| Maximum | ~2 | ~0 | ~2 | ~6 | ~280 |
| Hydrostatic | | | | | |
| Pressure (kpa) | | | | | |
| Maximum Impact | ~21 | <0.1 | ~41 | ~6 | ~280 |
| Pressure (kpa) | | | | | |
| Air Permeability | ~70 | ~52.3 | ~44 | ~29.4 | <1 |
| (cfm)* | | | | | |
| Water Resistance | 0 | -- | 0 | -- | -- |
| Rain Test | | | | | |
| (2 min @ | | | | | |
| 2 ft) (g)** | | | | | |
| Bundesmann | 5 | -- | 0 | -- | -- |
| Test, pass through | | | | | |
| (nth)*** | | | | | |

Notes:
*measured by standard ASTM D737
**measured by standard AATCC 35
***measured by standard ISO 9865
--data was not measured

Table 1 shows that even though the hydrostatic pressure of the 3D spacer fabric was only 2 kpa, it can resist impact pressures up to 21 kpa. Moreover, the combined structure (3D spacer fabric+hydrophilic woven protection layer) demonstrated superior impact pressure resistance of up to 41 kpa, which is nearly two-fold higher than either the 3D spacer fabric or the woven protection layer alone (resisted maximum impact pressures of ˜21 kpa and <0.1 kpa, respectively). Both structures can resist much higher impact pressure than the maximum hydrostatic pressure the fabrics can resist. On the contrary, the maximum impact pressure the conventional softshell fabric and GORE-TEX® can resist equaled their maximum hydrostatic pressure values. Advantageously, this unique feature of spacer fabrics (i.e. able to resist much higher impact pressure than maximum hydrostatic pressure of the structure) allows for robust liquid impact resistance with increased air permeability, e.g., as compared to softshell fabric or GORE-TEX®. For example, the fabric combining the 3D spacer fabric and the hydrophilic woven protection layer unexpectedly demonstrated superior air permeability to that of softshell fabric while also resisting liquid impact pressures nearly 7-fold higher than softshell fabric. In addition, the fabric combining the 3D spacer fabric and the hydrophilic woven protection layer exhibited a more than 40-fold increase in air permeability as compared to GORE-TEX®, demonstrating its superior breathability.

In the Rain Test (AATCC 35), the fabric sample was placed to face a pressurized water shower (simulating rain), and an absorption pad was placed behind the fabric sample to catch any water that passed through the fabric. If no weight change is measured at the absorption pad (0 g), the fabric is considered to pass the test and possess good rainproof ability. As can be seen from Table 1, both the 3D spacer fabric and the 3D spacer fabric+hydrophilic woven protection layer combination passed the test (0 g) and showed good rainproof ability.

The Bundesmann test is a very harsh test for evaluating the waterproof ability of a fabric sample by simulating heavy rain showers to the fabric surface and provide friction on the inside of the fabric. The strength of the test is considered to be 5.8 times that of a cloudburst, 90 times that for heavy rain, 480 times that for moderate rain and 21,000 times that for light rain. (see, e.g., textilelearner.blogspot.com/2012/03/water-repellency-test-bundesmann-water.html#ixzz4U1HexMDu).

In the Bundesmann test, the fabric sample was placed over the opening of a test cup in which a blade keeps rubbing the back/inside of the fabric sample. Meanwhile, a large nozzle array (300 nozzles, positioned 1.5 meters above the sample) generated droplets that constantly hit the sample's outside surface for 10 min. After the test, if no water is collected in the cup (e.g. 0 mL), the fabric sample is considered to have passed the test, and thus possesses great waterproof capacity, even under a cloudburst.

As can be seen in Table 1, the 3D spacer fabric+hydrophilic woven protection layer combination passed the test (0 mL). Meanwhile, since the 3D spacer fabric alone was weaker than the combination, it was not able to block all the liquid penetration during this test, and a small amount of water was collected in the cup (5 mL). These results demonstrate the superior liquid impact resistance of the material.

Although the foregoing descriptions and examples have been described in some detail by way of illustration and example for purposes of clarity of understanding, the descriptions and examples should not be construed as limiting the scope of the present disclosure.

What is claimed is:

1. An article of manufacture that resists liquid impact, the article comprising:
(a) a first layer comprising a first porous material, wherein the first layer is positioned to receive the liquid impact;
(b) a second layer comprising a hydrophobic porous material on at least a portion of the second layer, wherein the second layer is positioned behind the first layer in the direction of the liquid impact; and
(c) a spacer layer separating the first layer and the second layer.

2. The article of claim 1, wherein the hydrophobic porous material comprises a second porous material with a hydrophobic coating on at least the portion of the second layer.

3. The article of claim 2, wherein the hydrophobic coating comprises a fluoropolymer, silicone, hydrosilicone, fluoroacrylate, wax, or olefin.

4. The article of claim 2, wherein the second porous material is a textile.

5. The article of claim 4, wherein the textile is a natural fiber, a synthetic fiber, or a blend thereof.

6. The article of claim 5, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

7. The article of claim 2, wherein the second porous material is a metal mesh or a polymer mesh.

8. The article of claim 1, wherein the hydrophobic porous material comprises polypropylene, polydimethylsiloxane, or a fluoro-polymer.

9. The article of any one of claims 1-8, wherein the first porous material is a textile.

10. The article of claim 9, wherein the textile is a natural fiber, a synthetic fiber, or a blend thereof.

11. The article of claim 10, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

12. The article of any one of claims 1-8, wherein the first porous material is a metal mesh or a polymer mesh.

13. The article of any one of claims 1-12, wherein the first porous material has a pore size of between about 15 μm and about 1 mm.

14. The article of claim 13, wherein the first porous material has a pore size of between about 50 μm and about 1 mm.

15. The article of any one of claims 1-14, wherein the hydrophobic porous material has a pore size of between about 15 μm and about 1 mm.

16. The article of claim 15, wherein the hydrophobic porous material has a pore size of between about 50 μm and about 1 mm.

17. The article of any one of claims 1-16, wherein the spacer layer separates the first layer and the second layer from physical contact.

18. The article of any one of claims 1-16, wherein the spacer layer separates the first layer and the second layer from being connected by liquid accumulation from the liquid impact.

19. The article of any one of claims 1-18, wherein the spacer layer separates the first layer and the second layer by between about 100 μm and about 2 cm.

20. The article of any one of claims 1-19, wherein the spacer layer comprises a plurality of discrete spacers, wherein at least a first discrete spacer of the plurality has a first end and a second end, and wherein the first end penetrates into the first layer and the second end penetrates into the second layer.

21. The article of claim 20, wherein the first end and the second end of the first spacer are connected to each other.

22. The article of any one of claims 1-19, wherein the first porous material of the first layer is a textile comprising a plurality of fibers, wherein the second porous material of the second layer is a textile comprising a plurality of fibers, and wherein the spacer layer comprises at least a first yarn threaded through at least a first space between the plurality of fibers of the first layer and through at least a first space from the plurality of fibers of the second layer.

23. The article of claim 22, wherein the first yarn is a monofilament yarn.

24. The article of claim 22 or claim 23, wherein the first layer, the second layer, and the first yarn comprise a 3D knitted or woven fabric.

25. The article of any one of claims 1-19, wherein the spacer layer comprises a plurality of discrete spacers, wherein each discrete spacer of the plurality has a first end and a second end, and wherein the first end is attached to the first layer and the second end is attached to the second layer.

26. The article of claim 25, wherein the discrete spacers of the plurality are spaced apart from each other by between about 10 μm and about 1 cm.

27. The article of claim 26, wherein the discrete spacers of the plurality are spaced apart from each other by about 2 mm.

28. The article of any one of claims 25-27, wherein each discrete spacer of the plurality comprises a moisture impermeable material in at least the second end attached to the second layer.

29. The article of claim 28, wherein the moisture impermeable material is selected from the group consisting of adhesive, polyurethane, thermoplastic polyurethane (TPU), silicone, metal, polytetrafluoroethylene (PTFE), plastic and a dense hydrophobic fabric.

30. The article of any one of claims 20-29, wherein the first layer comprises:
(a) a first surface comprising the first porous material, wherein the first surface is positioned to receive the liquid impact; and
(b) a second surface comprising a hydrophilic material, wherein the second surface is adjacent to the spacer layer.

31. The article of claim 30, wherein the first porous material is a hydrophobic porous material.

32. The article of any one of claims 25-29, wherein the second layer comprises:
(a) a first surface, wherein the first surface is attached to the plurality of discrete spacers, and wherein the first surface further comprises:
(i) a first portion, wherein the first portion of the first surface is located at the attachments between the second layer and the plurality of discrete spacers, and wherein the first portion comprises the hydrophobic porous material; and
(ii) a second portion, wherein the second portion of the first surface is located around the attachments between the second layer and the plurality of discrete spacers, and wherein the second portion comprises a hydrophilic material; and
(b) a second surface comprising the hydrophobic porous material, wherein the second surface is behind the first surface in the direction of the liquid impact.

33. The article of any one of claims 20-29, wherein the spacer layer further comprises a hydrophilic layer, wherein the hydrophilic layer is positioned between the first end and the second end of the plurality of discrete spacers, wherein the hydrophilic layer connects the discrete spacers of the plurality, and wherein the hydrophilic layer comprises a hydrophilic material.

34. The article of any one of claims 30-33, wherein the hydrophilic material is a textile.

35. The article of claim 34, wherein the textile is a natural fiber, a synthetic fiber, or a blend thereof.

36. The article of claim 35, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

37. The article of any one of claims 20-29, wherein the first layer and the spacer layer each comprise a hydrophobic porous material.

38. The article of any one of claims 20-29, wherein the first layer and the spacer layer each comprise a hydrophobic porous material, and wherein the second layer comprises:
(a) a first surface comprising a hydrophobic porous material, wherein the first surface is adjacent to the spacer layer; and
(b) a second surface comprising a hydrophilic material, wherein the second surface is behind the first surface in the direction of the liquid impact.

39. The article of claim 38, wherein the first surface comprises between about 10% and about 95% of the thickness of the second layer.

40. The article of any one of claims 20-29, wherein the second layer and the spacer layer each comprise a hydrophobic porous material, and wherein the first layer comprises a hydrophilic material.

41. The article of claim 40, wherein the first layer comprises a first portion comprising a hydrophobic porous material and a second portion comprising the hydrophilic material.

42. The article of claim 41, wherein the second portion of the first layer forms a pattern on a surface of the first layer positioned to receive the liquid impact.

43. The article of claim 42, wherein the second portion forms a pattern on the surface of the first layer between about 1 mm and about 1 cm in width.

44. The article of claim 42 or claim 43, wherein the second portion covers between about 5% and about 50% of the surface area of the first layer.

45. The article of claim 41, wherein the second portion of the first layer comprises a first sub-portion abutting a second sub-portion in a cross-section of the first layer, wherein only the first sub-portion is present on a surface of the first layer positioned to receive the liquid impact, wherein the first sub-portion comprises a hydrophobic porous material, and wherein the second sub-portion comprises the hydrophilic material.

46. The article of claim 45, wherein the second sub-portion occupies between about 5% and about 95% of the cross-sectional thickness of the first layer.

47. The article of any one of claims 20-29, wherein the first layer and the spacer layer each comprise a hydrophilic material, and wherein the second layer comprises:
(a) a first surface comprising a hydrophilic material, wherein the first surface is adjacent to the spacer layer; and
(b) a second surface comprising a hydrophobic porous material, wherein the second surface is behind the first surface in the direction of the liquid impact.

48. The article of claim 47, wherein the first surface comprises between about 10% and about 95% of the thickness of the second layer.

49. The article of any one of claims 1-19, wherein the spacer layer comprises a space separating the first layer and the second layer, and wherein at least one of the first layer and the second layer is affixed to a support structure that maintains separation between the first layer and the second layer.

50. The article of any one of claims 1-49, wherein the article resists a liquid impact having an impact pressure of up to about 250 kPa.

51. The article of claim 50, wherein the first layer resists a liquid impact having an impact pressure of up to about 6 kPa.

52. The article of claim 50 or claim 51, wherein the second layer resists a liquid impact having an impact pressure of up to about 6 kPa.

53. The article of any one of claims 1-52, wherein the spacer layer is open to airflow in at least a first end.

54. The article of claim 53, wherein the first end of the spacer layer is configured to allow reversible sealing of the first end.

55. The article of any one of claims 1-54, wherein the article is a waterproof fabric.

56. The article of claim 55, wherein the waterproof fabric is a component of a garment.

57. The article of claim 56, wherein the garment comprises:
(a) a first portion comprising the waterproof fabric; and
(b) a second portion comprising a second fabric.

58. The article of claim 57, wherein the second fabric is a second waterproof fabric different from the waterproof fabric of the first portion.

59. The article of claim 55, wherein the waterproof fabric is a component of an outerwear, footwear, outdoor gear, pack, umbrella, rain gear, outerwear accessory, diaper, pad, wound dressing, or bed sheet.

60. An article of manufacture comprising:
(a) an outer layer comprising a first porous material having a pore size of between about 15 μm and about 1 mm;
(b) a spacer layer; and
(c) an inner layer comprising a hydrophobic porous material having a pore size of between about 15 μm and about 1 mm, wherein the inner layer has a first and a second surface, and wherein the first surface of the inner layer faces the spacer layer;
wherein the spacer layer separates the outer layer and the inner layer from physical contact and allows airflow between the outer layer and the first surface of the inner layer.

61. The article of claim 60, wherein the inner layer comprises the hydrophobic porous material on one or both of the first and the second surfaces.

62. The article of claim 60, wherein the hydrophobic porous material comprises a second porous material with a hydrophobic coating on one or both of the first and the second surfaces of the inner layer.

63. The article of claim 62, wherein the hydrophobic coating comprises a fluoropolymer, silicone, hydrosilicone, fluoroacrylate, wax, or olefin.

64. The article of claim 62, wherein the second porous material is a textile.

65. The article of claim 64, wherein the textile is a natural fiber, a synthetic fiber, or a blend thereof.

66. The article of claim 65, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

67. The article of claim 61, wherein the second porous material is a metal mesh or a polymer mesh.

68. The article of claim 60, wherein the hydrophobic porous material comprises polypropylene, polydimethylsiloxane, or a fluoro-polymer.

69. The article of any one of claims 60-68, wherein the first porous material is a textile.

70. The article of claim 69, wherein the textile is a natural fiber, a synthetic fiber, or a blend thereof.

71. The article of claim 70, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

72. The article of any one of claims 60-68, wherein the first porous material is a metal mesh or a polymer mesh.

73. The article of any one of claims 60-72, wherein the first porous material has a pore size of between about 50 μm and about 1 mm.

74. The article of any one of claims 60-73, wherein the hydrophobic porous material has a pore size of between about 50 μm and about 1 mm.

75. The article of any one of claims 60-74, wherein the spacer layer separates the outer layer and the inner layer from being connected by liquid accumulation from a liquid impact to the outer layer.

76. The article of any one of claims 60-75, wherein the spacer layer separates the outer layer and the inner layer by between about 100 μm and about 2 cm.

77. The article of any one of claims 60-76, wherein the spacer layer comprises a plurality of discrete spacers, wherein at least a first discrete spacer of the plurality has a first end and a second end, and wherein the first end penetrates into the outer layer and the second end penetrates into the inner layer.

78. The article of claim 77, wherein the first end and the second end of the first spacer are connected to each other.

79. The article of any one of claims 60-76, wherein the first porous material of the outer layer is a textile comprising a plurality of fibers, wherein the hydrophobic porous material of the inner layer is a textile comprising a plurality of fibers, and wherein the spacer layer comprises at least a first yarn threaded through at least a first space between the plurality of fibers of the outer layer and through at least a first space from the plurality of fibers of the inner layer.

80. The article of claim 79, wherein the first yarn is a monofilament yarn.

81. The article of claim 79 or claim 80, wherein the first layer, the second layer, and the first yarn comprise a 3D knitted or woven fabric.

82. The article of any one of claims 60-76, wherein the spacer layer comprises a plurality of discrete spacers, wherein each discrete spacer of the plurality has a first end and a second end, and wherein the first end is attached to the outer layer and the second end is attached to the first surface of the inner layer.

83. The article of claim 82, wherein the discrete spacers of the plurality are spaced apart from each other by between about 10 μm and about 1 cm.

84. The article of claim 83, wherein the discrete spacers of the plurality are spaced apart from each other by about 2 mm.

85. The article of any one of claims 82-84, wherein each discrete spacer of the plurality comprises a moisture impermeable material in at least the second end attached to the first surface of the inner layer.

86. The article of claim 85, wherein the moisture impermeable material is selected from the group consisting of adhesive, polyurethane, thermoplastic polyurethane (TPU), silicone, metal, polytetrafluoroethylene (PTFE), plastic and a dense hydrophobic fabric.

87. The article of any one of claims 77-86, wherein the outer layer comprises:
(a) an outer surface comprising the first porous material; and
(b) an inner surface comprising a hydrophilic material, wherein the inner surface of the outer layer is adjacent to the spacer layer.

88. The article of claim 87, wherein the first porous material is a hydrophobic porous material.

89. The article of any one of claims 82-86, wherein the inner layer comprises:
(a) the first surface, wherein the first surface is attached to the plurality of discrete spacers, and wherein the first surface further comprises:
(i) a first portion, wherein the first portion of the first surface is located at the attachments between the inner layer and the plurality of discrete spacers, and wherein the first portion comprises the hydrophobic porous material; and
(ii) a second portion, wherein the second portion of the first surface is located around the attachments between the inner layer and the plurality of discrete spacers, and wherein the second portion comprises a hydrophilic material; and
(b) the second surface, wherein the second surface comprises the hydrophobic porous material and faces in a direction opposite the first surface.

90. The article of any one of claims 77-86, wherein the spacer layer further comprises a hydrophilic layer, wherein the hydrophilic layer is positioned between the first end and the second end of the plurality of discrete spacers, wherein the hydrophilic layer connects the discrete spacers of the plurality, and wherein the hydrophilic layer comprises a hydrophilic material.

91. The article of any one of claims 87-90, wherein the hydrophilic material is a textile.

92. The article of claim 91, wherein the textile is a natural fiber, a synthetic fiber, or a blend thereof.

93. The article of claim 92, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

94. The article of any one of claims 77-86, wherein the outer layer and the spacer layer each comprise a hydrophobic porous material.

95. The article of any one of claims 77-86, wherein the outer layer and the spacer layer each comprise a hydrophobic porous material, wherein the first surface of the inner layer comprises a hydrophobic porous material, and wherein the second surface of the inner layer comprises a hydrophilic material.

96. The article of claim 95, wherein the first surface comprises between about 10% and about 95% of the thickness of the inner layer.

97. The article of any one of claims 77-86, wherein the inner layer and the spacer layer each comprise a hydrophobic porous material, and wherein the outer layer comprises a hydrophilic material.

98. The article of claim 97, wherein the outer layer comprises a first portion comprising a hydrophobic porous material and a second portion comprising the hydrophilic material.

99. The article of claim 98, wherein the second portion of the outer layer forms a pattern on an outer surface of the outer layer.

100. The article of claim 99, wherein the second portion forms a pattern on the outer surface of the outer layer between about 1 mm and about 1 cm in width.

101. The article of claim 99 or claim 100, wherein the second portion covers between about 5% and about 50% of the surface area of the outer layer.

102. The article of claim 98, wherein the second portion of the outer layer comprises a first sub-portion abutting a second sub-portion in a cross-section of the outer layer, wherein only the first sub-portion is present on the outer surface of the outer layer, wherein the first sub-portion comprises a hydrophobic porous material, and wherein the second sub-portion comprises the hydrophilic material.

103. The article of claim 102, wherein the second sub-portion occupies between about 5% and about 95% of the cross-sectional thickness of the first layer.

104. The article of any one of claims 77-86, wherein the outer layer and the spacer layer each comprise a hydrophilic material, wherein the first surface of the inner layer comprises a hydrophilic material, and wherein the second surface of the inner layer comprises a hydrophobic porous material.

105. The article of claim 104, wherein the first surface comprises between about 10% and about 95% of the thickness of the inner layer.

106. The article of any one of claims 60-76, wherein the spacer layer comprises a space separating the outer layer and the inner layer, and wherein at least one of the outer layer and the inner layer is affixed to a support structure that maintains separation between the outer layer and the inner layer.

107. The article of any one of claims 60-106, wherein the article resists a liquid impact having an impact pressure of up to about 250 kPa.

108. The article of claim 107, wherein the outer layer resists a liquid impact having an impact pressure of up to about 6 kPa.

109. The article of claim 107 or claim 108, wherein the inner layer resists a liquid impact having an impact pressure of up to about 6 kPa.

110. The article of any one of claims 60-109, wherein the spacer layer is open to airflow in at least a first end.

111. The article of claim 110, wherein the first end of the spacer layer is configured to allow reversible sealing of the first end.

112. The article of any one of claims 60-111, wherein the article is a waterproof fabric.

113. The article of claim 112, wherein the waterproof fabric is a component of a garment.

114. The article of claim 113, wherein the garment comprises:
(a) a first portion comprising the waterproof fabric; and
(b) a second portion comprising a second fabric.

115. The article of claim 114, wherein the second fabric is a second waterproof fabric different from the waterproof fabric of the first portion.

116. The article of claim 112, wherein the waterproof fabric is a component of an outerwear, footwear, outdoor gear, pack, umbrella, rain gear, outerwear accessory, diaper, pad, wound dressing, or bed sheet.

117. An article of manufacture comprising:
(a) an outer layer comprising a first porous material, the outer layer having an outer surface and an inner surface, wherein the first porous material has a pore size of between about 10 μm and about 5 mm;
(b) a spacer layer;
(c) an inner layer comprising a hydrophobic porous material having a pore size of between about 10 μm and about 1.5 mm; and
(d) a protection layer, wherein the protection layer is affixed to the outer surface of the outer layer, and wherein the protection layer has a pore size of between about 10 μm and about 400 μm;
wherein the spacer layer separates the outer layer and the inner layer from physical contact and allows airflow between the outer layer and the first surface of the inner layer.

118. The article of claim 117, wherein the protection layer is a woven fabric protection layer.

119. The article of claim 117 or claim 118, wherein the inner layer has a first and a second surface, wherein the first surface of the inner layer faces the spacer layer, and wherein the inner layer comprises the hydrophobic porous material on one or both of the first and the second surfaces.

120. The article of claim 119, wherein the hydrophobic porous material comprises a second porous material with a hydrophobic coating on one or both of the first and the second surfaces of the inner layer.

121. The article of claim 120, wherein the hydrophobic coating comprises a fluoropolymer, silicone, hydrosilicone, fluoroacrylate, wax, or olefin.

122. The article of claim 120, wherein the second porous material is a textile.

123. The article of claim 122, wherein the textile is a natural fiber, a synthetic fiber, or a blend thereof.

124. The article of claim 122, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

125. The article of claim 120, wherein the second porous material is a metal mesh or a polymer mesh.

126. The article of claim 117, wherein the hydrophobic porous material comprises polypropylene, polydimethylsiloxane, or a fluoro-polymer.

127. The article of any one of claims 117-126, wherein the first porous material is a textile.

128. The article of claim 127, wherein the textile is a natural fiber, a synthetic fiber, or a blend thereof.

129. The article of claim 128, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

130. The article of any one of claims 117-126, wherein the first porous material is a metal mesh or a polymer mesh.

131. The article of any one of claims 117-130, wherein the first porous material has a pore size of between about 10 μm and about 400 μm.

132. The article of any one of claims 117-131, wherein the hydrophobic porous material has a pore size of between about 50 μm and less than 0.5 mm.

133. The article of any one of claims 117-132, wherein the spacer layer separates the outer layer and the inner layer by between about 100 μm and about 2 cm.

134. The article of any one of claims 117-133, wherein the spacer layer comprises a plurality of discrete spacers, wherein at least a first discrete spacer of the plurality has a first end and a second end, and wherein the first end penetrates into the inner surface of the outer layer and the second end penetrates into the inner layer.

135. The article of claim 134, wherein the first end and the second end of the first spacer are connected to each other.

136. The article of any one of claims 117-133, wherein the first porous material of the outer layer is a textile comprising a plurality of fibers, wherein the hydrophobic porous material of the inner layer is a textile comprising a plurality of fibers, and wherein the spacer layer comprises at least a first yarn threaded through at least a first space between the plurality of fibers of the outer layer and through at least a first space from the plurality of fibers of the inner layer.

137. The article of claim 136, wherein the first yarn is a monofilament yarn.

138. The article of claim 136 or claim 137, wherein the first layer, the second layer, and the first yarn comprise a 3D knitted or woven fabric.

139. The article of any one of claims 117-133, wherein the spacer layer comprises a plurality of discrete spacers, wherein each discrete spacer of the plurality has a first end and a second end, and wherein the first end is attached to the outer layer and the second end is attached to the first surface of the inner layer.

140. The article of claim 139, wherein the discrete spacers of the plurality are spaced apart from each other by between about 10 μm and about 1 cm.

141. The article of claim 140, wherein the discrete spacers of the plurality are spaced apart from each other by about 2 mm.

142. The article of any one of claims 139-141, wherein each discrete spacer of the plurality comprises a moisture impermeable material in at least the second end attached to the first surface of the inner layer.

143. The article of claim 142, wherein the moisture impermeable material is selected from the group consisting of adhesive, polyurethane, thermoplastic polyurethane (TPU), silicone, metal, polytetrafluoroethylene (PTFE), plastic and a dense hydrophobic fabric.

144. The article of any one of claims 139-143, wherein the outer surface of the outer layer comprises the first porous material, and the inner surface of the outer layer comprises a hydrophilic material, wherein the inner surface of the outer layer is adjacent to the spacer layer.

145. The article of claim 144, wherein the first porous material is a hydrophobic porous material.

146. The article of any one of claims 139-143, wherein the inner layer comprises:
(a) the first surface, wherein the first surface is attached to the plurality of discrete spacers, and wherein the first surface further comprises:
(i) a first portion, wherein the first portion of the first surface is located at the attachments between the inner layer and the plurality of discrete spacers, and wherein the first portion comprises the hydrophobic porous material; and
(ii) a second portion, wherein the second portion of the first surface is located around the attachments between the inner layer and the plurality of discrete spacers, and wherein the second portion comprises a hydrophilic material; and
(b) the second surface, wherein the second surface comprises the hydrophobic porous material and faces in a direction opposite the first surface.

147. The article of any one of claims 139-143, wherein the spacer layer further comprises a hydrophilic layer, wherein the hydrophilic layer is positioned between the first end and the second end of the plurality of discrete spacers, wherein the hydrophilic layer connects the discrete spacers of the plurality, and wherein the hydrophilic layer comprises a hydrophilic material.

148. The article of any one of claims 144-147, wherein the hydrophilic material is a textile.

149. The article of claim 148, wherein the textile is a natural fiber, a synthetic fiber, or a blend thereof.

150. The article of claim 149, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

151. The article of any one of claims 134-143, wherein the outer layer and the spacer layer each comprise a hydrophobic porous material.

152. The article of any one of claims 134-143, wherein the outer layer and the spacer layer each comprise a hydrophobic porous material, wherein the first surface of the inner layer comprises a hydrophobic porous material, and wherein the second surface of the inner layer comprises a hydrophilic material.

153. The article of claim 152, wherein the first surface comprises between about 10% and about 95% of the thickness of the inner layer.

154. The article of any one of claims 134-143, wherein the inner layer and the spacer layer each comprise a hydrophobic porous material, and wherein the outer layer comprises a hydrophilic material.

155. The article of claim 154, wherein the outer layer comprises a first portion comprising a hydrophobic porous material and a second portion comprising the hydrophilic material.

156. The article of claim 155, wherein the second portion of the outer layer forms a pattern on an outer surface of the outer layer.

157. The article of claim 156, wherein the second portion forms a pattern on the outer surface of the outer layer between about 1 mm and about 1 cm in width.

158. The article of claim 156 or claim 157, wherein the second portion covers between about 5% and about 50% of the surface area of the outer layer.

159. The article of claim 155, wherein the second portion of the outer layer comprises a first sub-portion abutting a second sub-portion in a cross-section of the outer layer, wherein only the first sub-portion is present on the outer surface of the outer layer, wherein the first sub-portion comprises a hydrophobic porous material, and wherein the second sub-portion comprises the hydrophilic material.

160. The article of claim 159, wherein the second sub-portion occupies between about 5% and about 95% of the cross-sectional thickness of the first layer.

161. The article of any one of claims 134-143, wherein the outer layer and the spacer layer each comprise a hydrophilic material, wherein the first surface of the inner layer comprises a hydrophilic material, and wherein the second surface of the inner layer comprises a hydrophobic porous material.

162. The article of claim 161, wherein the first surface comprises between about 10% and about 95% of the thickness of the inner layer.

163. The article of any one of claims 117-133, wherein the spacer layer comprises a space separating the outer layer and the inner layer, and wherein at least one of the outer layer and the inner layer is affixed to a support structure that maintains separation between the outer layer and the inner layer.

164. The article of any one of claims 117-163, wherein the article resists a liquid impact having an impact pressure of up to about 41 kPa.

165. The article of claim 164, wherein the protection layer resists a liquid impact having an impact pressure of less than about 0.1 kPa.

166. The article of claim 164, wherein the protection layer resists a liquid impact having an impact pressure of greater than about 0.1 kPa.

167. The article of any one of claims 164-166, wherein an article comprising the outer layer, the spacer layer, and the inner layer but lacking the protection layer resists a liquid impact having an impact pressure of up to about 21 kPa.

168. The article of any one of claims 117-167, wherein the spacer layer is open to airflow in at least a first end.

169. The article of claim 168, wherein the first end of the spacer layer is configured to allow reversible sealing of the first end.

170. The article of any one of claims 117-169, wherein the protection layer is reversibly affixed to the outer surface of the outer layer.

171. The article of any one of claims 117-170, wherein the article is a waterproof fabric.

172. The article of claim 171, wherein the waterproof fabric is a component of a garment.

173. The article of claim 172, wherein the garment comprises:
(a) a first portion comprising the outer layer, the spacer layer, and the inner layer; and
(b) a second portion comprising the protection layer, wherein the first portion and the second portion are reversibly affixed.

174. The article of claim 171, wherein the waterproof fabric is a component of an outerwear, footwear, outdoor gear, pack, umbrella, rain gear, outerwear accessory, diaper, pad, wound dressing, or bed sheet.

175. A method of making an article that resists liquid impact, wherein the article comprises a first layer positioned to receive the liquid impact, a second layer positioned behind the first layer in the direction of the liquid impact, and a spacer layer separating the first layer and the second layer, the method comprising:
(a) providing the second layer, wherein the second layer comprises a hydrophobic porous material on at least a first portion of the second layer, and wherein the second layer further comprises a first surface that faces the direction of the liquid impact;
(b) screen printing a spacer material onto the first surface of the second layer to generate the spacer layer, wherein the spacer layer comprises a plurality of discrete spacers attached to the second layer; and
(c) adhering the first layer onto the spacer layer generated in step (b), wherein the first layer comprises a first porous material.

176. The method of claim 175, wherein screen printing the spacer material onto the second layer comprises:
(i) printing a first portion of a spacer material onto the first surface of the second layer through a screen;
(ii) curing the first portion of the spacer material; and
(iii) printing a second portion of the spacer material onto the cured first portion.

177. The method of claim 176, further comprising repeating steps (i) and (ii) before performing step (iii).

178. The method of any one of claims 175-177, further comprising curing the first layer, the second layer, and the spacer layer after step (c).

179. A method of making an article of manufacture, wherein the article comprises an outer layer comprising a first porous material having a pore size of between about 15 μm and about 1 mm, an inner layer comprising a hydrophobic porous material having a pore size of between about 15 μm and about 1 mm, and a spacer layer separating the first layer and the second layer, the method comprising:
(a) providing the inner layer, wherein the inner layer has a first and a second surface, and wherein the first surface of the inner layer faces the spacer layer, and wherein the inner layer comprises the hydrophobic porous material on at least a portion of the inner layer;
(b) screen printing a spacer material onto the first surface of the inner layer to generate the spacer layer, wherein the spacer layer comprises a plurality of discrete spacers attached to the inner layer; and
(c) adhering the outer layer onto the spacer layer generated in step (b).

180. The method of claim 179, wherein screen printing the spacer material onto the inner layer comprises:
(i) printing a first portion of a spacer material onto the first surface of the inner layer through a screen;
(ii) curing the first portion of the spacer material; and
(iii) printing a second portion of the spacer material onto the cured first portion.

181. The method of claim 180, further comprising repeating steps (i) and (ii) before performing step (iii).

182. The method of any one of claims 179-181, further comprising curing the outer layer, the inner layer, and the spacer layer after step (c).

183. The method of claim 175 or claim 179, wherein step (c) further comprises heating the spacer layer, and wherein the spacer layer comprises a puff ink.

184. A method of making an article that resists liquid impact, wherein the article comprises a first layer positioned to receive the liquid impact, a second layer positioned behind the first layer in the direction of the liquid impact, and a spacer layer separating the first layer and the second layer, the method comprising:
(a) providing the first layer and the second layer, wherein the first layer comprises a first porous material, wherein the second layer comprises a hydrophobic porous material on at least a first portion of the second layer, and wherein the second layer comprises a first surface that faces the direction of the liquid impact; and
(b) bonding the spacer layer to the first layer and the first surface of the second layer by lamination, wherein the spacer layer is bonded between the first layer and the first surface of the second layer, and wherein the spacer layer comprises a plurality of discrete spacers, each spacer of the plurality comprising a solid glue particle.

185. A method of making an article of manufacture, wherein the article comprises an outer layer comprising a first porous material having a pore size of between about 15 μm and about 1 mm, an inner layer comprising a hydrophobic porous material having a pore size of between about 15 μm and about 1 mm, and a spacer layer separating the first layer and the second layer, the method comprising:
(a) providing the outer layer and the inner layer, wherein the outer layer comprises a first porous material, wherein the inner layer has a first and a second surface, wherein the first surface of the inner layer faces the spacer layer, and wherein the inner layer comprises the hydrophobic porous material on at least a first portion of the inner layer; and
(b) bonding the spacer layer to the outer layer and the first surface of the inner layer by lamination, wherein the spacer layer is bonded between the outer layer and the first surface of the inner layer, and wherein the spacer layer comprises a plurality of discrete spacers, each spacer of the plurality comprising a solid glue particle.

186. A method of making an article that resists liquid impact, wherein the article comprises a first layer positioned to receive the liquid impact, a second layer positioned behind the first layer in the direction of the liquid impact, and a spacer layer separating the first layer and the second layer, the method comprising:
(a) providing a spacer material;
(b) applying an adhesive film onto the spacer material;
(c) laminating the applied adhesive film and the spacer material together;
(d) cutting the laminated adhesive film and spacer material into a plurality of discrete spacers to generate the spacer layer, wherein the spacer layer has a first surface comprising the adhesive film and a second surface comprising the spacer material; and
(e) bonding the spacer layer to the first layer and the second layer by lamination, wherein the spacer layer is bonded between the first layer and the second layer, wherein the first layer comprises a first porous material, wherein the second layer comprises a hydrophobic porous material on at least a first portion of the second layer, wherein the first surface of the second layer faces the direction of the liquid impact, and wherein the first surface of the spacer layer is bonded to the first surface of the second layer.

187. A method of making an article of manufacture, wherein the article comprises an outer layer comprising a first porous material having a pore size of between about 15 μm and about 1 mm, an inner layer comprising a hydrophobic porous material having a pore size of between about 15 μm and about 1 mm, and a spacer layer separating the first layer and the second layer, the method comprising:
(a) providing a spacer material;
(b) applying an adhesive film onto the spacer material;
(c) laminating the applied adhesive film and the spacer material together;
(d) cutting the laminated adhesive film and spacer material into a plurality of discrete spacers to generate the spacer layer, wherein the spacer layer has a first surface comprising the adhesive film and a second surface comprising the spacer material; and
(e) bonding the spacer layer to the outer layer and the inner layer by lamination, wherein the spacer layer is bonded between the outer layer and the inner layer, wherein the outer layer comprises a first porous material, wherein the inner layer has a first and a second surface, wherein the first surface of the inner layer faces the spacer layer, wherein the inner layer comprises the hydrophobic porous material on at least a first portion of the inner layer, and wherein the first surface of the spacer layer is bonded to the first surface of the inner layer.

188. A method of making an article of manufacture, wherein the article comprises an outer layer comprising a first porous material, the outer layer having an outer surface and an inner surface, wherein the first porous material has a pore size of between 15 μm and about 5 mm, a spacer layer, and an inner layer comprising a hydrophobic porous material having a pore size of between about 15 μm and less than about 1.5 mm, the method comprising:
(a) knitting the outer layer and the inner layer;
(b) knitting the spacer layer between the outer layer and the inner layer with a yarn.

189. The method of claim 188, wherein the inner layer is knitted using a hydrophobic yarn to produce the hydrophobic porous material.

190. The method of claim 188 or claim 189, wherein the yarn is a hydrophobic monofilament yarn.

191. The method of claim 188, further comprising, after step (b):
(c) soaking the article in a hydrophobic coating solution to produce the hydrophobic porous material; and
(d) squeezing the article between rollers to remove excess coating solution.

192. The method of claim 188, further comprising, after step (b): treating the inner layer with a hydrophobic coating solution using textile printing to produce the hydrophobic porous material.

193. The method of any one of claims 188-192, further comprising affixing a protection layer to the outer surface of the outer layer, wherein the protection layer has a pore size of between about 10 μm and about 400 μm.

194. The method of claim 193, wherein the protection layer is reversibly affixed to the outer surface of the outer layer.

195. The method of claim 193, wherein the protection layer is bonded to the outer surface of the outer layer by lamination.

196. The method of any one of claims 193-195, wherein the protection layer is a woven fabric protection layer.

197. A method of making an article of manufacture, wherein the article comprises an outer layer comprising a first hydrophilic porous material having a pore size of between about 15 μm and about 1 mm, an inner layer comprising a hydrophobic porous material having a pore size of between about 15 μm and about 1 mm, and a hydrophobic spacer layer separating the first layer and the second layer, the method comprising:
(a) providing an article comprising an outer layer comprising a first porous material having a pore size of between about 15 μm and about 1 mm, an inner layer comprising the first porous material having a pore size of between about 15 μm and about 1 mm, and a spacer layer separating the first layer and the second layer;
(b) applying a print paste comprising a hydrophobic material onto the inner layer such that the inner layer and spacer layer are coated with the hydrophobic material;
thereby producing the article comprising an outer layer comprising the first hydrophilic porous material having a pore size of between about 15 μm and about 1 mm, an inner layer comprising the hydrophobic porous material having a pore size of between about 15 μm and about 1 mm, and a hydrophobic spacer layer that separates the first layer and the second layer.

198. The method of claim 197, further comprising, after step (b):
(c) applying a print paste comprising a hydrophobic material onto the outer layer through a screen roller such that, after applying the print paste, the outer layer comprises a first portion comprising the hydrophilic porous material and a second portion comprising a hydrophobic material.

199. The method of claim 198, further comprising, after step (c):
(d) applying a print paste comprising a hydrophobic material onto the outer layer such that the print paste penetrates through part but not all of the outer layer, wherein after applying the print paste, the outer layer comprises a first portion comprising the hydrophilic porous material and a second portion comprising a hydrophobic material, and wherein the first portion is not present on the outer surface of the outer layer.

200. The method of any one of claims 188-199, wherein the inner layer has a first and a second surface, wherein the first surface of the inner layer faces the spacer layer, and wherein the inner layer comprises the hydrophobic porous material on one or both of the first and the second surfaces.

201. The method of any one of claims 175-187 and 199, wherein the second or inner layer comprises the hydrophobic porous material on one or both of the first and the second surfaces.

202. The method of claim 201, wherein the hydrophobic porous material comprises a second porous material with a hydrophobic coating on at least the first portion of the second or inner layer.

203. The method of claim 202, wherein the hydrophobic coating comprises a fluoropolymer, silicone, hydrosilicone, fluoroacrylate, wax, or olefin.

204. The method of claim 202, wherein the second porous material is a textile.

205. The method of claim 204, wherein the textile is a natural fiber, a synthetic fiber, or a blend thereof.

206. The method of claim 205, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

207. The method of any one of claims 175-187, wherein the second porous material is a metal mesh or a polymer mesh.

208. The method of any one of claims 175-207, wherein the hydrophobic porous material comprises polypropylene, polydimethylsiloxane, or a fluoro-polymer.

209. The method of any one of claims 175-208, wherein the first porous material is a textile.

210. The method of claim 209, wherein the textile is a natural fiber, a synthetic fiber, or a blend thereof.

211. The method of claim 210, wherein the textile is selected from the group consisting of cotton, hemp, rayon, coconut fiber, cellulose, wool, silk, bamboo, polyurethane, polypropylene, polyethylene, glass, acetate, polyester, nylon, elastin fiber, and any blend thereof.

212. The method of any one of claims 175-187, wherein the first porous material is a metal mesh or a polymer mesh.

213. The method of any one of claims 175, 184, and 186, wherein the first porous material has a pore size of between about 15 μm and about 1 mm.

214. The method of any one of claims 175, 184, and 186, wherein the first porous material has a pore size of between about 50 μm and about 1 mm.

215. The method of any one of claims 175, 184, and 186, wherein the hydrophobic porous material has a pore size of between about 15 μm and about 1 mm.

216. The method of any one of claims 175, 184, 186, and 214, wherein the hydrophobic porous material has a pore size of between about 50 μm and about 1 mm.

217. The method of any one of claims 175-216, wherein the spacer layer separates the first layer and the second layer or the outer layer and the inner layer from physical contact.

218. The method of any one of claims 175-216, wherein the spacer layer separates the first layer and the second layer or the outer layer and the inner layer from being connected by liquid accumulation.

219. The method of any one of claims 175-218, wherein the spacer layer separates the first layer and the second layer or the outer layer and the inner layer by between about 100 μm and about 2 cm.

220. The method of any one of claims 175-219, wherein the discrete spacers of the plurality are spaced apart from each other by between about 10 μm and about 1 cm.

221. The method of claim 220, wherein the discrete spacers of the plurality are spaced apart from each other by about 2 mm.

222. The method of any one of claims 175-221, wherein each discrete spacer of the plurality comprises a moisture impermeable material in at least an end attached to the second or inner layer.

223. The method of claim 222, wherein the moisture impermeable material is selected from the group consisting of adhesive, polyurethane, thermoplastic polyurethane (TPU), silicone, metal, polytetrafluoroethylene (PTFE), plastic and a dense hydrophobic fabric.

224. The method of any one of claims 175-187, wherein the article resists a liquid impact having an impact pressure of up to about 250 kPa.

225. The method of claim 224, wherein the first or outer layer resists a liquid impact having an impact pressure of up to about 6 kPa.

226. The method of claim 224 or claim 225, wherein the second or inner layer resists a liquid impact having an impact pressure of up to about 6 kPa.

227. The method of any one of claims 188-193, wherein the article resists a liquid impact having an impact pressure of up to about 41 kPa.

228. The method of claim 227, wherein the protection layer resists a liquid impact having an impact pressure of less than about 0.1 kPa.

229. The method of claim 227, the protection layer resists a liquid impact having an impact pressure of greater than about 0.1 kPa.

230. The method of any one of claims 227-229, wherein an article comprising the outer layer, the spacer layer, and the inner layer but lacking the protection layer resists a liquid impact having an impact pressure of up to about 21 kPa.

231. The method of any one of claims 175-230, wherein the spacer layer is open to airflow in at least a first end.

232. The method of claim 227, wherein the first end of the spacer layer is configured to allow reversible sealing of the first end.

233. The method of any one of claims 175-232, wherein the article is a waterproof fabric.

234. The method of claim 233, wherein the waterproof fabric is a component of a garment.

235. The method of claim 234, wherein the garment comprises:
(a) a first portion comprising the waterproof fabric; and
(b) a second portion comprising a second fabric.

236. The method of claim 235, wherein the second fabric is a second waterproof fabric different from the waterproof fabric of the first portion.

237. The method of claim 233, wherein the waterproof fabric is a component of an outerwear, footwear, outdoor gear, pack, umbrella, rain gear, outerwear accessory, diaper, pad, wound dressing, or bed sheet.
